(19) United States
(12) Patent Application Publication
(10) Pub. No.: US 2025/0296021 A1
(43) Pub. Date: Sep. 25, 2025

(54) FILTER MEDIA COMPRISING WATER-REPELLENT ADDITIVES AND/OR FIBRILLATED FIBERS

(71) Applicant: Hollingsworth & Vose Company, East Walpole, MA (US)

(72) Inventor: Goutham Viswanadam, Ayer, MA (US)

(73) Assignee: Hollingsworth & Vose Company, East Walpole, MA (US)

(21) Appl. No.: 19/087,949

(22) Filed: Mar. 24, 2025

Related U.S. Application Data
(60) Provisional application No. 63/569,526, filed on Mar. 25, 2024.

(51) Int. Cl. B01D 39/20; B01D 39/16

(52) U.S. Cl. CPC B01D 39/2017; B01D 39/1623; B01D 2239/0208; B01D 2239/0428; B01D 2239/0492; B01D 2239/0618; B01D 2239/064; B01D 2239/1233

(57) ABSTRACT

Filter media comprising water-repellent additives and/or fibrillated fibers are generally provided. In some embodiments, the filter media comprises fibrillated fibers, such as lyocell fibers. In some embodiments, the filter media comprise water-repellent additives, such as fluorinated water-repellent additives and/or water-repellent additives having minimal or no fluorine atoms. Filter media disclosed herein may include fluorinated water-repellent additives but not water-repellent additives having minimal or no fluorine atoms, water-repellent additives having minimal or no fluorine atoms but not fluorinated water-repellent additives, or both fluorinated water-repellent additives and water-repellent additives having minimal or no fluorine atoms.

### RELATED APPLICATIONS

This application claims priority under 35 U.S.C. § 119(e) to U.S. Provisional Patent Application No. 63/569,526, filed Mar. 25, 2024, and entitled “Filter Media Comprising Water-Repellent Additives and/or Fibrillated Fibers,” which is hereby incorporated herein by reference in its entirety for all purposes.

### FIELD

The present invention relates generally to filter media, and, more particularly, to filter media comprising water repellent additives and/or fibrillated fibers.

### BACKGROUND

Filter media may be employed in a variety of applications to remove contaminants from fluids.

Some filter media include synthetic fibers, such as synthetic fibers comprising poly(vinyl alcohol). However, in some cases, use of synthetic fibers comprising poly(vinyl alcohol) may result in reduced performance (e.g., gamma). Conversely, in some instances, filter media that do not include synthetic fibers comprising poly(vinyl alcohol) may result in reduced wet strength and/or reduced processability of the filter media.

Some filter media include fluorinated water repellents. Some filter media including fluorinated water repellents may have improved performance (e.g., higher gamma) than filter media including non-fluorinated water repellents. However, new regulations may make some such water repellents challenging to use.

Accordingly, improved filter media designs are needed.

### SUMMARY

Filter media, related components, and related methods are generally described.

In some embodiments, a filter media is provided. According to some embodiments, the filter media comprises a non-woven fiber web and a water-repellent additive, wherein the non-woven fiber web comprises fine microglass fibers, microglass fibers having moderate diameters, coarse glass fibers, and fibrillated fibers; wherein the fine microglass fibers have an average fiber diameter of less than or equal to 1 micron; wherein the microglass fibers having moderate diameters have an average fiber diameter of greater than 1 micron and less than or equal to 6 microns; wherein the coarse glass fibers have an average fiber diameter of greater than 6 microns; and wherein the non-woven fiber web comprises greater than 0 wt % and less than or equal to 20 wt % of the fibrillated fibers.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A shows a filter media comprising a non-woven fiber web, in accordance with some embodiments;

FIG. 1B shows a filter media comprising a non-woven fiber web and a layer, in accordance with some embodiments;

FIG. 2A, FIG. 2B, and FIG. 2C show a system for determining a wet strength of a non-woven fiber web, in accordance with some embodiments;

FIG. 3 shows gamma values for various filter media, in accordance with some embodiments;

FIG. 4, FIG. 5, FIG. 6, and FIG. 7 show water repellency values for various filter media, in accordance with some embodiments;

FIG. 8 and FIG. 9 show oil rank values for various filter media, in accordance with some embodiments;

FIG. 10 shows photographs of various filter media, in accordance with some embodiments;

FIG. 11 shows the poly(urethane) wicking heights for various filter media, in accordance with some embodiments;

FIG. 12 and FIG. 13 show the saturation pressure drop and average oil carryover values for various filter media, in accordance with some embodiments;

FIG. 14 is a plot of gamma as a function of the amount of PVOH fibers present in non-woven fiber web samples, according to some embodiments;

FIG. 15 is a plot of gamma as a function of the CSF of the fibrillated lyocell fibers present in non-woven fiber web samples, according to some embodiments; and

FIG. 16 is a plot of the base gamma as a function of the amount of fibrillated lyocell fibers present in non-woven fiber web samples, according to some embodiments.

### DETAILED DESCRIPTION

Filter media comprising water-repellent additives and/or fibrillated fibers are generally disclosed. In some embodiments, the filter media comprises a non-woven fiber web comprising fibrillated fibers. As described herein, some non-woven fiber webs comprising fibrillated fibers may exhibit improved properties in comparison to non-woven fiber webs without fibrillated fibers, non-woven fiber webs with amounts of fibrillated fibers outside of the ranges disclosed herein, and/or non-woven fiber webs with fibrillated fibers with levels of fibrillation outside of the ranges disclosed herein. For example, in some embodiments, a non-woven fiber web comprising an amount of fibrillated fibers (e.g., lyocell fibers) in the ranges disclosed herein has reduced flammability, increased strength (e.g., wet strength), increased flexibility, increased processability, and/or increased performance (e.g., gamma) compared to a non-woven fiber web with amounts of fibrillated fibers (e.g., lyocell fibers) outside of the ranges disclosed herein, all other factors being equal. As another example, in some embodiments, a non-woven fiber web comprising fibrillated fibers (e.g., lyocell fibers) having a level of fibrillation in the ranges disclosed herein has increased performance (e.g., gamma) compared to a non-woven fiber web comprising fibrillated fibers (e.g., lyocell fibers) having a level of fibrillation outside of the ranges disclosed herein, all other factors being equal.

In some embodiments, the filter media comprises a water-repellent additive. Filter media comprising fluorinated water-repellent additives and/or water-repellent additives having minimal or no fluorine atoms are generally provided. Filter media disclosed herein may include fluorinated water-repellent additives but not water-repellent additives having minimal or no fluorine atoms, water-repellent additives having minimal or no fluorine atoms but not fluorinated water-repellent additives, or both fluorinated water-repellent additives and water-repellent additives having minimal or no fluorine atoms.

In some embodiments, a filter media comprises a fluorinated water-repellent additive that is a polymer, an oligomer, or a monomer that may be capable of and/or configured to undergo a polymerization reaction to form a fluorinated polymer and/or oligomer. For instance, a filter media may comprise a perfluoropoly(ether), an oligomeric perfluoroether, and/or a monomer capable of and/or configured to polymerize to form either or both of the preceding. It is also possible for a filter media to comprise a polymer, oligomer, or monomer that comprises a fluorinated side chain. As an example, a filter media may comprise a polymer, an oligomer, or a monomer that comprises a side chain having the structure —CₙFₘR_{y}. The polymer, oligomer, or monomer may be in the form of a resin or may be in another suitable form (e.g., in the form of a thermoplastic polymer and/or oligomer).

In some embodiments, water-repellent additives having minimal or no fluorine atoms comprise one or more water-repellent functional groups. The water-repellent functional groups may comprise a carbon chain including three or more carbon atoms. In some embodiments, some or all of the water-repellent functional group(s) are bonded to a silicon atom and/or a metal atom. It is also possible for some or all of the water-repellent functional group(s) to form side chain(s) attached to a polymer backbone.

Some filter media described herein may exhibit improved properties in comparison to filter media comprising other types of water-repellent additives and/or other combinations of water-repellent additives. For instance, some filter media described herein may exhibit improved properties in comparison to filter media lacking fluorinated water-repellent additives and/or lacking water-repellent additives having minimal or no fluorine atoms. As another example, some filter media described herein may exhibit improved properties in comparison to filter media comprising types of fluorinated water-repellent additives other than perfluoropoly(ether)s, oligomeric perfluoroethers, polymers and oligomers that have fluorinated side chains, and monomers that are capable of and/or configured to polymerize to form some or all of the preceding. In some embodiments, a filter media described herein comprises a combination of a fluorinated water-repellent additive and a non-fluorinated water-repellent additive and exhibits improved performance in comparison to filter media lacking either the fluorinated water-repellent additive or the non-fluorinated water-repellent additive. The improved properties exhibited by some of the media described herein may include high levels of water repellency, oil repellency, and/or resistance to poly(urethane) wicking.

Some filter media described herein may exhibit improved properties in comparison to filter media comprising water-repellent additives including an appreciable amount of fluorine and/or lacking a water-repellent functional group taking the form of a carbon chain including three or more carbon atoms. For instance, in some embodiments, a filter media described herein includes fewer (or zero) components that are subject to certain regulations by a government body. Such filter media may exhibit comparable to or better performance than filter media comprising such regulated water-repellent additives. Such filter media may exhibit better performance than filter media comprising other types of non-fluorinated water-repellent additives, such as non-fluorinated water-repellent additives lacking a functional group taking the form of a carbon chain comprising three or more carbon atoms.

In some embodiments, a filter media described herein comprises an additive comprising a polar functional group. The polar functional group may be present in the same additive that also comprises a water-repellent functional group and/or may be present in a different additive. Advantageously, and unexpectedly, the presence of such polar functional groups may enhance the water-repellency of the filter media in comparison to otherwise-equivalent filter media lacking the additive comprising such polar functional groups and/or lacking such polar functional groups.

Some filter media described herein comprise a water-repellent additive including minimal or no fluorine and also comprise a resin. The water-repellent additive and the resin may together enhance the properties of the filter media in a manner that would be unexpected based on the performance of each of the water-repellent additive and the resin on its own. For instance, the combination of a water-repellent additive that exhibits appreciable water-repellency on its own and a resin that exhibits minimal water-repellency on its own may together exhibit notably higher water-repellency than the water-repellent additive. Some such resins may be fluorinated resins. Some fluorinated resins may comprise a fluorinated polymer that is a water-repellent additive as described above, a fluorinated oligomer that is a water-repellent additive as described above, and/or a fluorinated monomer that is a water-repellent additive as described above.

As described above, in some embodiments, a filter media is provided. It should also be noted that some embodiments may relate to non-woven fiber webs employed in applications other than filter media. For instance, in some embodiments, one or more of the non-woven fiber webs described herein may be a portion of a protective medical gown or a blind. Accordingly, it should be understood that references to non-woven fiber webs herein should be understood to describe both non-woven fiber webs that form a layer in a filter media and non-woven fiber webs that are not included in filter media. It should also be understood that applications other than filter media may include two or more of the non-woven fiber webs described herein and may independently have none, some, or all of the properties described elsewhere herein with respect to filter media.

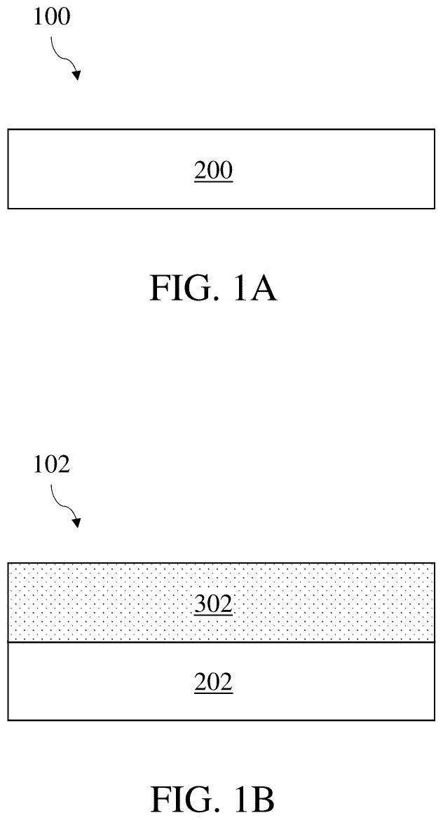

FIG. 1A shows one non-limiting embodiment of a filter media 100 comprising a non-woven fiber web 200. Some filter media, like the filter media shown in FIG. 1A, may include exactly one layer and/or non-woven fiber web. It is also possible for a filter media to comprise two or more layers (e.g., three or more layers, four or more layers, more than four layers), some or all of which may be non-woven fiber webs. A filter media may comprise two or more layers that are of the same type and/or may comprise two or more layers that are of different types. FIG. 1B shows one example of a filter media 102 comprising a non-woven fiber web 202 and a layer 302.

As also described above, in some embodiments, a filter media comprises one or more water-repellent additives and/or one or more resins. For example, in some embodiments, the filter media may comprise a first type of resin and a second type of resin. Each water-repellent additive and resin present in the filter media (if present) may independently be present in one or more of the layers present in the filter media (e.g., dispersed therethrough evenly or unevenly) and/or present in the form of a coating and/or surface layer disposed on one or more of the layers present in the filter media. Water-repellent additives that are dispersed in a layer of a filter media may be present at the surfaces of one or more fibers therein (e.g., in the form of a coating that coats one or more of the fibers). With respect to FIG. 1B, each of the water-repellent additives and resins present in the filter media (if any are present) may independently be positioned in the non-woven fiber web 202, the layer 302, at the surface of the non-woven fiber web 202 opposite the layer 302 (e.g., in the form of a coating and/or surface layer), between the non-woven fiber web 202 and the layer 302, and/or at the surface of the layer 302 opposite the non-woven fiber web 202. It is possible for a filter media to comprise two or more water-repellent additives that are positioned in a common location (e.g., two or more water-repellent additives that are positioned in a common non-woven fiber web) and for a filter media to comprise some locations that include one water-repellent additive but not another (e.g., a filter media may comprise a non-woven fiber web that comprises one water-repellent additive but not another that is also present in the filter media).

Water-repellent additives suitable for inclusion in the filter media described herein may have a variety of suitable properties. In some embodiments, a filter media comprises a water-repellent additive that has a water-repellent functional group. An additive of this type may be in the form of a resin or may be in a different form. It is also possible for a filter media to further comprise one or more additives of a different type (e.g., one or more additives that are not water-repellent, one or more additives that comprise fluorine, one or more additives that are regulated by a government body) and/or to comprise one or more resins that are not water-repellent (e.g., in addition to a water-repellent additive that is a resin, in addition to a water-repellent additive that is not a resin). Further details regarding some suitable water-repellent additives are provided below.

When present, a water-repellent additive may make up a variety of suitable amounts of the filter media. In some embodiments, a water-repellent additive makes up greater than 0 wt %, greater than or equal to 0.001 wt %, greater than or equal to 0.002 wt %, greater than or equal to 0.005 wt %, greater than or equal to 0.0075 wt %, greater than or equal to 0.01 wt %, greater than or equal to 0.02 wt %, greater than or equal to 0.05 wt %, greater than or equal to 0.075 wt %, greater than or equal to 0.1 wt %, greater than or equal to 0.2 wt %, greater than or equal to 0.5 wt %, greater than or equal to 0.75 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, or greater than or equal to 40 wt % of the filter media. In some embodiments, a water-repellent additive makes up less than or equal to 50 wt %, less than or equal to 40 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 2 wt %, less than or equal to 1 wt %, less than or equal to 0.75 wt %, less than or equal to 0.5 wt %, less than or equal to 0.2 wt %, less than or equal to 0.1 wt %, less than or equal to 0.075 wt %, less than or equal to 0.05 wt %, less than or equal to 0.02 wt %, less than or equal to 0.01 wt %, less than or equal to 0.0075 wt %, less than or equal to 0.005 wt %, less than or equal to 0.002 wt %, or less than or equal to 0.001 wt % of the filter media. Combinations of the above-referenced ranges are also possible (e.g., greater than 0 wt % and less than or equal to 50 wt %, greater than or equal to 0.001 wt % and less than or equal to 50 wt %, greater than or equal to 0.001 wt % and less than or equal to 25 wt %, greater than or equal to 0.001 wt % and less than or equal to 10 wt %, greater than or equal to 0.001 wt % and less than or equal to 10 wt %, greater than or equal to 0.1 wt % and less than or equal to 50 wt %, greater than or equal to 1 wt % and less than or equal to 5 wt %, or greater than or equal to 0.5 wt % and less than or equal to 50 wt %). Other ranges are also possible.

In embodiments in which a filter media comprises two or more water-repellent additives, each water-repellent additive may independently be present in the filter media in one or more of the ranges described above. It is also possible for the total amount of water-repellent additives present in the filter media to be in one or more of the ranges described above (i.e., a filter media may comprise one, two, or more additives, and all of the additives together may make up an amount of the filter media in one or more of the ranges described above).

In some embodiments, a filter media comprises at least two water-repellent additives. In such embodiments, any particular water-repellent additive may make up a variety of suitable amounts of the total water-repellent additive. In some embodiments, a water-repellent additive makes up greater than or equal to 0 wt %, greater than 0 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, greater than or equal to 90 wt %, greater than or equal to 95 wt %, greater than or equal to 97.5 wt %, or greater than or equal to 99 wt % of the total weight of all of the water-repellent additives present in the filter media and/or of the total weight of two particular water-repellent additives present in the filter media. In some embodiments, a water-repellent additive makes up less than or equal to 100 wt %, less than or equal to 99 wt %, less than or equal to 97.5 wt %, less than or equal to 95 wt %, less than or equal to 90 wt %, less than or equal to 85 wt %, less than or equal to 80 wt %, less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 2.5 wt %, or less than or equal to 1 wt % of the total weight of all of the water-repellent additives present in the filter media and/or of the total weight of two particular water-repellent additives present in the filter media. Combinations of the above-referenced ranges are also possible (e.g., greater than or equal to 0 wt % and less than or equal to 100 wt %, greater than or equal to 0 wt % and less than or equal to 95 wt %, greater than or equal to 0 wt % and less than or equal to 75 wt %, greater than 0 wt % and less than or equal to 100 wt %, greater than 0 wt % and less than or equal to 95 wt %, or greater than 0 wt % and less than or equal to 75 wt %). Other ranges are also possible.

In embodiments in which a filter media comprises two or more water-repellent additives, each water-repellent additive may independently be present in one or more of the ranges described above. Similarly, in embodiments in which a filter media comprises three or more water-repellent additives, each water-repellent additive may independently be present in one or more of the ranges described above with respect to all water-repellent additives and/or with respect to any sub-population of water-repellent additives (e.g., with respect to one or more particular types of water-repellent additives). As an example, in some embodiments, a filter media comprises a water-repellent additive comprising a fluorinated polymer, oligomer, or monomer and comprises a water-repellent additive comprising one or more water-repellent functional groups having a carbon chain including greater than or equal to three carbon atoms and the amount of the fluorinated polymer, oligomer, or monomer with respect to the total weight of both types of additives is in one or more of the above-referenced ranges.

It is also possible for the total amount of a particular type of water-repellent additive present in the filter media to be in one or more of the ranges described above. As an example, the total amount of fluorinated polymeric, oligomeric, and/or monomeric additives with respect to the total amount of water-repellent additives may be in one or more of the ranges described above. As another example, the total amount of fluorinated polymeric, oligomeric, and/or monomeric additives with respect to the sum of the total amount of such additives and the total amount of water-repellent additives comprising one or more water-repellent functional groups having a carbon chain including greater than or equal to three carbon atoms may be in one or more of the above-referenced ranges.

As described above, in some embodiments, a water-repellent additive is present in a layer of a filter media and/or in a coating disposed on one or more layers present in a filter media. In such embodiments, the water-repellent additive may be bonded to one or more components of the layer. As an example, in some embodiments, a water-repellent additive is bonded to at least a portion of the fibers in a fibrous layer (e.g., a non-woven fiber web). A variety of suitable types of bonding may be present. For instance, the bonding may be covalent bonding, ionic bonding, metallo-organic bonding, and/or hydrogen bonding. It is also possible for the water-repellent additive(s) to be physically entrapped in a layer and/or mechanically coupled to a layer without being bonded thereto.

In some embodiments, a water-repellent additive comprises one or more water-repellent functional groups having a carbon chain including greater than or equal to three carbon atoms. Each such functional group may independently be an alkyl group (i.e., a saturated carbon chain), an alkenyl group, or an alkynyl group. The alkenyl groups and alkynyl groups described herein may have any suitable degree of unsaturation. For instance, an alkenyl group may include exactly one double bond, may include two or more double bonds, or may include exclusively double bonds connecting the carbons in the alkenyl chain. Similarly, an alkynyl group may include exactly one triple bond, may include two or more triple bonds, or may include exclusively alternating triple and single bonds along the alkynyl chain. In some embodiments, an alkynyl group includes one or more triple bonds and one or more double bonds. When multiple double bonds and/or triple bonds are present, they may be positioned with respect to each other in any suitable manner. For instance, two double bonds may be adjacent or separated by one or more bonds of another type. Similarly, two triple bonds may be separated by exactly one single bond or may be separated by two or more bonds of another type.

The alkyl groups, alkenyl groups, and alkynyl groups described herein may have a variety of suitable architectures. Some suitable alkyl groups, alkenyl groups, and alkynyl groups are unbranched and/or straight chain functional groups, and some suitable alkyl groups, alkenyl groups, and alkynyl groups are branched and/or hyperbranched. Branched alkyl groups, alkenyl groups, and alkynyl groups may be branched at a single location or at multiple locations. When branched at multiple locations, the branches may be equally spaced or unequally spaced. Similarly, an alkyl group, alkenyl group, or alkynyl group may comprise two or more branches having equal lengths and/or may comprise two or more branches having unequal lengths.

A water-repellent additive may comprise an alkyl group that is unsubstituted, alkenyl group that is unsubstituted, and/or alkynyl group that is unsubstituted. It is also possible for a water-repellent additive to comprise an alkyl group that is substituted, an alkenyl group that is substituted, and/or an alkynyl group that is substituted. Substituted functional groups may be singly substituted (i.e., they may be substituted in a single location) and/or may be substituted in one or more locations. One non-limiting example of a suitable substitution is an aryl group.

The alkyl groups, alkenyl groups, and alkynyl groups described herein may have a variety of suitable lengths. When present, the alkyl group(s), alkenyl group(s), and/or alkynyl group(s) may each independently comprise greater than or equal to 3 carbon atoms, greater than or equal to 4 carbon atoms, greater than or equal to 5 carbon atoms, greater than or equal to 6 carbon atoms, greater than or equal to 7 carbon atoms, greater than or equal to 8 carbon atoms, greater than or equal to 9 carbon atoms, greater than or equal to 10 carbon atoms, greater than or equal to 11 carbon atoms, greater than or equal to 12 carbon atoms, greater than or equal to 13 carbon atoms, greater than or equal to 14 carbon atoms, greater than or equal to 15 carbon atoms, greater than or equal to 16 carbon atoms, greater than or equal to 17 carbon atoms, greater than or equal to 18 carbon atoms, greater than or equal to 19 carbon atoms, greater than or equal to 20 carbon atoms, greater than or equal to 21 carbon atoms, greater than or equal to 22 carbon atoms, greater than or equal to 23 carbon atoms, greater than or equal to 24 carbon atoms, greater than or equal to 25 carbon atoms, greater than or equal to 26 carbon atoms, greater than or equal to 27 carbon atoms, greater than or equal to 28 carbon atoms, or greater than or equal to 29 carbon atoms. The alkyl group(s), alkenyl group(s), and/or alkynyl group(s) may each independently comprise less than or equal to 30 carbon atoms, less than or equal to 29 carbon atoms, less than or equal to 28 carbon atoms, less than or equal to 27 carbon atoms, less than or equal to 26 carbon atoms, less than or equal to 25 carbon atoms, less than or equal to 24 carbon atoms, less than or equal to 23 carbon atoms, less than or equal to 22 carbon atoms, less than or equal to 21 carbon atoms, less than or equal to 20 carbon atoms, less than or equal to 19 carbon atoms, less than or equal to 18 carbon atoms, less than or equal to 17 carbon atoms, less than or equal to 16 carbon atoms, less than or equal to 15 carbon atoms, less than or equal to 14 carbon atoms, less than or equal to 13 carbon atoms, less than or equal to 12 carbon atoms, less than or equal to 11 carbon atoms, less than or equal to 10 carbon atoms, less than or equal to 9 carbon atoms, less than or equal to 8 carbon atoms, less than or equal to 7 carbon atoms, less than or equal to 6 carbon atoms, less than or equal to 5 carbon atoms, or less than or equal to 4 carbon atoms. Combinations of the above-referenced ranges are also possible (e.g., greater than or equal to 3 carbon atoms and less than or equal to 30 carbon atoms, or greater than or equal to 8 carbon atoms and less than or equal to 30 carbon atoms). Other ranges are also possible.

In some embodiments, a water-repellent additive comprises a water-repellent functional group having a number of carbon atoms identically equal to any of the values in the preceding paragraph (e.g., identically equal to three carbon atoms, identically equal to four carbon atoms, identically equal to five carbon atoms, etc.).

In some embodiments, a water-repellent functional group that is an alkyl group, alkenyl group, or alkynyl group comprises a number of carbon atoms in one or more of the above-referenced ranges that are arranged in a linear chain (e.g., an alkyl group comprising greater than or equal to 3 carbon atoms and less than or equal to 30 carbon atoms may be an n-alkyl group, an alkyl group comprising identically 8 carbon atoms may be an n-octyl group). It is also possible for the alkyl group, alkenyl group, or alkynyl group to comprise a carbon chain comprising a number of carbon atoms in one or more of the above-referenced ranges and further comprise one or more branches comprising further carbon atoms (e.g., an alkyl group may comprise a carbon chain comprising greater than or equal to 3 carbon atoms and less than or equal to 30 carbon atoms which may comprise one or more branches comprising further carbon atoms). In some embodiments, an alkyl group, alkenyl group, or alkynyl group comprises a number of carbon atoms in one or more of the above-referenced ranges that are not arranged in a linear chain (e.g., an alkyl group comprising identically 10 carbon atoms may be an ethyl-substituted octyl group).

It should also be understood that, for water-repellent additives comprising two or more water-repellent functional groups that each comprise three or more carbon atoms, the water-repellent functional groups that each comprise three or more carbon atoms may all be identical, may comprise at least one pair of such water-repellent functional groups that are identical to each other and at least one pair of such water-repellent functional groups that differ from each other, or may not comprise any such water-repellent functional groups that are identical to each other. Additionally, it should also be understood that some filter media may comprise two or more water-repellent additives that are different from each other but that each comprise at least one water-repellent functional group that comprises a carbon chain comprising three or more carbon atoms.

Some water-repellent additives include minimal or no fluorine atoms. In other words, in some embodiments, a filter media comprises a water-repellent additive that lacks fluorine atoms and/or includes relatively few fluorine atoms. In some embodiments, a filter media comprises a water-repellent additive that comprises a water-repellent functional group (e.g., an alkyl group comprising greater than or equal to three carbon atoms, an alkenyl group comprising greater than or equal to three carbon atoms, an alkynyl group comprising greater than or equal to three carbon atoms) that lacks fluorine atoms and/or includes relatively few fluorine atoms. For instance, fluorine atoms may make up less than or equal to 100 at %, less than or equal to 90 at %, less than or equal to 80 at %, less than or equal to 70 at %, less than or equal to 60 at %, less than or equal to 50 at %, less than or equal to 40 at %, less than or equal to 30 at %, less than or equal to 20 at %, less than or equal to 10 at %, less than or equal to 7.5 at %, less than or equal to 5 at %, less than or equal to 4 at %, less than or equal to 3 at %, or less than or equal to 2 at % of the atoms bonded to the carbon atoms in a water-repellent functional group. Fluorine atoms may make up greater than or equal to 1.5 at %, greater than or equal to 2 at %, greater than or equal to 3 at %, greater than or equal to 4 at %, greater than or equal to 5 at %, greater than or equal to 7.5 at %, greater than or equal to 10 at %, greater than or equal to 20 at %, greater than or equal to 30 at %, greater than or equal to 40 at %, greater than or equal to 50 at %, greater than or equal to 60 at %, greater than or equal to 70 at %, greater than or equal to 80 at %, or greater than or equal to 90 at % of the atoms bonded to the carbon atoms in a water-repellent functional group. Combinations of the above-referenced ranges are also possible (e.g., greater than or equal to 1.5 at % and less than or equal to 100 at %). Other ranges are also possible. In some embodiments, fluorine atoms make up identically 0% of the atoms bonded to the carbon atoms in a water-repellent functional group.

It should also be understood that, for water-repellent additives comprising two or more water-repellent functional groups, each water-repellent functional group may independently include an amount of fluorine in one or more of the above-referenced ranges. Additionally, it should also be understood that some filter media may comprise two or more water-repellent additives that are different from each other but that each comprise at least one water-repellent functional group that includes an amount of fluorine in one or more of the above-referenced ranges.

In some embodiments, a water-repellent additive comprises a water-repellent functional group (e.g., an alkyl group comprising greater than or equal to three carbon atoms, an alkenyl group comprising greater than or equal to three carbon atoms, an alkynyl group comprising greater than or equal to three carbon atoms) that includes less than or equal to 7 fluorine atoms, less than or equal to 6 fluorine atoms, less than or equal to 5 fluorine atoms, less than or equal to 4 fluorine atoms, less than or equal to 3 fluorine atoms, less than or equal to 2 fluorine atoms, or less than or equal to one fluorine atom. In some embodiments, a water-repellent additive comprises a water-repellent functional group that includes greater than or equal to 0 fluorine atoms, greater than or equal to 1 fluorine atom, greater than or equal to 2 fluorine atoms, greater than or equal to 3 fluorine atoms, greater than or equal to 4 fluorine atoms, greater than or equal to 5 fluorine atoms, or greater than or equal to 6 fluorine atoms. Combinations of the above-referenced ranges are also possible (e.g., greater than or equal to 0 fluorine atoms and less than or equal to 7 fluorine atoms). Other ranges are also possible. Additionally, in some embodiments, a water-repellent functional group includes identically 0 fluorine atoms.

It should also be understood that, for water-repellent additives comprising two or more water-repellent functional groups, each water-repellent functional group may independently include an amount of fluorine in one or more of the above-referenced ranges. Additionally, it should also be understood that some filter media may comprise two or more water-repellent additives that are different from each other but that each comprise at least one water-repellent functional group that includes an amount of fluorine in one or more of the above-referenced ranges.

In some embodiments, a water-repellent additive comprising a water-repellent functional group (e.g., an alkyl group comprising greater than or equal to three carbon atoms, an alkenyl group comprising greater than or equal to three carbon atoms, an alkynyl group comprising greater than or equal to three carbon atoms) further comprises a silicon atom and/or a metal atom. The water-repellent functional group may be bonded to the silicon atom and/or the metal atom. For instance, in some embodiments, a water-repellent additive has one or both of the structures shown below:

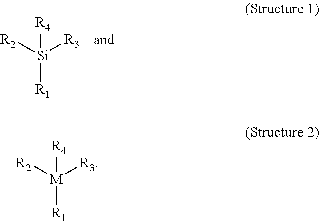

In Structures 1 and 2, R₁ is a water-repellent functional group (e.g., that is and/or comprises an alkyl group comprising greater than or equal to three carbon atoms, an alkenyl group comprising greater than or equal to three carbon atoms, or an alkynyl group comprising greater than or equal to three carbon atoms). Additionally, R₂, R₃, and R₄ are any suitable functional groups. As described above, in some embodiments, one, two, or all of R₂, R₃, and R₄ are also water-repellent functional groups (e.g., having the same structure as R₁ and/or each other, having a different structure from R₁ and/or each other). In other words, a water-repellent additive may comprise two water-repellent functional groups both bonded to the same silicon or metal atom. It is also possible for one, two, or all of R₂, R₃, and R₄ to be a functional group other than a water-repellent functional group (e.g., having the same structures as each other, having different structures from each other). Further detail regarding suitable structures for R₂, R₃, and R₄ are provided elsewhere herein.

In the embodiments in which a water-repellent additive has a structure as shown in Structure 2, M may be a variety of suitable metals. In some embodiments, M is a post-transition metal (e.g., aluminum). It is also possible for M to be a transition metal (e.g., titanium, zirconium).

Further examples of suitable water-repellent additives are shown below:

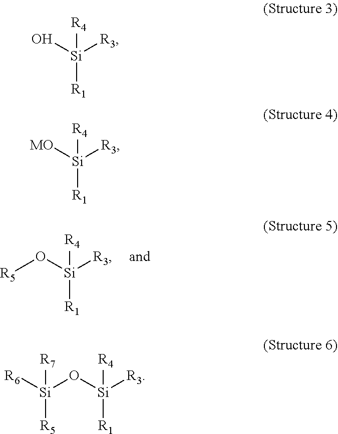

Structures 3-6 depict silanols, siloxides, silyl ethers, and silanes, respectively. In Structures 3-6: R₁ is a water-repellent functional group (e.g., an alkyl group comprising greater than or equal to three carbon atoms, an alkenyl group comprising greater than or equal to three carbon atoms, an alkynyl group comprising greater than or equal to three carbon atoms); and R₃ and R₄ are any suitable functional groups. In Structure 4, M is a metal (e.g., a post-transition metal such as aluminum, a transition metal such as titanium or zirconium). In Structures 5 and 6, R₅ is any suitable functional group. In Structure 6, R₆ and R₇ are any suitable functional groups. In some embodiments, one, two, or all of R₃, R₄, R₅, R₆, and R₇ (when present) are also water-repellent functional groups (e.g., having the same structure as R₁ and/or each other, having a different structure from R₁ and/or each other). It is also possible for one, two, or all of R₃, R₄, R₅, R₆, and R₇ to be a functional group other than a water-repellent functional group (e.g., having the same structures as each other, having different structures from each other).

In accordance with some embodiments, the water-repellent additive is not silicone-based. According to some embodiments, the water-repellent additive lacks silicon.

In some embodiments, a water-repellent additive comprising a water-repellent functional group (e.g., an alkyl group comprising greater than or equal to three carbon atoms, an alkenyl group comprising greater than or equal to three carbon atoms, an alkynyl group comprising greater than or equal to three carbon atoms) is a polymer. In such embodiments, the water-repellent functional group may form a side chain of a repeat unit of the polymer. As an example, a water-repellent additive may have the following structure:

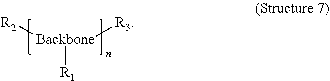

In Structure 7: Backbone is one or more atoms that form part of the backbone of the polymer; R₁ is a water-repellent functional group (e.g., that is and/or comprises an alkyl group comprising greater than or equal to three carbon atoms, an alkenyl group comprising greater than or equal to three carbon atoms, or an alkynyl group comprising greater than or equal to three carbon atoms); R₂ and R₃ are any suitable end groups; and n is any suitable value. Neither, either, or both of R₂ and R₃ may be water-repellent functional groups. In some embodiments, one or more further side chains may also be bonded to Backbone (not shown). Some, none, or all of such side chains may also be water-repellent. Additionally, some, none, or all of such further side chains may be bonded to the same atom as the water-repellent functional group.

A variety of suitable backbones may be employed. In some embodiments, the backbone is formed from carbon atoms. It is also possible for the backbone to comprise one or more heteroatoms (e.g., silicon atoms, oxygen atoms, nitrogen atoms).

Non-limiting examples of suitable repeat units (i.e., including both the backbone and the water-repellent functional group) include polymerized acrylic repeat units (e.g., the polymer may be a poly(acrylate)), polymerized urethane repeat units (e.g., the polymer may be a poly(urethane)), polymerized epoxy repeat units (e.g., the polymer may be a poly(ether)), polymerized urea repeat units (e.g., the polymer may be a poly(urea)), polymerized ester repeat units (e.g., the polymer may be a poly(ester)), polymerized siloxane repeat units (e.g., the polymer may be a poly(siloxane)), polymerized silazane repeat units (e.g., the polymer may be a poly(silazane)), and polymerized carbodiimide repeat units (e.g., the polymer may be a poly(carbodiimide)). In some embodiments, the functional group of the water-repellent additive lacks silicon. Accordingly, in some embodiments, the repeat unit lacks silicon.

Further examples of suitable polymers include hydrolysis products of species comprising a metal atom, a hydrolysable functional group, and one or more water-repellent functional groups (e.g., that are and/or comprise alkyl groups comprising greater than or equal to three carbon atoms, alkenyl groups comprising greater than or equal to three carbon atoms, and/or alkynyl groups comprising greater than or equal to three carbon atoms). These species may comprise post-transition metals (e.g., aluminum) and/or transition metals (e.g., titanium, zirconium). The hydrolysis products may take the form of organometallic compounds (e.g., organoaluminum compounds, organotitanium compounds, and/or organozirconium compounds).

In some embodiments, like the embodiment shown in Structure 7, a water-repellent additive comprising a water-repellent functional group is a homopolymer. It is also possible for a filter media to comprise a water-repellent additive that is a polymer other than a homopolymer. For instance, in some embodiments, a water-repellent additive comprises a repeat unit comprising a side chain comprising a water-repellent functional group (e.g., an alkyl group comprising greater than or equal to three carbon atoms, an alkenyl group comprising greater than or equal to three carbon atoms, an alkynyl group comprising greater than or equal to three carbon atoms) and further comprises one or more different types of repeat units. The different type(s) of repeat units may comprise a repeat unit comprising a water-repellent functional group (e.g., of a different type than the first repeat unit comprising a water-repellent functional group, of the same type as the first repeat unit comprising a water-repellent functional group but attached to a different type of backbone) and/or may comprise a repeat unit lacking a water-repellent functional group.

A water-repellent additive may be a copolymer, such as a dipolymer, a terpolymer, a quaterpolymer, or any other suitable type of polymer. Additionally, the arrangement of the repeat units within a copolymer may generally be selected as desired. To provide non-limiting examples, suitable water-repellent additives may include random copolymers, alternating copolymers, periodic copolymers, statistical copolymers, block copolymers, blocky copolymers, stereoblock copolymers, tapered copolymers, and/or graft copolymers. Structures 8 and 9 below show two non-limiting examples of suitable random copolymers and block copolymers, respectively:

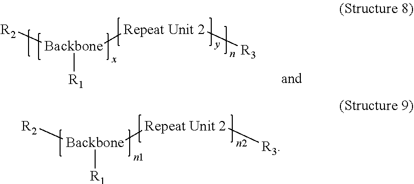

In Structures 8 and 9: Backbone is one or more atoms that form part of the backbone of the polymer associated with a repeat unit comprising a water-repellent functional group; Repeat Unit 2 is a repeat unit copolymerized with the repeat unit comprising the water-repellent functional group; R₁ is a water-repellent functional group (e.g., that is and/or comprises an alkyl group comprising greater than or equal to three carbon atoms, an alkenyl group comprising greater than or equal to three carbon atoms, or an alkynyl group comprising greater than or equal to three carbon atoms); and R₂ and R₃ are any suitable end groups. In Structure 8: n is any suitable value; x and y may be selected as desired and may vary across the length of the polymer. In Structure 9: n1 and n2 may be selected as desired. Neither, either, or both of R₂ and R₃ may be water-repellent functional groups. Similarly, the repeat unit comprising Backbone may comprise one or more further water-repellent functional groups and/or Repeat Unit 2 may comprise one or more water-repellent functional groups.

For both Backbone and Repeat Unit 2, a variety of suitable backbones may be employed. In some embodiments, the backbone is formed from carbon atoms. It is also possible for the backbone to comprise one or more heteroatoms (e.g., silicon atoms, oxygen atoms, nitrogen atoms).

Non-limiting examples of suitable repeat units for both the repeat unit comprising R₁ and Repeat Unit 2 include polymerized acrylic repeat units (e.g., the polymer may be a poly(acrylate)), polymerized urethane repeat units (e.g., the polymer may be a poly(urethane)), polymerized epoxy repeat units (e.g., the polymer may be a poly(ether)), polymerized siloxane repeat units (e.g., the polymer may be a poly(siloxane)), and polymerized silazane repeat units (e.g., the polymer may be a poly(silazane)). In some embodiments, the copolymer of the water-repellent additive lacks silicon. Accordingly, in some embodiments, the repeat unit lacks silicon.

It is also possible for a water-repellent additive to be an oligomer and comprise a water-repellent functional group (e.g., an alkyl functional group comprising greater than or equal to three carbon atoms, an alkenyl functional group comprising greater than or equal to three carbon atoms, an alkynyl functional group comprising greater than or equal to three carbon atoms). For instance, in some embodiments, a water-repellent additive is an oligomer that has a structure shown in any of Structures 7-9 in which n, x, or the sum of n1 and n2 is small enough to make the molecule an oligomer.

In some embodiments, a water-repellent additive has a three-dimensional structure. For instance, in some embodiments, a water-repellent additive is a covalent network. The covalent network may be crystalline, amorphous, or semicrystalline. Water-repellent additives having three-dimensional structures may comprise one or more water-repellent functional group(s) (e.g., alkyl functional groups comprising greater than or equal to three carbon atoms, alkenyl functional groups comprising greater than or equal to three carbon atoms, alkynyl functional groups comprising greater than or equal to three carbon atoms). It is also possible for such water-repellent additives to also comprise other types of functional groups. In some embodiments, water-repellent additives that are three-dimensional structures further comprise silicon atoms, metal atoms (e.g., titanium atoms, zirconium atoms, and/or aluminum atoms), oxygen atoms, and/or nitrogen atoms. In some such embodiments, the metal and/or silicon atoms may bond to both the oxygen atoms and the water-repellent functional groups. One non-limiting example of a suitable covalent network is a silsesquioxane.

In some embodiments, a water-repellent additive comprising a water-repellent functional group (e.g., an alkyl functional group comprising greater than or equal to three carbon atoms, an alkenyl functional group comprising greater than or equal to three carbon atoms, an alkynyl functional group comprising greater than or equal to three carbon atoms) further comprises one or more polar functional groups. The polar functional group(s) may be non-hydrolysable functional group(s) and/or functional group(s) that are stable during filter media preparation and/or use. Non-limiting examples of suitable polar functional groups include amino groups, acetoxy groups, and acetamido groups. Additionally, when a water-repellent additive comprises two or more polar functional groups, it may comprise exclusively one type of polar functional group, exclusively different types of polar functional groups, or at least two polar functional groups of the same type and at least two polar functional groups of different types.

When present, the polar functional group(s) may be positioned in a variety of suitable locations in the water-repellent additives described herein. For instance, in a water-repellent additive comprising a silicon or metal atom to which a water-repellent functional group is bonded, it is possible for the polar functional group to also be bonded to the silicon or metal atom. With reference to Structures 1 and 2, it is possible for all, some, or none of R₂, R₃, and R₄ to be polar functional groups. Similarly, with reference to Structures 3-6, it is also possible for all, some, or none of R₃, R₄, R₅, R₆, and R₇ to be polar functional groups.

In some embodiments, a water-repellent additive that is oligomeric or polymeric comprises a polar functional group. As an example, a water-repellent additive comprising an oligomer or polymer that comprises a repeat unit that comprises a water-repellent functional group (e.g., an alkyl group comprising greater than or equal to three carbon atoms, an alkenyl group comprising greater than or equal to three carbon atoms, an alkynyl group comprising greater than or equal to three carbon atoms) may further comprise a polar functional group. With reference to Structure 7-9, it is possible for a polar functional group to be attached to Backbone and/or for either, both, or neither of R₂ and R₃ to be polar functional groups. When the polar functional group is attached to Backbone, it may or may not be directly attached to the same atom therein to which the water-repellent functional group is attached. With reference to Structures 8 and 9, it is possible for a polar functional group to be attached to Repeat Unit 2. In other words, a polymeric or oligomeric water-repellent additive may: comprise a repeat unit comprising a single atom to which both a polar functional group and a water-repellent functional group are bonded; comprise a repeat unit comprising a polar functional group bonded to a different backbone atom than a water-repellent functional group; comprise one repeat unit comprising a water-repellent functional group and a second, different repeat unit comprising a polar functional group; and/or comprise an end group that comprises a polar functional group.

In some embodiments, a water-repellent additive that is a covalent network comprises one or more polar functional groups (e.g., in addition to a water-repellent functional group).

It should also be stated that some water-repellent additives (e.g., those having a structure shown in one or more of Structures 1-9, those comprising a silicon atom and/or a metal atom, those that are polymeric, those that are oligomeric, those that are covalent networks) may comprise one or more functional groups that are not water-repellent functional groups and are not polar functional groups. Such functional groups may be positioned in any suitable location(s) (e.g., any location(s) in Structures 1-9 that are not water-repellent functional groups or polar functional groups). Non-limiting examples functional groups that are neither a water-repellent functional group as described herein nor a polar functional group include hydrogen, methyl groups, and ethyl groups.

In some embodiments, a filter media comprises an additive comprising a polar functional group (e.g., a polar functional group as described elsewhere herein as being suitable for inclusion in a water-repellent additive). The additive comprising the polar functional group may also be a water-repellent additive (e.g., as described elsewhere herein) and/or comprise a water-repellent functional group (e.g., an alkyl group comprising greater than or equal to three carbon atoms, an alkenyl group comprising greater than or equal to three carbon atoms, an alkynyl group comprising greater than or equal to three carbon atoms). It is also possible for the additive comprising the polar functional group to lack water-repellent functional groups. An additive comprising a polar functional group may have a structure similar to one or more of the structures shown in Structures 1-9 and differing therefrom only in that R₁ is not a water-repellent functional group and one or more of the functional groups present (e.g., some or all of R₁-R₉) are polar functional groups.

When a filter media comprises a water-repellent additive and/or combination of additives (e.g., a combination of water-repellent additives, a combination comprising at least one water-repellent additive and at least one additive other than a water-repellent additive) that comprise both one or more water-repellent functional groups (e.g., alkyl groups comprising greater than or equal to three carbon atoms, alkenyl groups comprising greater than or equal to three carbon atoms, alkynyl groups comprising greater than or equal to three carbon atoms) and one or more polar functional groups, the relative amounts of the water-repellent functional groups and the polar functional groups may generally be selected as desired. In some embodiments, a ratio of the number of water-repellent functional groups to the number of polar functional groups is greater than or equal to 0.1, greater than or equal to 0.15, greater than or equal to 0.2, greater than or equal to 0.25, greater than or equal to 0.33, greater than or equal to 0.5, greater than or equal to 0.75, greater than or equal to 1, greater than or equal to 1.5, greater than or equal to 2, greater than or equal to 2.5, greater than or equal to 3, greater than or equal to 4, greater than or equal to 5, or greater than or equal to 7.5. In some embodiments, a ratio of the number of water-repellent functional groups to the number of polar functional groups is less than or equal to 10, less than or equal to 7.5, less than or equal to 5, less than or equal to 4, less than or equal to 3, less than or equal to 2.5, less than or equal to 2, less than or equal to 1.5, less than or equal to 1, less than or equal to 0.75, less than or equal to 0.5, less than or equal to 0.33, less than or equal to 0.25, less than or equal to 0.2, or less than or equal to 0.15. Combinations of the above-referenced ranges are also possible (e.g., greater than or equal to 0.1 and less than or equal to 10, greater than or equal to 0.2 and less than or equal to 5, or greater than or equal to 0.33 and less than or equal to 3). Other ranges are also possible.

In some embodiments, a single water-repellent additive present in a filter media (that may lack other water-repellent additives or that may further comprise other water-repellent additives) has a ratio of the number of water-repellent functional groups to the number of polar functional groups in one or more of the above-referenced ranges. In some embodiments, the ratio of the number of water-repellent functional groups to the number of polar functional groups in the filter media as a whole is in one or more of the above-referenced ranges.

When a filter media comprises a polymeric water repellent additive that comprises both one or more repeat units comprising a water-repellent functional group (e.g., an alkyl group comprising greater than or equal to three carbon atoms, an alkenyl group comprising greater than or equal to three carbon atoms, an alkynyl group comprising greater than or equal to three carbon atoms) and one or more repeat units comprising a polar functional group, the relative amounts of the repeat units comprising the water-repellent functional groups and the repeat units comprising the polar functional groups may generally be selected as desired. In some embodiments, a ratio of the number of repeat units comprising the water-repellent functional groups to the number of repeat units comprising the polar functional groups is greater than or equal to 0.1, greater than or equal to 0.15, greater than or equal to 0.2, greater than or equal to 0.25, greater than or equal to 0.33, greater than or equal to 0.5, greater than or equal to 0.75, greater than or equal to 1, greater than or equal to 1.5, greater than or equal to 2, greater than or equal to 2.5, greater than or equal to 3, greater than or equal to 4, greater than or equal to 5, or greater than or equal to 7.5. In some embodiments, a ratio of the number of the repeat units comprising the water-repellent functional groups to the number of repeat units comprising the polar functional groups is less than or equal to 10, less than or equal to 7.5, less than or equal to 5, less than or equal to 4, less than or equal to 3, less than or equal to 2.5, less than or equal to 2, less than or equal to 1.5, less than or equal to 1, less than or equal to 0.75, less than or equal to 0.5, less than or equal to 0.33, less than or equal to 0.25, less than or equal to 0.2, or less than or equal to 0.15. Combinations of the above-referenced ranges are also possible (e.g., greater than or equal to 0.1 and less than or equal to 10, greater than or equal to 0.2 and less than or equal to 5, or greater than or equal to 0.33 and less than or equal to 3). Other ranges are also possible. When a repeat unit comprises both a water-repellent functional group and a polar functional group, it is considered to contribute to the number of both types of functional groups in the above-referenced ratios.

Some filter media described herein comprise one or more water-repellent additives that take the form of a fluorinated polymer, a fluorinated oligomer, and/or a fluorinated monomer. Such water-repellent additives may take the form of a resin or a component of a resin. It is also possible for such water-repellent additives to be provided in a form other than a resin or a resin component. Fluorinated water-repellent additives may comprise one or more water-repellent functional groups like those described above (e.g., an alkyl group comprising greater than or equal to three carbon atoms, an alkenyl group comprising greater than or equal to three carbon atoms, an alkynyl group comprising greater than or equal to three carbon atoms) or may lack such functional groups. It is also possible for fluorinated water-repellent additives (e.g., fluorinated polymers, fluorinated oligomers, fluorinated monomers) to be provided in conjunction with a water-repellent additive comprising one or more water-repellent functional groups like those described above (e.g., an alkyl group comprising greater than or equal to three carbon atoms, an alkenyl group comprising greater than or equal to three carbon atoms, an alkynyl group comprising greater than or equal to three carbon atoms) or to be present in a filter media lacking such water-repellent additives. In some embodiments, a filter media includes a fluorinated polymer, fluorinated oligomer, or fluorinated monomer and does not include any further water-repellent additives.

A water-repellent that is a fluorinated polymer may be a homopolymer or a copolymer (e.g., a dipolymer, a terpolymer, a quaterpolymer, or any other suitable type of copolymer). Similarly, a water-repellent additive that is a fluorinated oligomer may be a homo-oligomer or a co-oligomer (e.g., a di-oligomer, a ter-oligomer, a quarter-oligomer, or any other suitable type of co-oligomer). Fluorinated copolymers and fluorinated co-oligomers may comprise repeat units that are unfluorinated or may be exclusively made up of fluorinated repeat units. The arrangement of the repeat units within fluorinated copolymers and fluorinated co-oligomers may generally be selected as desired. To provide non-limiting examples, suitable fluorinated copolymers and co-oligomers may include random copolymers and co-oligomers, alternating copolymers and co-oligomers, periodic copolymers and co-oligomers, statistical copolymers and co-oligomers, block copolymers and co-oligomers, blocky copolymers and co-oligomers, stereoblock copolymers and co-oligomers, tapered copolymers and co-oligomers, and/or graft copolymers and co-oligomers.

Fluorinated polymers and fluorinated oligomers suitable for use in the filter media described herein may comprise backbones that are fluorinated and/or one or more side chains that are fluorinated (e.g., a plurality of fluorinated side chains). Non-limiting examples of fluorinated water-repellent additives include fluorinated poly(ethers) (e.g., perfluoropoly(ether)s), oligomeric fluorinated ethers, fluorinated poly(urethane)s, oligomeric fluorinated urethanes, and polymers and oligomers comprising a side chain comprising a structural motif having the formula —CₙFₘR_{y}. Some filter media comprise two or more of the above-described types of water-repellent additives (e.g., a fluorinated poly(ether) and a polymer comprising a side chain comprising a structural motif having the formula —CₙFₘR_{y}). It is also possible for a filter media to comprise two or more different water-repellent additives that both fall into one or more of the above-described categories (e.g., two or more fluorinated poly(ether)s.

As described above, in some embodiments, a filter media comprises a water-repellent additive that is a perfluoropoly(ether), a water-repellent additive that is an oligomeric perfluoroether, and/or a monomeric perfluoroether. In some embodiments, a filter media comprises both a water-repellent additive that comprises a water-repellent functional group as described above (e.g., an alkyl group comprising greater than or equal to three carbon atoms, an alkenyl group comprising greater than or equal to three carbon atoms, an alkynyl group comprising greater than or equal to three carbon atoms) and further comprises a perfluoropoly(ether), an oligomeric perfluoroether, and/or a monomeric perfluoroether. It is also possible for a filter media to lack a water-repellent additive that comprises a water-repellent functional group as described above (e.g., an alkyl group comprising greater than or equal to three carbon atoms, an alkenyl group comprising greater than or equal to three carbon atoms, an alkynyl group comprising greater than or equal to three carbon atoms) but comprise a perfluoropoly(ether), an oligomeric perfluoroether, and/or a monomeric perfluoroether.

Perfluoropoly(ether)s and oligomeric perfluoroethers may comprise a perfluoroether chain. Monomeric perfluoroethers may comprise a perfluoroether functional group, a perfluoroether chain, and/or a functional group that may be capable of and/or configured to polymerize into a perfluoroether chain. Some suitable perfluoroether chains have the structure —(CₙFₘO)ₓ—, where n and m are integers properly chosen to form a valid structure. X in the chemical formula (CₙFₘO)ₓ— may be less than or equal to 10, less than or equal to 8, less than or equal to 6, less than or equal to 4, or less than or equal to 2. X may be greater than or equal to 1, greater than or equal to 2, greater than or equal to 4, greater than or equal to 6, or greater than or equal to 8. Combinations of the above-referenced ranges are also possible (e.g., less than or equal to 10 and greater than or equal to 1). Other ranges are also possible.

In some embodiments, x in the chemical formula (CₙFₘO)ₓ— is identically equal to any of the values in the preceding paragraph (e.g., identically equal to 10, identically equal to 8, identically equal to 6, etc.).

Non-limiting examples of polymers comprising perfluoroether chains having the chemical formula (CₙFₘO)— include poly(perfluoromethylene oxide), poly(perfluoroethylene oxide), poly(perfluoropropylene oxide), and poly(perfluorobutylene oxide). Further non-limiting examples of suitable repeat units for perfluoroether chains include —(CₙF₂ₙO)ₓ—, where n is an integer (e.g., —(C₃F₆O)ₓ—, —(C₄F₈O)ₓ—, —(C₅F₁₀O)ₓ—); —(CF(CF₃)CF₂O)ₓ—; —(CF₂CF₂O)ₓ—; —(CF(CF₃)CF₂O)ₓ—CF(CF₃)CONH—; —(CF₂ (CF₂)_{z′}CF₂O)ₓ—, where z′ is an integer; —(CFLO)ₓ—, where L=—F or —CF₃; and —(CH₂CF₂CF₂O)ₓ—. In some embodiments, a water-repellent additive that is a perfluoropoly(ether), a water-repellent additive that is an oligomeric perfluoroether, and/or a water-repellent additive that is a monomeric perfluoroether includes a terminal group having the formula (CₙF₂₊₁O)ₓ—, where n is an integer (e.g., —(CF₃O)ₓ—, —(C₂F₅O)ₓ—, and —(C₃F₇O)ₓ—). It is also possible for a water-repellent additive that is a perfluoropoly(ether), a water-repellent additive that is an oligomeric perfluoroether, and/or a water-repellent additive that is a monomeric perfluoroether to include —SO₃²⁻ as a terminal group. Some terminal groups may be unpolymerizable.

In some embodiments, a fluorinated polymer is a fluorinated poly(urethane), a fluorinated oligomer is a fluorinated oligomeric urethane, a fluorinated monomer comprises a urethane functional group, and/or a fluorinated monomer comprises one or more functional groups that are configured to react to form a fluorinated poly(urethane) and/or a fluorinated oligomeric urethane. In some embodiments, a filter media comprises both a water-repellent additive that comprises a water-repellent functional group as described above (e.g., an alkyl group comprising greater than or equal to three carbon atoms, an alkenyl group comprising greater than or equal to three carbon atoms, an alkynyl group comprising greater than or equal to three carbon atoms) and further comprises a fluorinated poly(urethane), fluorinated oligomeric urethane, a fluorinated monomer comprises a urethane functional group, and/or a fluorinated monomer comprises one or more functional groups that are configured to react to form a fluorinated poly(urethane) and/or a fluorinated oligomeric urethane. It is also possible for a filter media to lack a water-repellent additive that comprises a water-repellent functional group as described above (e.g., an alkyl group comprising greater than or equal to three carbon atoms, an alkenyl group comprising greater than or equal to three carbon atoms, an alkynyl group comprising greater than or equal to three carbon atoms) but comprise a fluorinated poly(urethane), fluorinated oligomeric urethane, a fluorinated monomer comprises a urethane functional group, and/or a fluorinated monomer comprises one or more functional groups that are configured to react to form a fluorinated poly(urethane) and/or a fluorinated oligomeric urethane.

One non-limiting example of a fluorinated poly(urethane) is a polymer having Structure 10 below:

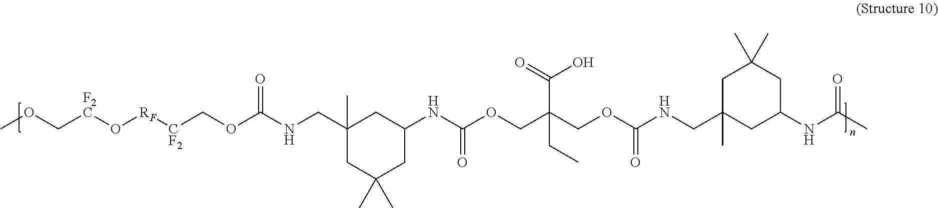

In Structure 10, R_{F}═(CF₂CF₂O)ₓ(CF₂O)_{y}. Structure 10 is thus both a poly(ether) and a poly(urethane). Other polymers that are both poly(ether)s and poly(urethane)s may also be employed. Similarly, oligomers that comprise both ether repeat units and urethane repeat units are also possible.

In some embodiments, a fluorinated polymer, a fluorinated oligomer, and/or a fluorinated monomer includes a chain having the structure —CₙFₘR_{y}. In some embodiments, a filter media comprises both a water-repellent additive that comprises a water-repellent functional group as described above (e.g., an alkyl group comprising greater than or equal to three carbon atoms, an alkenyl group comprising greater than or equal to three carbon atoms, an alkynyl group comprising greater than or equal to three carbon atoms) and further comprises fluorinated polymer, a fluorinated oligomer, and/or a fluorinated monomer that includes a chain having the structure —CₙFₘR_{y}. It is also possible for a filter media to lack a water-repellent additive that comprises a water-repellent functional group as described above (e.g., an alkyl group comprising greater than or equal to three carbon atoms, an alkenyl group comprising greater than or equal to three carbon atoms, an alkynyl group comprising greater than or equal to three carbon atoms) but comprise a fluorinated polymer, a fluorinated oligomer, and/or a fluorinated monomer that includes a chain having the structure —CₙFₘR_{y}.

When present, the chain may be a side chain and/or may be a portion of a side chain. In other words, a fluorinated polymer and/or a fluorinated oligomer may comprise a side chain comprising and/or having the structure —CₙFₘR_{y}. In some embodiments, a fluorinated polymer and/or a fluorinated oligomer comprises a side chain that comprises a linker that links a chain having the formula —CₙFₘR_{y} to a backbone. The side chain may terminate with the formula —CₙFₘR_{y}. The fluorinated polymer, fluorinated oligomer, and/or fluorinated monomer may be a fluoroacrylate polymer, a fluoroacrylate oligomer, and/or a fluoroacrylate monomer.

In the structure —CₙFₘR_{y}, n, m, and y may be selected as desired. N may be an integer greater than 1. M may be an integer greater than 1. R may be zero, an atom, or a group of atoms (e.g., hydrogen, oxygen, sulfur, nitrogen, carbon or an end group described herein). Y may be an integer greater than or equal to 0. In some embodiments, n is an integer less than or equal to 8 and m is an integer greater than 1 (e.g., in the structures —C₈F₁₅H₂, —C₈F₁₆H₁, and —C₈F₁₇). It is also possible for n to be an integer less than or equal to 6 and m to be an integer greater than 1. For example, in one particular embodiment, a chain comprises the formula —C₆F₁₂H₁. In another example, a chain comprises the formula —C₆F₁₃. In some embodiments, n is an integer less than or equal to 4, and m is an integer greater than 1 (e.g., —C₄F₇H₂, —C₄F₈H₁, —C₄F₉). The chain may include, in some embodiments, the formula —CₙF₂ₙ₊₁ (e.g., —(CF₂)ₙCF₃, such as —(CF₂)ₙCF₃ where n is greater than or equal to 2 and less than or equal to 3). As another example, in some embodiments, n is an integer greater than or equal to 6 and m is an integer greater than 1.

As one further example of a possible structure having the formula —CₙFₘR_{y}, in some embodiments n is greater than or equal to 3 and less than or equal to 5 (e.g., greater than or equal to 3 and less than or equal to 4), m is greater than or equal to 1, R is an atom or group of atoms, and y is greater than or equal to 0. It is also possible for m to be equal to 2n+1 (e.g., in the case where y=0).

Water-repellent additives that are polymeric (e.g., fluorinated polymers, polymers comprising a water-repellent functional group as described elsewhere herein) oligomeric (e.g., fluorinated oligomers, oligomers comprising a water-repellent functional group as described elsewhere herein), or monomeric may have a variety of suitable molecular weights. In some embodiments, a water-repellent additive that is a polymer, an oligomer, or a monomer has a weight average molecular weight of greater than or equal to 169 g/mol, greater than or equal to 200 g/mol, greater than or equal to 300 g/mol, greater than or equal to 400 g/mol, greater than or equal to 500 g/mol, greater than or equal to 600 g/mol, greater than or equal to 750 g/mol, greater than or equal to 1 kg/mol, greater than or equal to 2 kg/mol, greater than or equal to 5 kg/mol, greater than or equal to 7.5 kg/mol, greater than or equal to 10 kg/mol, greater than or equal to 15 kg/mol, greater than or equal to 20 kg/mol, greater than or equal to 30 kg/mol, greater than or equal to 50 kg/mol, greater than or equal to 60 kg/mol, greater than or equal to 75 kg/mol, greater than or equal to 100 kg/mol, greater than or equal to 125 kg/mol, greater than or equal to 150 kg/mol, or greater than or equal to 175 kg/mol. In some embodiments, a water-repellent additive that is a polymer, an oligomer, or a monomer has a weight average molecular weight of less than or equal to 200 kg/mol, less than or equal to 175 kg/mol, less than or equal to 150 kg/mol, less than or equal to 125 kg/mol, less than or equal to 100 kg/mol, less than or equal to 75 kg/mol, less than or equal to 60 kg/mol, less than or equal to 50 kg/mol, less than or equal to 30 kg/mol, less than or equal to 20 kg/mol, less than or equal to 15 kg/mol, less than or equal to 10 kg/mol, less than or equal to 7.5 kg/mol, less than or equal to 5 kg/mol, less than or equal to 2 kg/mol, less than or equal to 1 kg/mol, less than or equal to 750 g/mol, less than or equal to 600 g/mol, less than or equal to 500 g/mol, less than or equal to 400 g/mol, less than or equal to 300 g/mol, or less than or equal to 200 g/mol. Combinations of the above-referenced ranges are also possible (e.g., greater than or equal to 169 g/mol and less than or equal to 200 kg/mol, greater than or equal to 200 g/mol and less than or equal to 200 kg/mol, greater than or equal to 500 g/mol and less than or equal to 100 kg/mol, or greater than or equal to 1 kg/mol and less than or equal to 50 kg/mol). Other ranges are also possible.

The weight average molecular weight of a polymer, an oligomer, or monomer may be measured using gel permeation chromatography according to ASTM D5296 (2019).

When a filter media comprises two or more water-repellent additives that are polymers, two or more water-repellent additives that are oligomers, and/or both a polymeric water-repellent additive and an oligomeric water-repellent additive, each polymeric and oligomeric water-repellent additive may independently have a molecular weight in one or more of the ranges described above. In some embodiments, a water-repellent additive (e.g., a water-repellent additive comprising a water-repellent functional group, a water-repellent additive having a structure described elsewhere herein and/or as shown in Structures 1-9) is a reaction product of one or more precursors and/or monomers. Such reaction products and/or monomers may also have a molecular weight in one or more of the above-referenced ranges. It is of course also possible for water-repellent additives described herein to not be reaction products obtained from precursors and/or to be provided directly to the filter media in their final form. When occurring, the reaction from which the water-repellent additive is formed may occur prior to and/or during filter media fabrication. As an example, in some embodiments, the reaction may occur during a step in which a layer in which the water-repellent additive is positioned is formed (e.g., a wet laying step). As another example, in some embodiments, the reaction may occur during a step after which the precursor(s) have been introduced to a layer present in the filter media (e.g., a drying step, a curing step, a post curing step).

In some embodiments, a reaction in which a water-repellent additive is formed comprises reacting two or more precursors with each other that both contribute one or more functional groups to the reaction product (e.g., in an addition and/or polymerization reaction), reacting one or more precursors contributing functional groups the reaction product with one or more precursors not contributing functional groups to the reaction product (e.g., in a reaction catalyzed by the one or more precursors not contributing functional groups to the reaction product), and/or reacting one or more precursors with one or more components of a layer in which the water-repellent additive is to be present in and/or disposed on (e.g., a grafting reaction). Non-limiting examples of suitable types of reactions that may occur include hydrolysis reactions, condensation reactions, and curing reactions.

When a water-repellent additive is a reaction product of one or more precursors, the precursor(s) contributing functional groups to the reaction product may comprise one or more functional groups that are configured to and/or are capable of undergoing the relevant reaction. As an example, precursors contributing functional groups to the reaction product and configured to undergo a hydrolysis reaction may comprise one or more hydrolysable functional groups. Non-limiting examples of suitable hydrolysable functional groups include oxygenated functional groups (e.g., alcohol functional groups, methoxy functional groups, ethoxy functional groups, propoxy functional groups, butoxy functional groups, longer chain oxygenated functional groups) and halogenated functional groups (e.g., fluorine, chlorine, bromine). Functional groups configured to and/or capable of undergoing a reaction may be bonded to a silicon or metal atom prior to undergoing the relevant reaction. This silicon or metal atom may be a silicon or metal atom to which a water-repellent functional group is bonded and/or a silicon or metal atom to which a polar functional group is bonded. During and/or after the reaction, the functional groups configured to undergo the reaction may be partially or fully removed from the precursors, the water-repellent additive, and/or the filter media. Non-limiting examples of suitable precursors comprising silicon and/or metal atoms include silanes (e.g., n-octyltrimethoxysilane, n-hexadecyltrimethoxysilane), titanates, zirconates, and aluminates.

Without wishing to be bound by any particular theory, it is believed that the number of hydrolysable functional groups present in a precursor may affect the structure of the reaction product that it reacts to form. Precursors comprising one hydrolysable functional group may, upon hydrolysis of the hydrolysable functional group, react with and/or be configured to react with one other reactive species (e.g., another precursor comprising one or more hydrolysable functional groups, a portion of a layer in the filter media) and so may react to form small molecules. Precursors comprising two hydrolysable functional groups may, upon hydrolysis of the functional groups, react with and/or be configured to react with two other reactive species (e.g., another precursor comprising one or more hydrolysable functional groups, a portion of a layer in the filter media) and so may react to form polymers, oligomers, or other linear molecules. Precursors comprising three or more hydrolysable functional groups may, upon hydrolysis of the functional groups, react to form branched reaction products and/or covalent networks. When a combination of precursors is employed that comprises precursors having different amounts of hydrolysable functional groups from each other, combinations of the above-described reaction products may form and/or reaction products having characteristics of two or more of the above-described reaction products may form.

It is also possible for at least a portion of one or more precursors contributing functional groups to the reaction product to a water-repellent additive to comprise a water-repellent functional group (e.g., an alkyl group comprising greater than or equal to three carbon atoms, an alkenyl group comprising greater than or equal to three carbon atoms, an alkynyl group comprising greater than or equal to three carbon atoms) and/or for at least a portion one or more precursors to a water-repellent additive to comprise a polar functional group. When both types of functional groups are present, a single precursor contributing functional groups to the reaction product may be provided that comprises them both and/or at least one precursor contributing functional groups to the reaction product may be provided that comprises one of these types of functional groups but not the other.

As described above, in some embodiments, a reaction resulting in a water-repellent additive may be between at least one precursor contributing functional groups to the water-repellent additive and at least one precursor not contributing functional groups to the water-repellent additive. For instance, the reaction may comprise catalyzing the reaction of the precursor(s) contributing functional groups to the water-repellent additive by exposing them to the precursor(s) not contributing functional groups to the water-repellent additive. One non-limiting example of a class of precursors having the latter property is ammonium salts, one non-limiting example of which is ammonium chloride. It is also possible for heat, light (e.g., UV light), moisture, and/or a catalyst to be employed to catalyze a reaction.

As described elsewhere herein, some filter media and/or non-woven webs may comprise a resin. Some suitable resins may also be water-repellent additives as described above, and some resins may not be water-repellent additives as described above. In some embodiments, a resin may be water-repellent but not comprise a water-repellent functional group as described above. It is also possible for a resin to be water-repellent and comprise a water-repellent functional group. For example, in some embodiments, the filter media and/or non-woven web comprises a first type of resin and a second type of resin. Further details regarding some suitable resins are provided below.

When present, a resin may make up a variety of suitable amounts of a filter media and/or non-woven fiber web in which it is positioned. In some embodiments, a resin makes up greater than or equal to 0 wt %, greater than or equal to 0.1 wt %, greater than or equal to 0.2 wt %, greater than or equal to 0.5 wt %, greater than or equal to 0.75 wt %, greater than or equal to 1 wt %, greater than or equal to 2 wt %, greater than or equal to 5 wt %, greater than or equal to 7.5 wt %, greater than or equal to 10 wt %, greater than or equal to 12.5 wt %, greater than or equal to 15 wt %, greater than or equal to 20 wt %, greater than or equal to 25 wt %, greater than or equal to 30 wt %, greater than or equal to 35 wt %, greater than or equal to 40 wt %, or greater than or equal to 45 wt % of the filter media and/or non-woven fiber web. In some embodiments, a resin makes up less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 12.5 wt %, less than or equal to 10 wt %, less than or equal to 7.5 wt %, less than or equal to 5 wt %, less than or equal to 2 wt %, less than or equal to 1 wt %, less than or equal to 0.75 wt %, less than or equal to 0.5 wt %, less than or equal to 0.2 wt %, or less than or equal to 0.1 wt % of the filter media and/or non-woven fiber web. Combinations of the above-referenced ranges are also possible (e.g., greater than or equal to 0 wt % and less than or equal to 50 wt %, greater than or equal to 0 wt % and less than or equal to 35 wt %, greater than or equal to 1 wt % and less than or equal to 35 wt %, or greater than or equal to 0.5 wt % and less than or equal to 5 wt % of the first type of resin). Other ranges are also possible. Additionally, in some embodiments, a filter media and/or non-woven fiber web includes identically 0 wt % resin.

When a filter media comprises two or more resins, each resin may independently make up an amount of the filter media in one or more of the ranges described above. For example, in some embodiments, a filter media and/or non-woven fiber web comprises greater than 0 wt % and less than 50 wt % of a first type of resin (e.g., greater than or equal to 0.5 wt % and less than or equal to 5 wt % of the first type of resin) and/or greater than 0 wt % and less than 50 wt % of a second type of resin (e.g., greater than or equal to 0.5 wt % and less than or equal to 5 wt % of the second type of resin). In some embodiments, the total resin content of the filter media is in one or more of the ranges described above.

The filter media described herein may comprise a variety of suitable resins. Non-limiting examples of such resins include latexes, acrylic polymers, epoxies, phenolic polymers, silicones, poly(esters), poly(amide)s, poly(imide)s, poly(urethane)s, poly(urea)s, poly(aramid)s, and copolymers of the foregoing. Non-limiting examples of suitable copolymers include dipolymers, terpolymers, and quaterpolymers. Additionally, the arrangement of the repeat units within a resin that is a copolymer may generally be selected as desired. To provide non-limiting examples, suitable resins may include random copolymers, alternating copolymers, periodic copolymers, statistical copolymers, block copolymers, blocky copolymers, stereoblock copolymers, tapered copolymers, and/or graft copolymers. It is also possible for a filter to comprise two or more different resins. According to some embodiments, certain resins may be absent from the filter media. For example, in some embodiments, the filter media lacks a silicone-based resin. In some embodiments, the resin (e.g., any resin present in the non-woven fiber web) lacks silicon.

In some embodiments, a filter media comprises a resin that is a fluorinated resin. The fluorinated resin may be provided on its own, in combination with another fluorinated resin, and/or in combination with a non-fluorinated resin. In some embodiments, a filter media comprises a fluorinated resin that is also a water-repellent additive. The fluorinated resin may comprise a fluorinated repeat unit. For instance, in some embodiments, a fluorinated resin is one of the types of resins described in the preceding paragraph and comprises a fluorinated repeat unit. Further non-limiting examples of suitable repeat units include polymerized vinylidene difluoride repeat units, polymerized tetrafluoroethylene repeat units, polymerized hexafluoropropylene repeat units, polymerized vinyl fluoride repeat units, polymerized perfluorocycloalkene repeat units, polymerized chlorotrifluoroethylene repeat units, polymerized perfluoropropylvinylether repeat units, and polymerized perfluoromethylvinylether repeat units. In some embodiments, a filter media comprises a fluorinated resin that is a homopolymer, such as poly(tetrafluoroethylene) and/or poly(vinylidene difluoride). In some embodiments, the fluorinated repeat unit lacks a fluorinated side chain. In other words, some fluorinated resins may comprise fluorine atoms that are directly bonded to the backbone and lack fluorine atoms that are bonded to any side chains that are present. Other fluorinated resins may comprise fluorinated side chains.

When present, the fluorinated repeat unit may be the only repeat unit present in a fluorinated resin (in other words, the fluorinated resin may be a homopolymer) or the fluorinated repeat unit may be copolymerized with one or more additional non-fluorinated repeat units (in other words, the fluorinated resin may be a copolymer). Non-limiting examples of suitable types of non-fluorinated repeat units that may be copolymerized with fluorinated repeat units include polymerized non-fluorinated epoxy repeat units, polymerized non-fluorinated urethane repeat units, polymerized non-fluorinated ester repeat units, and polymerized non-fluorinated acrylic repeat units. In some embodiments, a fluorinated resin is a poly(vinylidene difluoride)-acrylic copolymer (i.e., a copolymer comprising vinylidene difluoride repeat units and non-fluorinated acrylic repeat units).

When a filter media comprises a fluorinated resin (e.g., a poly(vinylidene difluoride)-acrylic copolymer), the fluorinated repeat units may make up a variety of suitable amounts of the resin. In some embodiments, fluorinated repeat units make up greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, greater than or equal to 90 wt %, or greater than or equal to 95 wt % of the resin. In some embodiments, fluorinated repeat units make up less than or equal to 100 wt %, less than or equal to 95 wt %, less than or equal to 90 wt %, less than or equal to 85 wt %, less than or equal to 80 wt %, less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, or less than or equal to 35 wt % of the resin. Combinations of the above-referenced ranges are also possible (e.g., greater than or equal to 30 wt % and less than or equal to 100 wt %, or greater than or equal to 50 wt % and less than or equal to 100 wt %). Other ranges are also possible. In some embodiments, the fluorinated repeat units make up identically 100 wt % of the resin.

In some embodiments, a filter media comprises one resin having an amount of fluorinated repeat units in one or more of the above-referenced ranges and may further comprise other resins (which may each independently comprise fluorinated repeat units or lack fluorinated repeat units). In some embodiments, a filter media comprises two or more resins (at least one of which, but not necessarily all of which, comprise fluorinated repeat units), and all of the resins in the filter media together have an amount of fluorinated repeat units in one or more of the above-referenced ranges.

It is also possible for a resin to lack fluorinated repeat units and/or to be unfluorinated.

As described elsewhere herein, in some embodiments, a filter media comprises a non-woven fiber web. The non-woven fiber web may be a layer in which one or more of the above-described additives and/or resins are positioned and/or on which one or more of the above-described additives and/or resins are disposed (e.g., in the form of a coating). The non-woven fiber web may serve as the main filter layer. Non-limiting examples of non-woven fiber webs suitable for this purpose include wet laid fiber webs, non-wet laid fiber webs, and combinations of the two. Further details regarding some non-woven fiber webs suitable for use as main filter layers are provided below.

The non-woven fiber webs described herein may have a variety of suitable average fiber diameters. In some embodiments, the average fiber diameter of the fibers in a non-woven fiber web is greater than or equal to 0.1 micron, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.6 microns, greater than or equal to 0.75 microns, greater than or equal to 1 micron, greater than or equal to 2 microns, greater than or equal to 5 microns, greater than or equal to 7.5 microns, greater than or equal to 10 microns, greater than or equal to 12.5 microns, greater than or equal to 15 microns, greater than or equal to 17.5 microns, greater than or equal to 20 microns, greater than or equal to 22.5 microns, greater than or equal to 25 microns, greater than or equal to 27.5 microns, greater than or equal to 30 microns, greater than or equal to 35 microns, greater than or equal to 40 microns, or greater than or equal to 45 microns. In some embodiments, the average fiber diameter of the fibers in a non-woven fiber web is less than or equal to 50 microns, less than or equal to 45 microns, less than or equal to 40 microns, less than or equal to 35 microns, less than or equal to 30 microns, less than or equal to 27.5 microns, less than or equal to 25 microns, less than or equal to 22.5 microns, less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 2 microns, less than or equal to 1 micron, less than or equal to 0.75 microns, less than or equal to 0.5 microns, less than or equal to 0.4 microns, less than or equal to 0.3 microns, less than or equal to 0.25 microns, less than or equal to 0.2 microns, or less than or equal to 0.15 microns. Combinations of the above-referenced ranges are also possible (e.g., greater than or equal to 0.1 micron and less than or equal to 50 microns, greater than or equal to 0.3 microns and less than or equal to 25 microns, or greater than or equal to 0.5 microns and less than or equal to 10 microns). Other ranges are also possible.

When a filter media comprises two or more non-woven fiber webs, each non-woven fiber web may independently have an average fiber diameter in one or more of the ranges described above.

The non-woven fiber webs described herein may have a variety of suitable average fiber lengths. In some embodiments, the average fiber length of the fibers in a non-woven fiber web is greater than or equal to 0.001 inches, greater than or equal to 0.002 inches, greater than or equal to 0.003 inches, greater than or equal to 0.004 inches, greater than or equal to 0.005 inches, greater than or equal to 0.01 inches, greater than or equal to 0.05 inches, greater than or equal to 0.1 inches, greater than or equal to 0.15 inches, greater than or equal to 0.2 inches, greater than or equal to 0.25 inches, greater than or equal to 0.3 inches, greater than or equal to 0.35 inches, greater than or equal to 0.4 inches, greater than or equal to 0.45 inches, greater than or equal to 0.5 inches, greater than or equal to 0.55 inches, greater than or equal to 0.6 inches, greater than or equal to 0.65 inches, greater than or equal to 0.7 inches, greater than or equal to 0.75 inches, greater than or equal to 0.8 inches, greater than or equal to 0.85 inches, or greater than or equal to 0.9 inches. In some embodiments, the average fiber length of the fibers in a non-woven fiber web is less than or equal to 1 inch, less than or equal to 0.95 inches, less than or equal to 0.9 inches, less than or equal to 0.85 inches, less than or equal to 0.8 inches, less than or equal to 0.75 inches, less than or equal to 0.7 inches, less than or equal to 0.65 inches, less than or equal to 0.6 inches, less than or equal to 0.55 inches, less than or equal to 0.5 inches, less than or equal to 0.45 inches, less than or equal to 0.4 inches, less than or equal to 0.35 inches, less than or equal to 0.3 inches, less than or equal to 0.25 inches, less than or equal to 0.2 inches, less than or equal to 0.15 inches, less than or equal to 0.1 inches, less than or equal to 0.05 inches, or less than or equal to 0.01 inches. Combinations of the above-referenced ranges are also possible (e.g., greater than or equal to 0.001 inches and less than or equal to 1 inch, greater than or equal to 0.002 inches and less than or equal to 0.75 inches, or greater than or equal to 0.004 inches and less than or equal to 0.5 inches). Other ranges are also possible.

When a filter media comprises two or more non-woven fiber webs, each non-woven fiber web may independently have an average fiber length in one or more of the ranges described above.

In some embodiments, a non-woven fiber web comprises glass fibers. The glass fibers may make up a variety of suitable amounts of the non-woven fiber web. In some embodiments, glass fibers make up greater than or equal to 0 wt %, greater than 0 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, greater than or equal to 40 wt %, greater than or equal to 50 wt %, greater than or equal to 60 wt %, or greater than or equal to 80 wt % of the fibers in the non-woven fiber web. In some embodiments, glass fibers make up less than or equal to 100 wt %, less than or equal to 80 wt %, less than or equal to 60 wt %, less than or equal to 50 wt %, less than or equal to 40 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 2 wt %, or less than or equal to 1 wt % of the fibers in the non-woven fiber web. Combinations of the above-referenced ranges are also possible (e.g., greater than or equal to 0 wt % and less than or equal to 100 wt % or greater than 0 wt % and less than or equal to 100 wt %). Other ranges are also possible. In some embodiments, glass fibers make up exactly 0 wt % of the fibers in a non-woven fiber web. In some embodiments, glass fibers make up exactly 100 wt % of the fibers in a non-woven fiber web.

When a filter media comprises two or more non-woven fiber webs, each non-woven fiber web may independently have an amount of glass fibers in one or more of the ranges described above.

In some embodiments, a non-woven fiber web comprises microglass fibers. According to some embodiments, the non-woven fiber web comprises fine microglass fibers. In accordance with certain embodiments, the non-woven fiber web comprises microglass fibers having moderate diameters. In accordance with certain embodiments, the non-woven fiber web comprises coarse glass fibers (e.g., chopped strand glass fibers).

The microglass fibers may comprise microglass fibers drawn from bushing tips and further subjected to flame blowing or rotary spinning processes. In some cases, microglass fibers may be made using a remelting process. The microglass fibers may be microglass fibers for which alkali metal oxides (e.g., sodium oxides, magnesium oxides) make up 10-20 wt % of the fibers. Such fibers may have relatively lower melting and processing temperatures. Non-limiting examples of microglass fibers include B glass fibers, E glass fibers, S glass fibers, M glass fibers according to Man Made Vitreous Fibers by Nomenclature Committee of TIMA Inc. March 1993, Page 45, C glass fibers (e.g., Lauscha C glass fibers, JM 253 C glass fibers), and non-persistent glass fibers (e.g., fibers that are configured to dissolve completely in the fluid present in human lungs in less than or equal to 40 days, such as Johns Manville 481 fibers). It should be understood that microglass fibers present in a non-woven fiber web may comprise one or more of the types of microglass fibers described herein.

When present, the microglass fibers may make up a variety of suitable amounts of a non-woven fiber web. In some embodiments, the microglass fibers make up greater than or equal to 1 wt %, greater than or equal to greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, greater than or equal to 40 wt %, greater than or equal to 50 wt %, greater than or equal to 60 wt %, or greater than or equal to 80 wt % of the fibers in the non-woven fiber web. In some embodiments, microglass fibers make up less than or equal to 100 wt %, less than or equal to 80 wt %, less than or equal to 60 wt %, less than or equal to 50 wt %, less than or equal to 40 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, or less than or equal to 2 wt % of the fibers in the non-woven fiber web. Combinations of the above-referenced ranges are also possible (e.g., greater than or equal to 1 wt % and less than or equal to 100 wt %). Other ranges are also possible. In some embodiments, glass fibers make up exactly 100 wt % of the fibers in a non-woven fiber web.

When a non-woven fiber web comprises two or more types of microglass fibers, each type of microglass fiber may independently make up an amount of the non-woven fiber web in one or more of the ranges described above. Additionally, in some embodiments, a total amount of microglass fibers in a non-woven fiber web may be in one or more of the ranges described above. Similarly, when a filter media comprises two or more non-woven fiber webs, each type of microglass fiber may independently make up an amount of each non-woven fiber web in one or more of the ranges described above and/or the total amount of microglass fibers in each non-woven fiber web may independently be in one or more of the ranges described above.

When present, the microglass fibers may have a variety of suitable average diameters. In some embodiments, the average diameter of the microglass fibers in a non-woven fiber web is greater than or equal to 0.1 micron, greater than or equal to 0.15 microns, greater than or equal to 0.2 microns, greater than or equal to 0.25 microns, greater than or equal to 0.3 microns, greater than or equal to 0.35 microns, greater than or equal to 0.4 microns, greater than or equal to 0.45 microns, greater than or equal to 0.5 microns, greater than or equal to 0.55 microns, greater than or equal to 0.6 microns, greater than or equal to 0.65 microns, greater than or equal to 0.7 microns, greater than or equal to 0.75 microns, greater than or equal to 0.8 microns, greater than or equal to 0.85 microns, greater than or equal to 0.9 microns, greater than or equal to 0.95 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 5 microns, or greater than or equal to 7.5 microns. In some embodiments, the average diameter of the microglass fibers in a non-woven fiber web is less than or equal to 10 microns, less than or equal to 7.5 microns, less than or equal to 6 microns, less than or equal to 5 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.95 microns, less than or equal to 0.9 microns, less than or equal to 0.85 microns, less than or equal to 0.8 microns, less than or equal to 0.75 microns, less than or equal to 0.7 microns, less than or equal to 0.65 microns, less than or equal to 0.6 microns, less than or equal to 0.55 microns, less than or equal to 0.5 microns, less than or equal to 0.45 microns, less than or equal to 0.4 microns, less than or equal to 0.35 microns, less than or equal to 0.3 microns, less than or equal to 0.25 microns, less than or equal to 0.2 microns, or less than or equal to 0.15 microns. Combinations of the above-referenced ranges are also possible (e.g., greater than or equal to 0.1 micron and less than or equal to 10 microns, greater than or equal to 0.1 micron and less than or equal to 1 micron, greater than or equal to 0.2 microns and less than or equal to 0.8 microns, greater than or equal to 0.4 microns and less than or equal to 0.8 microns, greater than or equal to 0.2 microns and less than or equal to 0.55 microns, greater than or equal to 0.2 microns and less than or equal to 0.4 microns, greater than or equal to 0.4 microns and less than or equal to 1 micron, greater than or equal to 0.5 microns and less than or equal to 1 micron, greater than 1 micron and less than or equal to 6 microns, greater than or equal to 2 microns and less than or equal to 10 microns, or greater than or equal to 2.5 microns and less than or equal to 10 microns). Other ranges are also possible.

When a non-woven fiber web comprises two or more types of microglass fibers, each type of microglass fiber may have an average diameter in one or more of the ranges described above. Additionally, in some embodiments, all of the microglass fibers in a non-woven fiber web together have an average diameter in one or more of the ranges described above. Similarly, when a filter media comprises two or more non-woven fiber webs, each non-woven fiber web may independently comprise microglass fibers (of one or more types independently, of all types together) having an average diameter in one or more of the ranges described above.

When present, the microglass fibers may have a variety of suitable average fiber lengths. In some embodiments, the microglass fibers have an average fiber length of greater than or equal to 0.001 inches, greater than or equal to 0.002 inches, greater than or equal to 0.003 inches, greater than or equal to 0.004 inches, greater than or equal to 0.006 inches, greater than or equal to 0.008 inches, greater than or equal to 0.01 inches, greater than or equal to 0.025 inches, greater than or equal to 0.05 inches, greater than or equal to 0.075 inches, greater than or equal to 0.1 inches, greater than or equal to 0.2 inches, greater than or equal to 0.3 inches, greater than or equal to 0.4 inches, greater than or equal to 0.5 inches, greater than or equal to 0.6 inches, greater than or equal to 0.75 inches, or greater than or equal to 0.9 inches. In some embodiments, the microglass fibers have an average fiber length of less than or equal to 1 inch, less than or equal to 0.9 inches, less than or equal to 0.75 inches, less than or equal to 0.6 inches, less than or equal to 0.5 inches, less than or equal to 0.4 inches, less than or equal to 0.3 inches, less than or equal to 0.2 inches, less than or equal to 0.1 inches, less than or equal to 0.075 inches, less than or equal to 0.05 inches, less than or equal to 0.025 inches, less than or equal to 0.01 inches, less than or equal to 0.008 inches, less than or equal to 0.006 inches, less than or equal to 0.004 inches, less than or equal to 0.003 inches, less than or equal to 0.002 inches, or less than or equal to 0.001 inches. Combinations of the above-referenced ranges are also possible (e.g., greater than or equal to 0.001 inches and less than or equal to 1 inch, greater than or equal to 0.003 inches and less than or equal to 0.75 inches, or greater than or equal to 0.01 inches and less than or equal to 0.5 inches). Other ranges are also possible.

When a non-woven fiber web comprises two or more types of microglass fibers, each type of microglass fiber may independently have an average fiber length in one or more of the ranges described above and/or all of the microglass fibers in a non-woven fiber web of the first type may together have an average fiber length in one or more of the ranges described above. Similarly, when a filter media comprises two or more non-woven fiber webs, each non-woven fiber web may independently comprise one or more types of microglass fibers having an average fiber length in one or more of the ranges described above and/or may comprise microglass fibers that overall have an average fiber length in one or more of the ranges described above.

When present, the microglass fibers may have a variety of suitable aspect ratios. In some embodiments, the microglass fibers have an aspect ratio of greater than or equal to 100, greater than or equal to 150, greater than or equal to 200, greater than or equal to 300, greater than or equal to 400, greater than or equal to 500, greater than or equal to 750, greater than or equal to 1000, greater than or equal to 1500, greater than or equal to 2000, greater than or equal to 2500, greater than or equal to 3000, greater than or equal to 3500, greater than or equal to 4000, greater than or equal to 5000, greater than or equal to 6000, greater than or equal to 7000, greater than or equal to 8000, greater than or equal to 9000, greater than or equal to 10000, greater than or equal to 20000, greater than or equal to 30000, greater than or equal to 40000, greater than or equal to 50000, greater than or equal to 60000, greater than or equal to 70000, greater than or equal to 80000, or greater than or equal to 90000. In some embodiments, the microglass fibers have an aspect ratio of less than or equal to 100000, less than or equal to 90000, less than or equal to 80000, less than or equal to 70000, less than or equal to 60000, less than or equal to 50000, less than or equal to 40000, less than or equal to 30000, less than or equal to 20000, less than or equal to 10000, less than or equal to 9000, less than or equal to 8000, less than or equal to 7000, less than or equal to 6000, less than or equal to 5000, less than or equal to 4000, less than or equal to 3500, less than or equal to 3000, less than or equal to 2500, less than or equal to 2000, less than or equal to 1500, less than or equal to 1000, less than or equal to 750, less than or equal to 500, less than or equal to 400, less than or equal to 300, less than or equal to 200, or less than or equal to 150. Combinations of the above-referenced ranges are also possible (e.g., greater than or equal to 100 and less than or equal to 100000, greater than or equal to 100 and less than or equal to 10000, greater than or equal to 200 and less than or equal to 2500, or greater than or equal to 300 and less than or equal to 1000). Other ranges are also possible.

When a non-woven fiber web comprises two or more types of microglass fibers, each type of microglass fiber may independently have an aspect ratio in one or more of the ranges described above and/or all of the microglass fibers in a non-woven fiber web may together have an aspect ratio in one or more of the ranges described above. Similarly, when a filter media comprises two or more non-woven fiber webs, each non-woven fiber web may independently comprise one or more types of microglass fibers having an aspect ratio in one or more of the ranges described above and/or may comprise glass fibers that overall have an aspect ratio in one or more of the ranges described above.

In some embodiments, a non-woven fiber web comprises a particular type of microglass fibers in a particularly advantageous amount. For example, in some embodiments, a non-woven fiber web comprises fine microglass fibers (e.g., having an average diameter of less than or equal to 1 micron (e.g., greater than or equal to 0.1 micron and less than or equal to 1 micron, greater than or equal to 0.2 microns and less than or equal to 0.8 microns or greater than or equal to 0.4 microns and less than or equal to 0.8 microns)) in an amount of greater than or equal to 0 wt %, greater than 0 wt %, greater than or equal to 1.5 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 75 wt %, greater than or equal to 80 wt %, or greater than or equal to 90 wt % of the fibers in the non-woven fiber web. In some embodiments, a non-woven fiber web comprises fine microglass fibers in an amount of less than or equal to 95 wt %, less than or equal to 90 wt %, less than or equal to 80 wt %, less than or equal to 75 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 15 wt %, less than or equal to 10 wt %, less than or equal to 7.5 wt %, less than or equal to 5 wt %, less than or equal to 2 wt %, or less than or equal to 1.5 wt % of the fibers in a non-woven fiber web. Combinations of the above-referenced ranges are also possible (e.g., greater than or equal to 0 wt % and less than or equal to 95 wt %, greater than or equal to 0 wt % and less than or equal to 75 wt %, greater than or equal to 0 wt % and less than or equal to 60 wt %, greater than 0 wt % and less than or equal to 95 wt %, greater than 0 wt % and less than or equal to 75 wt %, greater than 0 wt % and less than or equal to 60 wt %, greater than or equal to 1.5 wt % and less than or equal to 100 wt %, greater than 0 wt % and less than or equal to 95 wt %, greater than or equal to 5 wt % and less than or equal to 60 wt %, greater than or equal to 10 wt % and less than or equal to 20 wt %, or greater than or equal to 40 wt % and less than or equal to 50 wt %). Other ranges are also possible. In some embodiments, fine microglass fibers make up exactly 0 wt % of the fibers in a non-woven fiber web.

When a filter media comprises two or more non-woven fiber webs, each non-woven fiber web may independently comprise an amount of fine microglass fibers in one or more of the ranges described above.

In some embodiments, a non-woven fiber web comprises microglass fibers having moderate diameters (e.g., having an average diameter of greater than 1 micron and less than or equal to 6 microns (e.g., greater than or equal to 2 microns and less than or equal to 6 microns or greater than or equal to 3 microns and less than or equal to 5 microns)) in an amount of greater than 0 wt %, greater than or equal to 1.5 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, or greater than or equal to 90 wt % of the fibers in the non-woven fiber web. In some embodiments, a non-woven fiber web comprises microglass fibers having moderate diameters in an amount of less than or equal to 95 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 15 wt %, less than or equal to 10 wt %, less than or equal to 7.5 wt %, less than or equal to 5 wt %, less than or equal to 2 wt %, or less than or equal to 1.5 wt % of the fibers in a non-woven fiber web. Combinations of the above-referenced ranges are also possible (e.g., greater than 0 wt % and less than or equal to 95 wt %, greater than or equal to 20 wt % and less than or equal to 80 wt %, greater than or equal to 30 wt % and less than or equal to 70 wt %, greater than or equal to 30 wt % and less than or equal to 40 wt %, or greater than or equal to 60 wt % and less than or equal to 70 wt %). Other ranges are also possible.

When a filter media comprises two or more non-woven fiber webs, each non-woven fiber web may independently comprise an amount of microglass fibers having moderate diameters in one or more of the ranges described above.

In some embodiments, a non-woven fiber web comprises coarse glass fibers (e.g., microglass fibers and/or chopped strand glass fibers). When present, the coarse glass fibers may have a variety of suitable average diameters. In some embodiments, the coarse glass fibers in a non-woven fiber web have an average diameter of greater than 6 microns, greater than or equal to 6.25 microns, greater than or equal to 6.5 microns, greater than or equal to 7 microns, greater than or equal to 8 microns, greater than or equal to 10 microns, greater than or equal to 12 microns, greater than or equal to 15 microns, greater than or equal to 18 microns, greater than or equal to 20 microns, greater than or equal to 23 microns, or greater than or equal to 25 microns. In certain embodiments, the coarse glass fibers in a non-woven fiber web have an average diameter of less than or equal to 30 microns, less than or equal to 28 microns, less than or equal to 25 microns, less than or equal to 23 microns, less than or equal to 20 microns, less than or equal to 18 microns, less than or equal to 15 microns, less than or equal to 14 microns, less than or equal to 13 microns, less than or equal to 12 microns, less than or equal to 11 microns, less than or equal to 10 microns, less than or equal to 9 microns, less than or equal to 8 microns, or less than or equal to 7 microns. Combinations of the above-referenced ranges are also possible (e.g., greater than 6 microns and less than or equal to 30 microns, greater than 6 microns and less than or equal to 14 microns, greater than 6 microns and less than or equal to 10 microns, or greater than 6 microns and less than or equal to 8 microns). Other ranges are also possible.

When present, the coarse glass fibers may be present in any suitable amount. In some embodiments, a non-woven fiber web comprises coarse glass fibers in an amount of greater than or equal to 0 wt %, greater than 0 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, or greater than or equal to 55 wt % of the fibers in a non-woven fiber web. In some embodiments, a non-woven fiber web comprises coarse glass fibers in an amount of less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 2 wt %, or less than or equal to 1 wt % of the fibers in a non-woven fiber web. Combinations of the above-referenced ranges are also possible (e.g., greater than or equal to 0 wt % and less than or equal to 60 wt %, greater than 0 wt % and less than or equal to 60 wt %, greater than or equal to 5 wt % and less than or equal to 25 wt %, or greater than or equal to 10 wt % and less than or equal to 20 wt %). Other ranges are also possible. In some embodiments, coarse glass fibers make up exactly 0 wt % of the fibers in a non-woven fiber web.

When a filter media comprises two or more non-woven fiber webs, each non-woven fiber web may independently comprise an amount of coarse fibers in one or more of the ranges described above.

In some embodiments, a filter media may comprise one, two, three, or more types of glass fibers (e.g., two or all of the following: fine microglass fibers, microglass fibers having a moderate diameter, and coarse glass fibers). In embodiments comprising two or more types of glass fibers (e.g., both fine microglass fibers and microglass fibers having moderate diameters, both fine microglass fibers and coarse glass fibers, both microglass fibers having a moderate diameter and coarse glass fibers, or all three of the foregoing types of glass fibers), glass fibers falling into a category described by a relatively larger diameter may have an average diameter larger than that of the glass fibers falling into the category described by a relatively small diameter. The differences in fiber diameter between populations of microglass fibers present may be sufficiently large such that the two or more populations of fibers could be readily distinguished by microscopy.

In some embodiments, a non-woven fiber web comprises coarse glass fibers comprising chopped strand glass fibers. In some embodiments, the coarse glass fibers present in the non-woven fiber web are chopped strand glass fibers. The chopped strand glass fibers may comprise chopped strand glass fibers which were produced by drawing a melt of glass from bushing tips into continuous fibers and then cutting the continuous fibers into short fibers. In some embodiments, a non-woven fiber web comprises chopped strand glass fibers for which alkali metal oxides (e.g., sodium oxides, magnesium oxides) make up a relatively low amount of the fibers. It is also possible for a non-woven fiber web to comprise chopped strand glass fibers that include relatively large amounts of calcium oxide and/or alumina (Al₂O₃). In some embodiments, a non-woven fiber web comprises S-glass fibers, which include approximately 10 wt % magnesium oxide. It should be understood that chopped strand glass fibers present in a non-woven fiber web may comprise one or more of the types of chopped strand glass fibers described herein.

When present, chopped strand glass fibers may make up a variety of suitable amounts of a non-woven fiber web. In some embodiments, chopped strand glass fibers make up greater than or equal to 0 wt %, greater than 0 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, or greater than or equal to 55 wt % of the fibers in a non-woven fiber web. In some embodiments, chopped strand glass fibers make up less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 2 wt %, or less than or equal to 1 wt % of the fibers in a non-woven fiber web. Combinations of the above-referenced ranges are also possible (e.g., greater than or equal to 0 wt % and less than or equal to 60 wt %, greater than 0 wt % and less than or equal to 60 wt %, greater than or equal to 5 wt % and less than or equal to 25 wt %, greater than or equal to 10 wt % and less than or equal to 20 wt %, greater than 0 wt % and less than or equal to 50 wt %, or greater than or equal to 0 wt % and less than or equal to 50 wt %). Other ranges are also possible. In some embodiments, chopped strand glass fibers make up exactly 0 wt % of the fibers in a non-woven fiber web.

In some embodiments, a non-woven fiber web comprises two or more types of chopped strand glass fibers. For example, in some embodiments, a non-woven fiber web comprises a first type of chopped strand glass fibers and a second type of chopped strand glass fibers. When a non-woven fiber web comprises two or more types of chopped strand glass fibers, each type of chopped strand glass fiber may independently make up an amount of the non-woven fiber web in one or more of the ranges described above. Additionally, in some embodiments, a total amount of chopped strand glass fibers in a non-woven fiber web may be in one or more of the ranges described above. Similarly, when a filter media comprises two or more non-woven fiber webs, each type of chopped strand glass fiber may independently make up an amount of each non-woven fiber web in one or more of the ranges described above and/or the total amount of chopped strand glass fibers in each non-woven fiber web may independently be in one or more of the ranges described above.

When present, the chopped strand glass fibers may have a variety of suitable average diameters. In some embodiments, a non-woven fiber web comprises chopped strand glass fibers having an average diameter of greater than 6 microns, greater than or equal to 6.25 microns, greater than or equal to 6.5 microns, greater than or equal to 7 microns, greater than or equal to 8 microns, greater than or equal to 10 microns, greater than or equal to 12.5 microns, greater than or equal to 14 microns, greater than or equal to 15 microns, greater than or equal to 17 microns, greater than or equal to 20 microns, greater than or equal to 22 microns, or greater than or equal to 25 microns. In some embodiments, a non-woven fiber web comprises chopped strand glass fibers having an average diameter of less than or equal to 30 microns, less than or equal to 28 microns, less than or equal to 25 microns, less than or equal to 23 microns, less than or equal to 20 microns, less than or equal to 18 microns, less than or equal to 15 microns, less than or equal to 14 microns, less than or equal to 13 microns, less than or equal to 12 microns, less than or equal to 11 microns, less than or equal to 10 microns, less than or equal to 9 microns, less than or equal to 8 microns, or less than or equal to 7 microns. Combinations of the above-referenced ranges are also possible (e.g., greater than 6 microns and less than or equal to 30 microns, greater than 6 microns and less than or equal to 14 microns, or greater than 6 microns and less than or equal to 10 microns). Other ranges are also possible.

When a non-woven fiber web comprises two or more types of chopped strand glass fibers, each type of chopped strand glass fiber may have an average diameter in one or more of the ranges described above. Additionally, in some embodiments, all of the chopped strand glass fibers in a non-woven fiber web together have an average diameter in one or more of the ranges described above. Similarly, when a filter media comprises two or more non-woven fiber webs, each non-woven fiber web may independently comprise chopped strand glass fibers (of one or more types independently, of all types together) having an average diameter in one or more of the ranges described above.

When present, the chopped strand glass fibers may have a variety of suitable average lengths. In some embodiments, a non-woven fiber web comprises chopped strand glass fibers having an average length of greater than or equal to 0.004 inches, greater than or equal to 0.005 inches, greater than or equal to 0.0075 inches, greater than or equal to 0.01 inch, greater than or equal to 0.02 inches, greater than or equal to 0.05 inches, greater than or equal to 0.075 inches, greater than or equal to 0.1 inch, greater than or equal to 0.2 inches, greater than or equal to 0.5 inches, greater than or equal to 0.75 inches, greater than or equal to 1 inch, greater than or equal to 1.25 inches, greater than or equal to 1.5 inches, greater than or equal to 2 inches, or greater than or equal to 2.5 inches. In some embodiments, a non-woven fiber web comprises chopped strand glass fibers having an average length of less than or equal to 3 inches, less than or equal to 2.5 inches, less than or equal to 2 inches, less than or equal to 1.5 inches, less than or equal to 1.25 inches, less than or equal to 1 inch, less than or equal to 0.75 inches, less than or equal to 0.5 inches, less than or equal to 0.2 inches, less than or equal to 0.1 inch, less than or equal to 0.075 inches, less than or equal to 0.05 inches, less than or equal to 0.02 inches, less than or equal to 0.01 inch, less than or equal to 0.0075 inches, or less than or equal to 0.005 inches. Combinations of the above-referenced ranges are also possible (e.g., greater than or equal to 0.004 inches and less than or equal to 3 inches, greater than or equal to 0.004 inches and less than or equal to 2 inches, or greater than or equal to 0.05 inches and less than or equal to 3 inches). Other ranges are also possible.

When a non-woven fiber web comprises two or more types of chopped strand glass fibers, each type of chopped strand glass fiber may have an average length in one or more of the ranges described above. Additionally, in some embodiments, all of the chopped strand glass fibers in a non-woven fiber web together have an average length in one or more of the ranges described above. Similarly, when a filter media comprises two or more non-woven fiber webs, each non-woven fiber web may independently comprise chopped strand glass fibers (of one or more types independently, of all types together) having an average length in one or more of the ranges described above.

In some embodiments, a non-woven fiber web comprises natural fibers. When present, the natural fibers may make up a variety of suitable amounts of the non-woven fiber web. In some embodiments, natural fibers make up greater than or equal to 0 wt %, greater than 0 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, greater than or equal to 40 wt %, greater than or equal to 50 wt %, greater than or equal to 60 wt %, or greater than or equal to 80 wt % of the fibers in a non-woven fiber web. In some embodiments, natural fibers make up less than or equal to 100 wt %, less than or equal to 80 wt %, less than or equal to 60 wt %, less than or equal to 50 wt %, less than or equal to 40 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 2 wt %, or less than or equal to 1 wt % of the fibers in a non-woven fiber web. Combinations of the above-referenced ranges are also possible (e.g., greater than or equal to 0 wt % and less than or equal to 100 wt % or greater than 0 wt % and less than or equal to 100 wt %). Other ranges are also possible. In some embodiments, natural fibers make up exactly 0 wt % of the fibers in a non-woven fiber web. In some embodiments, natural fibers make up exactly 100 wt % of the fibers in a non-woven fiber web.

When a non-woven fiber web comprises two or more types of natural fibers, each type of natural fiber may independently make up an amount of the non-woven fiber web in one or more of the ranges described above. Additionally, in some embodiments, a total amount of natural fibers in a non-woven fiber web may be in one or more of the ranges described above. Similarly, when a filter media comprises two or more non-woven fiber webs, each type of natural fiber may independently make up an amount of each non-woven fiber web in one or more of the ranges described above and/or the total amount of natural fibers in each non-woven fiber web may independently be in one or more of the ranges described above.

One example of a natural fiber is natural cellulose fibers. When a fiber web comprises natural cellulose fibers, the natural cellulose fibers may be wood (e.g., cedar) fibers, such as softwood fibers and/or hardwood fibers. Other examples of natural cellulose fibers are also possible (e.g., nano-cellulose fibers, such as nanofibrillated fibers and/or fibrous cellulose nanocrystals; microfibrillated cellulose). It is also possible for a fiber web to comprise wool.

Exemplary softwood fibers include fibers obtained from mercerized southern pine (“mercerized southern pine fibers or HPZ fibers”), northern bleached softwood kraft (e.g., fibers obtained from Robur Flash (“Robur Flash fibers”)), southern bleached softwood kraft (e.g., fibers obtained from Brunswick pine (“Brunswick pine fibers”)), and/or chemically treated mechanical pulps (“CTMP fibers”). For example, HPZ fibers can be obtained from Buckeye Technologies, Inc., Memphis, TN; Robur Flash fibers can be obtained from Rottneros AB, Stockholm, Sweden; and Brunswick pine fibers can be obtained from Georgia-Pacific, Atlanta, GA.

Exemplary hardwood fibers include fibers obtained from Eucalyptus (“Eucalyptus fibers”). Eucalyptus fibers are commercially available from, e.g., (1) Suzano Group, Suzano, Brazil (“Suzano fibers”), (2) Group Portucel Soporcel, Cacia, Portugal (“Cacia fibers”), (3) Tembec, Inc., Temiscaming, QC, Canada (“Tarascon fibers”), (4) Kartonimex Intercell, Duesseldorf, Germany, (“Acacia fibers”), (5) Mead-Westvaco, Stamford, CT (“Westvaco fibers”), and (6) Georgia-Pacific, Atlanta, GA (“Leaf River fibers”).

When present, the natural fibers may have a variety of suitable average diameters. In some embodiments, a non-woven fiber web comprises natural fibers having an average diameter of greater than or equal to 1 micron, greater than or equal to 2 microns, greater than or equal to 5 microns, greater than or equal to 7.5 microns, greater than or equal to 10 microns, greater than or equal to 15 microns, greater than or equal to 20 microns, greater than or equal to 30 microns, or greater than or equal to 40 microns. In some embodiments, a non-woven fiber web comprises natural fibers having an average diameter of less than or equal to 50 microns, less than or equal to 40 microns, less than or equal to 30 microns, less than or equal to 20 microns, less than or equal to 15 microns, less than or equal to 10 microns, less than or equal to 7.5 microns, less than or equal to 5 microns, or less than or equal to 2 microns. Combinations of the above-referenced ranges are also possible (e.g., greater than or equal to 1 micron and less than or equal to 50 microns). Other ranges are also possible.

When a non-woven fiber web comprises two or more types of natural fibers, each type of natural fiber may have an average diameter in one or more of the ranges described above. Additionally, in some embodiments, all of the natural fibers in a non-woven fiber web together have an average diameter in one or more of the ranges described above. Similarly, when a filter media comprises two or more non-woven fiber webs, each non-woven fiber web may independently comprise natural fibers (of one or more types independently, of all types together) having an average diameter in one or more of the ranges described above.

In some embodiments, a non-woven fiber web comprises synthetic fibers. The synthetic fibers may make up a variety of suitable amounts of the non-woven fiber web. In some embodiments, synthetic fibers make up greater than or equal to 0 wt %, greater than 0 wt %, greater than or equal to 0.1 wt %, greater than or equal to 0.5 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, greater than or equal to 40 wt %, greater than or equal to 50 wt %, greater than or equal to 60 wt %, or greater than or equal to 80 wt % of the fibers in a non-woven fiber web. In some embodiments, synthetic fibers make up less than or equal to 100 wt %, less than or equal to 80 wt %, less than or equal to 60 wt %, less than or equal to 50 wt %, less than or equal to 40 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 2 wt %, less than or equal to 1 wt %, less than or equal to 0.5 wt %, or less than or equal to 0.1 wt % of the fibers in a non-woven fiber web. Combinations of the above-referenced ranges are also possible (e.g., greater than or equal to 0 wt % and less than or equal to 100 wt % or greater than 0 wt % and less than or equal to 100 wt %). Other ranges are also possible. In some embodiments, synthetic fibers make up exactly 0 wt % of the fibers in a non-woven fiber web. In some embodiments, synthetic fibers make up exactly 100 wt % of the fibers in a non-woven fiber web.

When a non-woven fiber web comprises two or more types of synthetic fibers, each type of synthetic fiber may independently make up an amount of the non-woven fiber web in one or more of the ranges described above. Additionally, in some embodiments, a total amount of synthetic fibers in a non-woven fiber web may be in one or more of the ranges described above. Similarly, when a filter media comprises two or more non-woven fiber webs, each type of synthetic fiber may independently make up an amount of each non-woven fiber web in one or more of the ranges described above and/or the total amount of synthetic fibers in each non-woven fiber web may independently be in one or more of the ranges described above.

A variety of suitable types of synthetic fibers may be employed in the non-woven fiber webs described herein. In some embodiments, a non-woven fiber web comprises monocomponent synthetic fibers. Non-limiting examples of suitable polymers that may be included in synthetic fibers include: acrylics, poly(vinyl alcohol) (PVOH), poly(ester)s (e.g., poly(ethylene terephthalate)), poly(acrylonitrile), poly(olefin)s (e.g., poly(ethylene), poly(propylene)), poly(vinylidene difluoride), poly(ether sulfone), poly(vinyl chloride), poly(amide)s, poly(imide)s, aramids (e.g., meta-aramids, para-aramids), poly(etherimide), poly(ether ether ketone), liquid crystal polymers (e.g., poly(p-phenylene-2,6-benzobisoxazole; poly(ester)-based liquid crystal polymers, such as fibers produced by the polycondensation of 4-hydroxybenzoic acid and 6-hydroxynaphthalene-2-carboxylic acid), regenerated cellulose (e.g., lyocell, rayon), celluloid, cellulose acetate, carboxymethylcellulose copolymers of the foregoing, and blends of the foregoing.

According to some embodiments, the non-woven fiber web may have a relatively low percentage of synthetic fibers (e.g., less than or equal to 5 wt %, less than or equal to 3 wt %, less than or equal to 1 wt %, less than or equal to 0.5 wt %, less than or equal to 0.1 wt %, or 0 wt %, or any of the other ranges disclosed above) other than fibrillated fibers (e.g., lyocell fibers). In some embodiments, the non-woven fiber web may be substantially free of synthetic fibers other than fibrillated fibers (e.g., lyocell fibers). In some embodiments, the non-woven fiber web lacks synthetic fibers other than fibrillated fibers (e.g., lyocell fibers).

In some embodiments, the non-woven fiber web comprises synthetic fibers comprising poly(vinyl alcohol) in a relatively low amount (e.g., less than or equal to 2 wt %, less than or equal to 1 wt %, less than or equal to 0.5 wt %, less than or equal to 0.1 wt %, or 0 wt % of the fibers in a non-woven fiber web). This may be desirable, in some embodiments, as the presence of the poly(vinyl alcohol) fibers may decrease a gamma value of the filter media containing the poly(vinyl alcohol) fibers compared to a substantially identical filter media lacking the poly(vinyl alcohol) fibers, in some cases. In some embodiments, the non-woven fiber web may be substantially free of synthetic fibers comprising poly(vinyl alcohol). In some embodiments, the non-woven fiber web lacks synthetic fibers comprising poly(vinyl alcohol).

When present, the synthetic fibers (e.g., lyocell fibers) may have a variety of suitable average diameters. In some embodiments, a non-woven fiber web comprises synthetic fibers having an average diameter of greater than or equal to 0.01 micron, greater than or equal to 0.02 microns, greater than or equal to 0.05 microns, greater than or equal to 0.075 microns, greater than or equal to 0.1 micron, greater than or equal to 0.2 microns, greater than or equal to 0.5 microns, greater than or equal to 0.75 microns, greater than or equal to 1 micron, greater than or equal to 2 microns, greater than or equal to 5 microns, greater than or equal to 7.5 microns, greater than or equal to 10 microns, greater than or equal to 20 microns, greater than or equal to 50 microns, or greater than or equal to 75 microns. In some embodiments, a non-woven fiber web comprises synthetic fibers having an average diameter of less than or equal to 100 microns, less than or equal to 75 microns, less than or equal to 50 microns, less than or equal to 20 microns, less than or equal to 10 microns, less than or equal to 7.5 microns, less than or equal to 5 microns, less than or equal to 2 microns, less than or equal to 1 micron, less than or equal to 0.75 microns, less than or equal to 0.5 microns, less than or equal to 0.2 microns, less than or equal to 0.1 micron, less than or equal to 0.075 microns, less than or equal to 0.05 microns, or less than or equal to 0.02 microns. Combinations of the above-referenced ranges are also possible (e.g., greater than or equal to 0.01 micron and less than or equal to 100 microns). Other ranges are also possible.

When a non-woven fiber web comprises two or more types of synthetic fibers, each type of synthetic fiber may have an average diameter in one or more of the ranges described above. Additionally, in some embodiments, all of the synthetic fibers in a non-woven fiber web together have an average diameter in one or more of the ranges described above. Similarly, when a filter media comprises two or more non-woven fiber webs, each non-woven fiber web may independently comprise synthetic fibers (of one or more types independently, of all types together) having an average diameter in one or more of the ranges described above.

When present, synthetic fibers may comprise continuous fibers and/or non-continuous fibers. Continuous fibers may be made by a “continuous” fiber-forming process, such as a meltblown or a spunbond process, and typically have longer lengths than non-continuous fibers. Non-continuous fibers may be staple fibers that may be cut (e.g., from a filament) or formed as non-continuous discrete fibers to have a particular length or a range of lengths as described in more detail herein. In certain embodiments, a non-woven fiber web comprises continuous fibers that have an average length of greater than 5 inches.

When present, the synthetic fibers may have a variety of suitable average lengths. In some embodiments, a non-woven fiber web comprises synthetic fibers having an average length of greater than or equal to 0.01 inch, greater than or equal to 0.02 inches, greater than or equal to 0.05 inches, greater than or equal to 0.075 inches, greater than or equal to 0.1 inch, greater than or equal to 0.2 inches, greater than or equal to 0.5 inches, greater than or equal to 0.75 inches, greater than or equal to 1 inch, greater than or equal to 2 inches, greater than or equal to 5 inches, or greater than or equal to 7.5 inches. In some embodiments, a non-woven fiber web comprises synthetic fibers having an average length of less than or equal to 10 inches, less than or equal to 7.5 inches, less than or equal to 5 inches, less than or equal to 2 inches, less than or equal to 1 inch, less than or equal to 0.75 inches, less than or equal to 0.5 inches, less than or equal to 0.2 inches, less than or equal to 0.1 inch, less than or equal to 0.075 inches, less than or equal to 0.05 inches, or less than or equal to 0.02 inches. Combinations of the above-referenced ranges are also possible (e.g., greater than or equal to 0.01 inches and less than or equal to 10 inches). Other ranges are also possible.

When a non-woven fiber web comprises two or more types of synthetic fibers, each type of synthetic fiber may have an average length in one or more of the ranges described above. Additionally, in some embodiments, all of the synthetic fibers in a non-woven fiber web together have an average length in one or more of the ranges described above. Similarly, when a filter media comprises two or more non-woven fiber webs, each non-woven fiber web may independently comprise synthetic fibers (of one or more types independently, of all types together) having an average length in one or more of the ranges described above.

In some embodiments, a non-woven fiber web comprises binder fibers. The binder fibers may make up a variety of suitable amounts of the non-woven fiber web. In some embodiments, binder fibers make up greater than or equal to 0 wt %, greater than 0 w %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, greater than or equal to 40 wt %, greater than or equal to 50 wt %, greater than or equal to 60 wt %, or greater than or equal to 80 wt % of the fibers in a non-woven fiber web. In some embodiments, binder fibers make up less than or equal to 90 wt %, less than or equal to 80 wt %, less than or equal to 60 wt %, less than or equal to 50 wt %, less than or equal to 40 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 2 wt %, or less than or equal to 1 wt % of the fibers in a non-woven fiber web. Combinations of the above-referenced ranges are also possible (e.g., greater than or equal to 0 wt % and less than or equal to 90 wt % or greater than 0 wt % and less than or equal to 90 wt %). Other ranges are also possible. In some embodiments, binder fibers make up exactly 0 wt % of the fibers in a non-woven fiber web.

A variety of suitable types of binder fibers may be employed in the non-woven fiber webs described herein. In some embodiments, the binder fibers comprise multicomponent fibers and/or monocomponent fibers. The multicomponent fibers may comprise bicomponent fibers (i.e., fibers including two components), and/or may comprise fibers comprising three or more components. Multicomponent fibers may have a variety of suitable structures. For instance, a non-woven fiber web may comprise one or more of the following types of multicomponent fibers: core/sheath fibers (e.g., concentric core/sheath fibers, non-concentric core-sheath fibers), segmented pie fibers, side-by-side fibers, tip-trilobal fibers, and “island in the sea” fibers. Core-sheath bicomponent fibers may comprise a sheath that has a lower melting temperature than that of the core. When heated (e.g., during a binding step), the sheath may melt prior to the core, binding the non-woven fiber web together while the core remains solid.

Non-limiting examples of suitable materials that may be included in multicomponent and monocomponent binder fibers include poly(olefin)s such as poly(ethylene), poly(propylene), and poly(butylene); poly(ester)s and co-poly(ester)s such as poly(ethylene terephthalate) (e.g., amorphous poly(ethylene terephthalate)), co-poly(ethylene terephthalate), poly(butylene terephthalate), and poly(ethylene isophthalate); poly(amide)s and co-poly(amides) such as nylons and aramids; and halogenated polymers such as poly(tetrafluoroethylene). Suitable co-poly(ethylene terephthalate)s may comprise repeat units formed by the polymerization of ethylene terephthalate monomers and further comprise repeat units formed by the polymerization of one or more comonomers. Such comonomers may include linear, cyclic, and branched aliphatic dicarboxylic acids having 4-12 carbon atoms (e.g., butanedioic acid, pentanedioic acid, hexanedioic acid, dodecanedioic acid, and 1,4-cyclo-hexanedicarboxylic acid); aromatic dicarboxylic acids having 8-12 carbon atoms (e.g., isophthalic acid and 2,6-naphthalenedicarboxylic acid); linear, cyclic, and branched aliphatic diols having 3-8 carbon atoms (e.g., 1,3-propane diol, 1,2-propanediol, 1,4-butanediol, 3-methyl-1,5-pentanediol, 2,2-dimethyl-1,3-propanediol, 2-methyl-1,3-propanediol, and 1,4-cyclohexanediol); and/or aliphatic and aromatic/aliphatic ether glycols having 4-10 carbon atoms (e.g., hydroquinone bis(2-hydroxyethyl) ether and poly(ethylene ether) glycols having a molecular weight below 460 g/mol, such as diethylene ether glycol).

Non-limiting examples of suitable pairs of materials that may be included in bicomponent fibers include poly(ethylene)/poly(ethylene terephthalate), poly(propylene)/poly(ethylene terephthalate), co-poly(ethylene terephthalate)/poly(ethylene terephthalate), poly(butylene terephthalate)/poly(ethylene terephthalate), co-poly(amide)/poly(amide), and poly(ethylene)/poly(propylene). In the preceding list, the material having the lower melting temperature is listed first and the material having the higher melting temperature is listed second. Core-sheath bicomponent fibers comprising one of the above such pairs may have a sheath comprising the first material and a core comprising the second material.

In embodiments in which a non-woven fiber web comprises two or more types of bicomponent fibers, each type of bicomponent fiber may independently comprise one of the pairs of materials described above. According to some embodiments, the non-woven fiber web may have a relatively low percentage of bicomponent fibers (e.g., less than or equal to 3 wt %, less than or equal to 2 wt %, less than or equal to 1 wt %, less than or equal to 0.5 wt %, less than or equal to 0.1 wt %, or 0% of the fibers in the non-woven fiber web). In some embodiments, the non-woven fiber web may be substantially free of bicomponent fibers. In some embodiments, the non-woven fiber web lacks bicomponent fibers.

The monocomponent and multicomponent binder fibers described herein may have a variety of suitable melting points and/or comprise components having a variety of suitable melting points. In some embodiments, a non-woven fiber web comprises a monocomponent binder fiber having a melting point and/or a multicomponent fiber comprising a component having a melting point of greater than or equal to 80° C., greater than or equal to 90° C., greater than or equal to 100° C., greater than or equal to 110° C., greater than or equal to 120° C., greater than or equal to 130° C., greater than or equal to 140° C., greater than or equal to 150° C., greater than or equal to 160° C., greater than or equal to 170° C., greater than or equal to 180° C., greater than or equal to 190° C., greater than or equal to 200° C., greater than or equal to 210° C., or greater than or equal to 220° C. In some embodiments, a non-woven fiber web comprises a monocomponent binder fiber having a melting point and/or a multicomponent fiber comprising a component having a melting point less than or equal to 230° C., less than or equal to 220° C., less than or equal to 210° C., less than or equal to 200° C., less than or equal to 190° C., less than or equal to 180° C., less than or equal to 170° C., less than or equal to 160° C., less than or equal to 150° C., less than or equal to 140° C., less than or equal to 130° C., less than or equal to 120° C., less than or equal to 110° C., less than or equal to 100° C., or less than or equal to 90° C. Combinations of the above-referenced ranges are also possible (e.g., greater than or equal to 80° C. and less than or equal to 230° C., or greater than or equal to 110° C. and less than or equal to 230° C.). Other ranges are also possible.

The melting point of a monocomponent fiber and the melting points of the components of a multicomponent fiber may be determined by performing differential scanning calorimetry. The differential scanning calorimetry measurement may be carried out by heating the multicomponent fiber to 300° C. at 20° C./minute, cooling the multicomponent fiber to room temperature, and then determining the melting point during a reheating to 300° C. at 20° C./minute.

When present, the binder fibers may have a variety of suitable average diameters. In some embodiments, a non-woven fiber web comprises binder fibers having an average diameter of greater than or equal to 0.5 microns, greater than or equal to 0.75 microns, greater than or equal to 1 micron, greater than or equal to 2 microns, greater than or equal to 5 microns, greater than or equal to 7.5 microns, greater than or equal to 10 microns, greater than or equal to 15 microns, greater than or equal to 20 microns, greater than or equal to 25 microns, greater than or equal to 30 microns, greater than or equal to 35 microns, greater than or equal to 40 microns, or greater than or equal to 45 microns. In some embodiments, a non-woven fiber web comprises binder fibers having an average diameter of less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 10 microns, less than or equal to 7.5 microns, less than or equal to 5 microns, less than or equal to 2 microns, less than or equal to 1 micron, or less than or equal to 0.75 microns. Combinations of the above-referenced ranges are also possible (e.g., greater than or equal to 0.5 microns and less than or equal to 50 microns, greater than or equal to 1 micron and less than or equal to 50 microns, or greater than or equal to 2 microns and less than or equal to 50 microns). Other ranges are also possible.

When a non-woven fiber web comprises two or more types of binder fibers, each type of binder fiber may have an average diameter in one or more of the ranges described above. Additionally, in some embodiments, all of the binder fibers in a non-woven fiber web together have an average diameter in one or more of the ranges described above. Similarly, when a filter media comprises two or more non-woven fiber webs, each non-woven fiber web may independently comprise binder fibers (of one or more types independently, of all types together) having an average diameter in one or more of the ranges described above.

When present, the binder fibers may have a variety of suitable average lengths. In some embodiments, a non-woven fiber web comprises binder fibers having an average length of greater than or equal to 0.01 inch, greater than or equal to 0.02 inches, greater than or equal to 0.05 inches, greater than or equal to 0.075 inches, greater than or equal to 0.1 inch, greater than or equal to 0.2 inches, greater than or equal to 0.5 inches, greater than or equal to 0.75 inches, greater than or equal to 1 inch, greater than or equal to 1.25 inches, greater than or equal to 1.5 inches, greater than or equal to 2 inches, greater than or equal to 2.5 inches, greater than or equal to 3 inches, greater than or equal to 3.5 inches, greater than or equal to 4 inches, greater than or equal to 5 inches, greater than or equal to 6 inches, or greater than or equal to 8 inches. In some embodiments, a non-woven fiber web comprises binder fibers having an average length of less than or equal to 10 inches, less than or equal to 8 inches, less than or equal to 6 inches, less than or equal to 5 inches, less than or equal to 4 inches, less than or equal to 3.5 inches, less than or equal to 3 inches, less than or equal to 2.5 inches, less than or equal to 2 inches, less than or equal to 2.5 inches, less than or equal to 2 inches, less than or equal to 1.5 inches, less than or equal to 1.25 inches, less than or equal to 1 inch, less than or equal to 0.75 inches, less than or equal to 0.5 inches, less than or equal to 0.2 inches, less than or equal to 0.1 inch, less than or equal to 0.075 inches, less than or equal to 0.05 inches, or less than or equal to 0.02 inches. Combinations of the above-referenced ranges are also possible (e.g., greater than or equal to 0.01 inch and less than or equal to 10 inches, greater than or equal to 0.01 inch and less than or equal to 5 inches, or greater than or equal to 0.05 inches and less than or equal to 3 inches). Other ranges are also possible.

When a non-woven fiber web comprises two or more types of binder fibers, each type of binder fiber may have an average length in one or more of the ranges described above. Additionally, in some embodiments, all of the binder fibers in a non-woven fiber web together have an average length in one or more of the ranges described above. Similarly, when a filter media comprises two or more non-woven fiber webs, each non-woven fiber web may independently comprise binder fibers (of one or more types independently, of all types together) having an average length in one or more of the ranges described above.

In some embodiments, a non-woven fiber web comprises fibrillated fibers. The fibrillated fibers may comprise natural fibers and/or synthetic fibers as described elsewhere herein. As a non-limiting example, the fibrillated fibers may comprise lyocell fibers. A fibrillated fiber may include a parent fiber that branches into smaller diameter fibrils, which can, in some instances, branch further out into even smaller diameter fibrils with further branching also being possible. The branched nature of the fibrils may enhance the surface area of a fiber web in which the fibrillated fibers are employed, and can increase the number of contact points between the fibrillated fibers and other fibers in the non-woven fiber web. Such an increase in points of contact between the fibrillated fibers and other fibers in the non-woven fiber web may enhance the mechanical properties (e.g., flexibility, strength) of the non-woven fiber web.

When present, fibrillated fibers may comprise stems having average diameters in one or more of the ranges described elsewhere herein with respect to the average diameter of fibers of the relevant type (e.g., fibrillated synthetic fibers may comprise stems having average diameters in one or more of the ranges described elsewhere herein as possibly characterizing the average diameter of synthetic fibers, fibrillated natural fibers may comprise stems having average diameters in one or more of the ranges described elsewhere herein as possibly characterizing the average diameter of natural fibers).

When present, the fibrillated fibers (e.g., lyocell fibers) may comprise fibrils having a variety of suitable diameters. In some embodiments, a non-woven fiber web comprises fibrillated fibers comprising fibrils having an average diameter of greater than or equal to 0.1 micron, greater than or equal to 0.2 microns, greater than or equal to 0.5 microns, greater than or equal to 0.75 microns, greater than or equal to 1 micron, greater than or equal to 1.25 microns, greater than or equal to 1.5 microns, or greater than or equal to 1.75 microns. In some embodiments, a non-woven fiber web comprises fibrillated fibers comprising fibrils having an average diameter of less than or equal to 2 microns, less than or equal to 1.75 microns, less than or equal to 1.5 microns, less than or equal to 1.25 microns, less than or equal to 1 micron, less than or equal to 0.75 microns, less than or equal to 0.5 microns, or less than or equal to 0.2 microns. Combinations of the above-referenced ranges are also possible (e.g., greater than or equal to 0.1 micron and less than or equal to 2 microns). Other ranges are also possible.

When a non-woven fiber web comprises two or more types of fibrillated fibers, each type of fibrillated fiber may comprise fibrils having an average diameter in one or more of the ranges described above. Additionally, in some embodiments, the fibrils of all of the fibrillated fibers in a non-woven fiber web together have an average diameter in one or more of the ranges described above. Similarly, when a filter media comprises two or more non-woven fiber webs, each non-woven fiber web may independently comprise fibrillated fibers (of one or more types independently, of all types together) comprising fibrils having an average diameter in one or more of the ranges described above.

When present, the fibrillated fibers (e.g., lyocell fibers) may have a variety of suitable average lengths. In some embodiments, the fibrillated fibers have an average length of greater than or equal to 0.01 inches, greater than or equal to 0.03 inches, greater than or equal to 0.05 inches, greater than or equal to 0.1 inches, greater than or equal to 0.2 inches, greater than or equal to 0.3 inches, greater than or equal to 0.4 inches, greater than or equal to 0.5 inches, greater than or equal to 0.6 inches, greater than or equal to 0.7 inches, greater than or equal to 0.8 inches, or greater than or equal to 0.9 inches. In some embodiments, the fibrillated fibers have an average length of less than or equal to 1 inch, less than or equal to 0.9 inches, less than or equal to 0.8 inches, less than or equal to 0.7 inches, less than or equal to 0.6 inches, less than or equal to 0.5 inches, less than or equal to 0.4 inches, less than or equal to 0.3 inches, less than or equal to 0.2 inches, less than or equal to 0.1 inches, less than or equal to 0.05 inches, less than or equal to 0.03 inches, or less than or equal to 0.02 inches. Combinations of the above-referenced ranges are also possible (e.g., greater than or equal to 0.01 inches and less than or equal to 1 inch, greater than or equal to 0.1 inches and less than or equal to 0.5 inches, or greater than or equal to 0.1 inches and less than or equal to 0.3 inches). Other ranges are also possible.

When a non-woven fiber web comprises two or more types of fibrillated fibers, each type of fibrillated fiber may independently have an average fiber length in one or more of the ranges described above and/or all of the fibrillated fibers in a non-woven fiber web may together have an average fiber length in one or more of the ranges described above. Similarly, when a filter media comprises two or more non-woven fiber webs, each non-woven fiber web may independently comprise one or more types of fibrillated fibers having an average fiber length in one or more of the ranges described above and/or may comprise fibrillated fibers that overall have an average fiber length in one or more of the ranges described above.

When present, the fibrillated fibers (e.g., lyocell fibers) may be present in a non-woven fiber web in a variety of suitable amounts. In some embodiments, the fibrillated fibers may be present in a non-woven fiber web in an amount of greater than 0 wt %, greater than or equal to 0.01 wt %, greater than or equal to 0.02 wt %, greater than or equal to 0.03 wt %, greater than or equal to 0.05 wt %, greater than or equal to 0.08 wt %, greater than or equal to 0.1 wt %, greater than or equal to 0.2 wt %, greater than or equal to 0.3 wt %, greater than or equal to 0.5 wt %, greater than or equal to 0.8 wt %, greater than or equal to 1 wt %, greater than or equal to 1.5 wt %, greater than or equal to 2 wt %, greater than or equal to 3 wt %, greater than or equal to 4 wt %, greater than or equal to 5 wt %, greater than or equal to 8 wt %, greater than or equal to 10 wt %, greater than or equal to 12 wt %, greater than or equal to 15 wt %, or greater than or equal to 18 wt % of the non-woven fiber web. According to some embodiments, the fibrillated fibers may be present in a non-woven fiber web in an amount of less than or equal to 20 wt %, less than or equal to 18 wt %, less than or equal to 15 wt %, less than or equal to 12 wt %, less than or equal to 10 wt %, less than or equal to 8 wt %, less than or equal to 5 wt %, less than or equal to 4 wt %, less than or equal to 3 wt %, less than or equal to 2 wt %, less than or equal to 1.5 wt %, less than or equal to 1 wt %, less than or equal to 0.8 wt %, less than or equal to 0.5 wt %, less than or equal to 0.3 wt %, less than or equal to 0.2 wt %, less than or equal to 0.1 wt %, less than or equal to 0.08 wt %, less than or equal to 0.05 wt %, less than or equal to 0.03 wt %, less than or equal to 0.02 wt %, or less than or equal to 0.01 wt % of the non-woven fiber web. Combinations of the foregoing ranges are possible (e.g., greater than or equal to 0 wt % and less than or equal to 20 wt % of the non-woven fiber web, greater than 0 wt % and less than or equal to 20 wt % of the non-woven fiber web, greater than 0 wt % and less than or equal to 15 wt % of the non-woven fiber web, greater than 0 wt % and less than or equal to 12 wt % of the non-woven fiber web, greater than 0 wt % and less than or equal to 10 wt % of the non-woven fiber web, greater than 0 wt % and less than or equal to 5 wt % of the non-woven fiber web, greater than 0 wt % and less than or equal to 2 wt % of the non-woven fiber web, or greater than 0 wt % and less than or equal to 1 wt % of the non-woven fiber web). Other ranges are also possible.

When a non-woven fiber web comprises two or more types of fibrillated fibers, each type of fibrillated fiber may independently make up an amount of the non-woven fiber web in one or more of the ranges described above. Additionally, in some embodiments, a total amount of fibrillated fibers in a non-woven fiber web may be in one or more of the ranges described above. Similarly, when a filter media comprises two or more non-woven fiber webs, each type of fibrillated fiber may independently make up an amount of each non-woven fiber web in one or more of the ranges described above and/or the total amount of fibrillated fibers in each non-woven fiber web may independently be in one or more of the ranges described above.

In some embodiments, if the amount of fibrillated fibers (e.g., lyocell fibers) within the non-woven fiber web is too high, the non-woven fiber web may have a relatively high flammability and/or relatively low performance (e.g., relatively low gamma). In some embodiments, if the amount of fibrillated fibers (e.g., lyocell fibers) within the non-woven fiber web is too low, the non-woven fiber web may have relatively low strength (e.g., wet strength), relatively low flexibility, and/or relatively low processability. Accordingly, in some embodiments, a non-woven fiber web comprising an amount of fibrillated fibers (e.g., lyocell fibers) in the above-referenced ranges has reduced flammability, increased strength (e.g., wet strength), increased flexibility, increased processability, and/or increased performance (e.g., increased gamma) compared to a non-woven fiber web with amounts of fibrillated fibers (e.g., lyocell fibers) outside of the above-referenced ranges, all other factors being equal. In some embodiments, use of fibrillated fibers (e.g., lyocell fibers) in the above-referenced ranges provides sufficient flame-resistant properties, strength (e.g., wet strength), flexibility, processability, and/or performance (e.g., gamma) such that low amounts (e.g., amounts disclosed herein) or no additional synthetic fibers (e.g., bicomponent fibers and/or synthetic fibers comprising poly(vinyl alcohol) are needed to achieve the desired flame-resistant properties, strength (e.g., wet strength), flexibility, processability, and/or performance (e.g., gamma).

When a non-woven fiber web comprises two or more types of fibrillated fibers, each type of fibrillated fiber may comprise fibrils having an average diameter in one or more of the ranges described above. Additionally, in some embodiments, the fibrils of all of the fibrillated fibers in a non-woven fiber web together have an average diameter in one or more of the ranges described above. Similarly, when a filter media comprises two or more non-woven fiber webs, each non-woven fiber web may independently comprise fibrillated fibers (of one or more types independently, of all types together) comprising fibrils having an average diameter in one or more of the ranges described above.

When present, the fibrillated fibers may have a variety of suitable levels of fibrillation. In some embodiments, a non-woven fiber web comprises fibrillated fibers having a level of fibrillation of greater than or equal to 1 CSF, greater than or equal to 2 CSF, greater than or equal to 3 CSF, greater than or equal to 4 CSF, greater than or equal to 5 CSF, greater than or equal to 7.5 CSF, greater than or equal to 10 CSF, greater than or equal to 20 CSF, greater than or equal to 50 CSF, greater than or equal to 75 CSF, greater than or equal to 100 CSF, greater than or equal to 200 CSF, greater than or equal to 225 CSF, greater than or equal to 240 CSF, greater than or equal to 300 CSF, greater than or equal to 350 CSF, greater than or equal to 400 CSF, greater than or equal to 500 CSF, greater than or equal to 750 CSF, or greater than or equal to 900 CSF. In some embodiments, a non-woven fiber web comprises fibrillated fibers having a level of fibrillation of less than or equal to 1000 CSF, less than or equal to 900 CSF, less than or equal to 750 CSF, less than or equal to 600 CSF, less than or equal to 550 CSF, less than or equal to 500 CSF, less than or equal to 450 CSF, less than or equal to 400 CSF, less than or equal to 350 CSF, less than or equal to 240 CSF, less than or equal to 200 CSF, less than or equal to 100 CSF, less than or equal to 75 CSF, less than or equal to 50 CSF, less than or equal to 20 CSF, less than or equal to 10 CSF, less than or equal to 7.5 CSF, less than or equal to 5 CSF, less than or equal to 4 CSF, less than or equal to 3 CSF, or less than or equal to 2 CSF. Combinations of the above-referenced ranges are also possible (e.g., greater than or equal to 1 CSF and less than or equal to 1000 CSF, greater than or equal to 3 CSF and less than or equal to 1000 CSF, or greater than or equal to 5 CSF and less than or equal to 900 CSF, greater than or equal to 10 CSF and less than or equal to 600 CSF, greater than or equal to 200 CSF and less than or equal to 500 CSF, or greater than or equal to 240 CSF and less than or equal to 400 CSF). Other ranges are also possible.

The fibrillation of fibrillated fibers can be measured according to a Canadian Standard Freeness test, specified by TAPPI test method T-227-om-09 Freeness of pulp (2009). The test can provide an average CSF value.

When a non-woven fiber web comprises two or more types of fibrillated fibers, each type of fibrillated fiber may have a level of fibrillation in one or more of the ranges described above. Additionally, in some embodiments, all of the fibrillated fibers in a non-woven fiber web together have a level of fibrillation in one or more of the ranges described above. Similarly, when a filter media comprises two or more non-woven fiber webs, each non-woven fiber web may independently comprise fibrillated fibers (of one or more types independently, of all types together) having a level of fibrillation in one or more of the ranges described above.

In some embodiments, a non-woven fiber web comprising fibrillated fibers (e.g., lyocell fibers) having a level of fibrillation in the above-referenced ranges has increased performance (e.g., gamma) compared to a non-woven fiber web comprising fibrillated fibers (e.g., lyocell fibers) having a level of fibrillation outside of the above-referenced ranges, all other factors being equal.

In some embodiments, a filter media (e.g., comprising one or more of the above-described types of water-repellent additives, resins, and/or fibers) lacks certain fluorinated materials regulated by government bodies. For instance, in some embodiments, a filter media lacks perfluoroalkyl substances, polyfluoroalkyl substances, and/or fluorotelomers. As further examples, in some embodiments, a filter media lacks perfluoroalkane sulfonic acids (e.g., perfluoroalkane sulfonic acids comprising a carbon chain comprising six or more carbon atoms, such as perfluorohexane sulfonic acid and/or perfluorooctane sulfonic acid), perfluorocarboxylic acids (e.g., perfluorocarboxylic acids comprising a carbon chain comprising eight or more carbon atoms, such as perfluorooctanoic acid), perfluoroalkyl substances comprising a carbon chain comprising five or fewer carbon atoms (e.g., perfluorobutane sulfonic acid), perfluoroalkyl substances comprising a carbon chain comprising seven or fewer carbon atoms (e.g., perfluorohexanoic acid), and/or precursors that are capable of degrading to form any of the preceding species (e.g., long-chain perfluoroalkyl sulfonyl fluoride-based raw materials, fluorotelomers).

In some embodiments, a filter media (e.g., comprising one or more of the above-described types of water-repellent additives, resins, and/or fibers) comprises one or more fluorinated materials regulated by government bodies (e.g., one or more of the fluorinated materials described in the preceding paragraph) in a relatively small amount. The relevant fluorinated material may make up less than or equal to 15 wt %, less than or equal to 10 wt %, less than or equal to 7.5 wt %, less than or equal to 5 wt %, less than or equal to 2 wt %, less than or equal to 1 wt %, less than or equal to 0.1 wt %, or less than or equal to 0.01 wt % of the non-fibrous components of the filter media (e.g., any water-repellent additives and/or resins). The relevant fluorinated material may make up greater than or equal to 0 wt %, greater than 0 wt %, greater than or equal to 0.01 wt %, greater than or equal to 0.1 wt %, greater than or equal to 1 wt %, greater than or equal to 2 wt %, greater than or equal to 5 wt %, greater than or equal to 7.5 wt %, or greater than or equal to 10 wt % of the non-fibrous components of the filter media. Combinations of the above-referenced ranges are also possible (e.g., less than or equal to 15 wt % and greater than or equal to 0 wt % or less than or equal to 15 wt % and greater than 0 wt %). In some embodiments, one or more fluorinated materials regulated by government bodies make up identically 0 wt % of the non-fibrous components of the filter media.

The non-woven fiber webs described herein may have a variety of suitable basis weights. In some embodiments, a non-woven fiber web has a basis weight of greater than or equal to 20 gsm, greater than or equal to 30 gsm, greater than or equal to 40 gsm, greater than or equal to 50 gsm, greater than or equal to 60 gsm, greater than or equal to 70 gsm, greater than or equal to 80 gsm, greater than or equal to 90 gsm, greater than or equal to 100 gsm, greater than or equal to 110 gsm, greater than or equal to 120 gsm, greater than or equal to 130 gsm, greater than or equal to 140 gsm, greater than or equal to 150 gsm, greater than or equal to 160 gsm, greater than or equal to 170 gsm, greater than or equal to 180 gsm, greater than or equal to 190 gsm, greater than or equal to 200 gsm, greater than or equal to 225 gsm, greater than or equal to 250 gsm, greater than or equal to 275 gsm, greater than or equal to 300 gsm, greater than or equal to 350 gsm, greater than or equal to 400 gsm, or greater than or equal to 450 gsm. In some embodiments, a non-woven fiber web has a basis weight of less than or equal to 500 gsm, less than or equal to 450 gsm, less than or equal to 400 gsm, less than or equal to 350 gsm, less than or equal to 300 gsm, less than or equal to 275 gsm, less than or equal to 250 gsm, less than or equal to 225 gsm, less than or equal to 200 gsm, less than or equal to 190 gsm, less than or equal to 180 gsm, less than or equal to 170 gsm, less than or equal to 160 gsm, less than or equal to 150 gsm, less than or equal to 140 gsm, less than or equal to 130 gsm, less than or equal to 120 gsm, less than or equal to 110 gsm, less than or equal to 100 gsm, less than or equal to 90 gsm, less than or equal to 80 gsm, less than or equal to 70 gsm, less than or equal to 60 gsm, less than or equal to 50 gsm, less than or equal to 40 gsm, or less than or equal to 30 gsm. Combinations of the above-referenced ranges are also possible (e.g., greater than or equal to 20 gsm and less than or equal to 500 gsm, greater than or equal to 20 gsm and less than or equal to 400 gsm, greater than or equal to 20 gsm and less than or equal to 200 gsm, greater than or equal to 20 gsm and less than or equal to 150 gsm, greater than or equal to 20 gsm and less than or equal to 130 gsm, greater than or equal to 30 gsm and less than or equal to 400 gsm, or greater than or equal to 40 gsm and less than or equal to 250 gsm). Other ranges are also possible.

The basis weight of a non-woven fiber web may be determined in accordance with ISO 536:2012.

When a filter media comprises two or more non-woven fiber webs, each non-woven fiber web may independently have a basis weight in one or more of the above-described ranges.

The non-woven fiber webs described herein may have a variety of suitable thicknesses. In some embodiments, a non-woven fiber web has a thickness of greater than or equal to 100 microns, greater than or equal to 200 microns, greater than or equal to 250 microns, greater than or equal to 300 microns, greater than or equal to 400 microns, greater than or equal to 500 microns, greater than or equal to 750 microns, greater than or equal to 1000 microns, greater than or equal to 2000 microns, greater than or equal to 3000 microns, or greater than or equal to 4000 microns. In some embodiments, a non-woven fiber web has a thickness of less than or equal to 5000 microns, less than or equal to 4000 microns, less than or equal to 3000 microns, less than or equal to 2000 microns, less than or equal to 1000 microns, less than or equal to 750 microns, less than or equal to 500 microns, less than or equal to 400 microns, less than or equal to 300 microns, less than or equal to 200 microns, or less than or equal to 200 microns. Combinations of the above-referenced ranges are also possible (e.g., greater than or equal to 100 microns and less than or equal to 5000 microns, greater than or equal to 200 microns and less than or equal to 5000 microns, greater than or equal to 200 microns and less than or equal to 3000 microns, or greater than or equal to 250 microns and less than or equal to 2000 microns). Other ranges are also possible.

The thickness of a non-woven fiber web may be determined in accordance with ASTM D1777-96 (2019) under an applied pressure of 2 kPa.

When a filter media comprises two or more non-woven fiber webs, each non-woven fiber web may independently have a thickness in one or more of the above-described ranges.

The non-woven fiber webs described herein may have a variety of suitable mean flow pore sizes. In some embodiments, a non-woven fiber web has a mean flow pore size of greater than or equal to 0.5 microns, greater than or equal to 0.75 microns, greater than or equal to 1 micron, greater than or equal to 1.25 microns, greater than or equal to 1.5 microns, greater than or equal to 1.75 microns, greater than or equal to 2 microns, greater than or equal to 2.25 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 17.5 microns, greater than or equal to 20 microns, greater than or equal to 25 microns, greater than or equal to 30 microns, greater than or equal to 35 microns, greater than or equal to 40 microns, or greater than or equal to 45 microns. In some embodiments, a non-woven fiber web has a mean flow pore size of less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2.5 microns, less than or equal to 2.25 microns, less than or equal to 2 microns, less than or equal to 1.75 microns, less than or equal to 1.5 microns, less than or equal to 1.25 microns, less than or equal to 1 micron, or less than or equal to 0.75 microns. Combinations of the above-referenced ranges are also possible (e.g., greater than or equal to 0.5 microns and less than or equal to 50 microns, greater than or equal to 0.5 microns and less than or equal to 30 microns, or greater than or equal to 1 micron and less than or equal to 15 microns). Other ranges are also possible.

The mean flow pore size of a non-woven fiber web may be determined in accordance with ASTM F316-90 Method B (2019).

When a filter media comprises two or more non-woven fiber webs, each non-woven fiber web may independently have a mean flow pore size in one or more of the above-described ranges.

The non-woven fiber webs described herein may have a variety of suitable maximum pore sizes. In some embodiments, a non-woven fiber web has a maximum pore size of greater than or equal to 1.5 microns, greater than or equal to 1.75 microns, greater than or equal to 2 microns, greater than or equal to 2.5 microns, greater than or equal to 3 microns, greater than or equal to 4 microns, greater than or equal to 5 microns, greater than or equal to 6 microns, greater than or equal to 8 microns, greater than or equal to 10 microns, greater than or equal to 12.5 microns, greater than or equal to 15 microns, greater than or equal to 17.5 microns, greater than or equal to 20 microns, greater than or equal to 25 microns, greater than or equal to 30 microns, greater than or equal to 35 microns, greater than or equal to 40 microns, greater than or equal to 45 microns, greater than or equal to 50 microns, greater than or equal to 60 microns, greater than or equal to 70 microns, greater than or equal to 80 microns, or greater than or equal to 90 microns. In some embodiments, a non-woven fiber web has a maximum pore size of less than or equal to 100 microns, less than or equal to 90 microns, less than or equal to 80 microns, less than or equal to 70 microns, less than or equal to 60 microns, less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 17.5 microns, less than or equal to 15 microns, less than or equal to 12.5 microns, less than or equal to 10 microns, less than or equal to 8 microns, less than or equal to 6 microns, less than or equal to 5 microns, less than or equal to 4 microns, less than or equal to 3 microns, less than or equal to 2.5 microns, less than or equal to 2 microns, or less than or equal to 1.75 microns. Combinations of the above-referenced ranges are also possible (e.g., greater than or equal to 1.5 microns and less than or equal to 100 microns, greater than or equal to 1.5 microns and less than or equal to 50 microns, or greater than or equal to 2.5 microns and less than or equal to 40 microns). Other ranges are also possible.

The maximum pore size of a non-woven fiber web may be determined in accordance with ASTM F316-90 Method B (2019).

When a filter media comprises two or more non-woven fiber webs, each non-woven fiber web may independently have a maximum pore size in one or more of the above-described ranges.

The non-woven fiber webs and/or filter media described herein may have a variety of suitable water roll off angles. In some embodiments, a non-woven fiber web and/or filter media has a water roll off angle of greater than or equal to 0.5 degrees, greater than or equal to 1 degree, greater than or equal to 2 degrees, greater than or equal to 3 degrees, greater than or equal to 4 degrees, greater than or equal to 5 degrees, greater than or equal to 7 degrees, greater than or equal to 10 degrees, greater than or equal to 12 degrees, greater than or equal to 15 degrees, greater than or equal to 20 degrees, greater than or equal to 25 degrees, greater than or equal to 30 degrees, greater than or equal to 35 degrees, or greater than or equal to 40 degrees. In certain embodiments, a non-woven fiber web and/or filter media has a water roll off angle of less than or equal to 45 degrees, less than or equal to 43 degrees, less than or equal to 40 degrees, less than or equal to 38 degrees, less than or equal to 35 degrees, less than or equal to 33 degrees, less than or equal to 30 degrees, less than or equal to 28 degrees, less than or equal to 25 degrees, less than or equal to 23 degrees, less than or equal to 20 degrees, less than or equal to 18 degrees, less than or equal to 15 degrees, less than or equal to 13 degrees, less than or equal to 10 degrees, less than or equal to 8 degrees, or less than or equal to 5 degrees. Combinations of the above-referenced ranges are also possible (e.g., greater than or equal to 0.5 degrees and less than or equal to 45 degrees, greater than or equal to 0.5 degrees and less than or equal to 25 degrees, or greater than or equal to 0.5 degrees and less than or equal to 15 degrees). Other ranges are also possible.

The water roll off angle of a non-woven fiber web and/or filter media is the angle from horizontal at or above which a water droplet (approximately 5 μl volume) placed on the surface of the non-woven fiber web and/or filter media at 22° C. will not remain stationary and will roll to the edge or off the surface.

When a filter media comprises two or more non-woven fiber webs, each non-woven fiber web may independently have a water roll off angle in one or more of the above-described ranges.

In some embodiments, the non-woven fiber web and/or filter media is relatively flexible. For example, in some embodiments, the non-woven fiber web and/or filter media has an AC Flex Light Weight of greater than or equal to 1 cycle, greater than or equal to 2 cycles, greater than or equal to 3 cycles, greater than or equal to 4 cycles, greater than or equal to 5 cycles, greater than or equal to 10 cycles, greater than or equal to 15 cycles, greater than or equal to 20 cycles, greater than or equal to 25 cycles, greater than or equal to 30 cycles, greater than or equal to 35 cycles, greater than or equal to 40 cycles, greater than or equal to 45 cycles, greater than or equal to 50 cycles, greater than or equal to 55 cycles, greater than or equal to 60 cycles, greater than or equal to 75 cycles, greater than or equal to 100 cycles, greater than or equal to 125 cycles, greater than or equal to 150 cycles, greater than or equal to 175 cycles, greater than or equal to 200 cycles, greater than or equal to 250 cycles, greater than or equal to 300 cycles, or greater than or equal to 350 cycles. In some embodiments, the non-woven fiber web and/or filter media has an AC Flex Light Weight of less than or equal to 400 cycles, less than or equal to 375 cycles, less than or equal to 350 cycles, less than or equal to 325 cycles, less than or equal to 300 cycles, less than or equal to 275 cycles, less than or equal to 250 cycles, less than or equal to 225 cycles, less than or equal to 200 cycles, less than or equal to 175 cycles, less than or equal to 150 cycles, less than or equal to 125 cycles, less than or equal to 100 cycles, less than or equal to 90 cycles, less than or equal to 80 cycles, less than or equal to 75 cycles, less than or equal to 70 cycles, less than or equal to 68 cycles, less than or equal to 65 cycles, less than or equal to 63 cycles, less than or equal to 60 cycles, less than or equal to 58 cycles, less than or equal to 55 cycles, less than or equal to 53 cycles, less than or equal to 50 cycles, less than or equal to 48 cycles, less than or equal to 45 cycles, less than or equal to 43 cycles, less than or equal to 40 cycles, less than or equal to 35 cycles, less than or equal to 30 cycles, less than or equal to 25 cycles, less than or equal to 20 cycles, less than or equal to 15 cycles, less than or equal to 10 cycles, less than or equal to 5 cycles. Combinations of these ranges are also possible (e.g., greater than or equal to 1 cycle and less than or equal to 400 cycles, greater than or equal to 1 cycle and less than or equal to 100 cycles, greater than or equal to 1 cycle and less than or equal to 70 cycles, greater than or equal to 10 cycles and less than or equal to 70 cycles, or greater than or equal to 30 cycles and less than or equal to 70 cycles). Other ranges are also possible. The AC Flex Light Weight (AC Flex Lt Wt) may be measured using an AC Flex Tester on a 2 inch by 4 inch sample cut with the 4 inch side aligned in the machine direction. The sample is clamped in a specimen holder. The tester is activated to cyclically flex the sample at a rate of 48 cycles per minute (+/−1 cycle) using a flex weight of 413.2 grams. The number of flex cycles until the specimen broke is recorded. When a filter media comprises two or more non-woven fiber webs, each non-woven fiber web may independently have an AC Flex Light Weight in one of the above-referenced ranges.

In some embodiments, the filter media and/or a non-woven fiber web is relatively flame resistant. For example, in some embodiments, the filter media and/or a non-woven fiber web has an F1 and/or K1 rating as measured according to DIN 53438 (June 1984). When a filter media comprises two or more non-woven fiber webs, each non-woven fiber web may independently have an F1 and/or K1 rating as measured according to DIN 53438 (June 1984).

According to some embodiments, a non-woven fiber web has a sufficient wet strength to facilitate processing of the non-woven fiber web. For example, in some embodiments, a non-woven fiber web has a sufficient wet strength such that the non-woven fiber web can be processed without breaking, tearing, or otherwise degrading during processing. In some embodiments, it may be desirable to include certain components described herein within the filter media to improve the wet strength of the non-woven fiber web. For example, in some embodiments, including fibrillated fibers (e.g., lyocell fibers) within the non-woven fiber media may improve the wet strength of the non-woven fiber web. Other components described herein may also improve the wet strength of the non-woven fiber web, in accordance with some embodiments.

The wet strength of one or more non-woven fiber webs may be a variety of suitable values. Accordingly, in some embodiments, the non-woven fiber web has a wet strength of greater than or equal to 5 grams, greater than or equal to 10 grams, greater than or equal to 20 grams, greater than or equal to 30 grams, greater than or equal to 40 grams, greater than or equal to 50 grams, greater than or equal to 60 grams, greater than or equal to 70 grams, greater than or equal to 80 grams, or greater than or equal to 90 grams. In some embodiments, the non-woven fiber web has a wet strength of less than or equal to 100 grams, less than or equal to 90 grams, less than or equal to 80 grams, less than or equal to 70 grams, less than or equal to 60 grams, less than or equal to 50 grams, less than or equal to 40 grams, less than or equal to 30 grams, less than or equal to 20 grams, or less than or equal to 10 grams. Combinations of the foregoing ranges are possible (e.g., greater than or equal to 5 grams and less than or equal to 100 grams or greater than or equal to 40 grams and less than or equal to 80 grams). Other ranges are also possible.

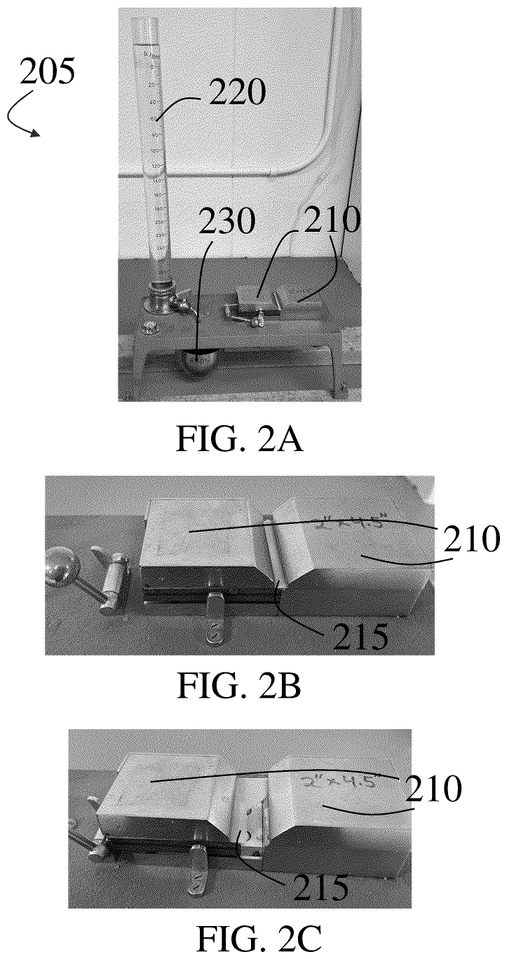

The wet strength may be determined as follows. A system, such as system 205 in FIGS. 2A-2C, may be used. A 2″×4.5″ sample (e.g., sample 215) is cut out of the middle of a wet non-woven fiber web. The wet sample (e.g., sample 215) is positioned in the system (e.g., system 205 as shown in FIGS. 2A-2C) and metal blocks (e.g., metal blocks 210) are placed on top of the wet sample (e.g., sample 215) to hold it in place, balanced by a counterweight underneath so that there are no tensile stresses on the sample (e.g., sample 215). A graduated cylinder (e.g., graduated cylinder 220) is filled with water, and the water valve is opened, such that water flows from the graduated cylinder into a pan (e.g., pan 230). The weight of the water in the pan (e.g., pan 230) is applied as a tensile stress to the wet sample (e.g., sample 215). The method continues until enough water is added into the pan (e.g., pan 230) to pull apart the wet sample (e.g., sample 215, as shown in FIG. 2C). The weight (in grams) of the water sufficient to pull apart the wet sample is the wet strength of the non-woven fiber web.

The non-woven fiber webs described herein may have a variety of suitable air resistances. In some embodiments, a non-woven fiber web has an air resistance of greater than or equal to 0.5 Pa, greater than or equal to 0.6 Pa, greater than or equal to 0.8 Pa, greater than or equal to 1 Pa, greater than or equal to 2 Pa, greater than or equal to 5 Pa, greater than or equal to 7.5 Pa, greater than or equal to 10 Pa, greater than or equal to 20 Pa, greater than or equal to 25 Pa, greater than or equal to 28 Pa, greater than or equal to 30 Pa, greater than or equal to 35 Pa, greater than or equal to 40 Pa, greater than or equal to 45 Pa, greater than or equal to 50 Pa, greater than or equal to 55 Pa, greater than or equal to 60 Pa, greater than or equal to 75 Pa, greater than or equal to 100 Pa, greater than or equal to 200 Pa, greater than or equal to 300 Pa, greater than or equal to 400 Pa, greater than or equal to 500 Pa, greater than or equal to 600 Pa, or greater than or equal to 700 Pa. In some embodiments, a non-woven fiber web has an air resistance of less than or equal to 800 Pa, less than or equal to 700 Pa, less than or equal to 600 Pa, less than or equal to 500 Pa, less than or equal to 400 Pa, less than or equal to 300 Pa, less than or equal to 200 Pa, less than or equal to 100 Pa, less than or equal to 75 Pa, less than or equal to 60 Pa, less than or equal to 55 Pa, less than or equal to 50 Pa, less than or equal to 45 Pa, less than or equal to 40 Pa, less than or equal to 35 Pa, less than or equal to 30 Pa, less than or equal to 28 Pa, less than or equal to 25 Pa, less than or equal to 20 Pa, less than or equal to 10 Pa, less than or equal to 7.5 Pa, less than or equal to 5 Pa, less than or equal to 2 Pa, less than or equal to 1 Pa, less than or equal to 0.8 Pa, or less than or equal to 0.6 Pa. Combinations of the above-referenced ranges are also possible (e.g., greater than or equal to 0.5 Pa and less than or equal to 800 Pa, greater than or equal to 0.5 Pa and less than or equal to 60 Pa, greater than or equal to 0.8 Pa and less than or equal to 30 Pa, or greater than or equal to 2 Pa and less than or equal to 800 Pa). Other ranges are also possible.

The air resistance of a non-woven fiber web may be determined by measuring the air permeability in CFM (cfm/sf) of the non-woven fiber web using a FX 3300 Air Permeability Tester III from TEXTEST Instruments and then dividing 113.5 by the measured air permeability. The air permeability measurement may be performed in accordance with ASTM D737-04 (2016) at a pressure of 125 Pa and a face velocity of 5.33 cm/s.

When a filter media comprises two or more non-woven fiber webs, each non-woven fiber web may independently have an air resistance in one or more of the above-described ranges.

In some embodiments, a non-woven fiber web has a relatively high dry tensile strength in the machine direction. The tensile strength in the machine direction may be greater than or equal to 0.25 kN/m, greater than or equal to 0.5 kN/m, greater than or equal to 0.75 kN/m, greater than or equal to 1 kN/m, greater than or equal to 1.5 kN/m, greater than or equal to 2 kN/m, greater than or equal to 2.5 kN/m, greater than or equal to 3 kN/m, greater than or equal to 4 kN/m, greater than or equal to 5 kN/m, greater than or equal to 6 kN/m, greater than or equal to 7.5 kN/m, greater than or equal to 10 kN/m, or greater than or equal to 12.5 kN/m. The dry tensile strength in the machine direction may be less than or equal to 15 kN/m, less than or equal to 12.5 kN/m, less than or equal to 10 kN/m, less than or equal to 7.5 kN/m, less than or equal to 6 kN/m, less than or equal to 5 kN/m, less than or equal to 4 kN/m, less than or equal to 3 kN/m, less than or equal to 2.5 kN/m, less than or equal to 2 kN/m, less than or equal to 1.5 kN/m, less than or equal to 1 kN/m, less than or equal to 0.75 kN/m, or less than or equal to 0.5 kN/m. Combinations of the above-referenced ranges are also possible (e.g., greater than or equal to 0.25 kN/m and less than or equal to 15 kN/m). Other ranges are also possible.

The dry tensile strength in the machine direction of a non-woven fiber web may be determined in accordance with the standard T494 om-96 (1996) test using a test span of 5 inches and a jaw separation speed of 1 in/min.

When a filter media comprises two or more non-woven fiber webs, each non-woven fiber web may independently have a dry tensile strength in the machine direction in one or more of the above-referenced ranges.

In some embodiments, a non-woven fiber web has a relatively high machine direction Gurley stiffness. The Gurley stiffness in the machine direction may be greater than or equal to 300 mg, greater than or equal to 400 mg, greater than or equal to 500 mg, greater than or equal to 600 mg, greater than or equal to 750 mg, greater than or equal to 1000 mg, greater than or equal to 1250 mg, greater than or equal to 1500 mg, greater than or equal to 2000 mg, greater than or equal to 2500 mg, greater than or equal to 3000 mg, greater than or equal to 3500 mg, greater than or equal to 4000 mg, or greater than or equal to 4500 mg. The Gurley stiffness in the machine direction may be less than or equal to 5000 mg, less than or equal to 4500 mg, less than or equal to 4000 mg, less than or equal to 3500 mg, less than or equal to 3000 mg, less than or equal to 2500 mg, less than or equal to 2000 mg, less than or equal to 1500 mg, less than or equal to 1250 mg, less than or equal to 1000 mg, less than or equal to 750 mg, less than or equal to 600 mg, less than or equal to 500 mg, or less than or equal to 400 mg. Combinations of the above-referenced ranges are also possible (e.g., greater than or equal to 300 mg and less than or equal to 5000 mg). Other ranges are also possible.

The Gurley stiffness of a non-woven fiber web may be determined in accordance with TAPPI T543 om-94 (1994).

The non-woven fiber webs described herein may have a variety of oil ranks. In some embodiments, a non-woven fiber web has an oil rank of greater than or equal to 0, greater than or equal to 1, greater than or equal to 2, greater than or equal to 3, greater than or equal to 4, or greater than or equal to 5. In some embodiments, a non-woven fiber web has an oil rank of less than or equal to 6, less than or equal to 5, less than or equal to 4, less than or equal to 3, less than or equal to 2, or less than or equal to 1. Combinations of the above-referenced ranges are also possible (e.g., greater than or equal to 0 and less than or equal to 6, greater than or equal to 1 and less than or equal to 6, greater than or equal to 2 and less than or equal to 5, greater than or equal to 3 and less than or equal to 4, or greater than or equal to 5 and less than or equal to 6). Other ranges are also possible.

Oil rank may be determined according to AATCC TM 118 (2020) measured at 23° C. and 50% relative humidity (RH). Briefly, 5 drops of each test oil (having an average droplet diameter of about 2 mm) are placed on five different locations on the surface of the non-woven fiber web. The test oil with the greatest oil surface tension that does not wet the surface of the non-woven fiber web (e.g., has a contact angle greater than or equal to 90° with the surface) after 30 seconds of contact with the fiber web at 23° C. and 50% RH, corresponds to the oil rank (listed in Table 1). For example, if a test oil with a surface tension of 26.6 mN/m does not wet the surface of the non-woven fiber web (i.e., has a contact angle of greater than or equal to 90 degrees with the surface) after 30 seconds, but a test oil with a surface tension of 25.4 mN/m wets the surface of the non-woven fiber web within thirty seconds, the non-woven fiber web has an oil rank of 4. By way of another example, if a test oil with a surface tension of 25.4 mN/m does not wet the surface of the non-woven fiber web after 30 seconds, but a test oil with a surface tension of 23.8 mN/m wets the surface of the non-woven fiber web within thirty seconds, the non-woven fiber web has an oil rank of 5. By way of yet another example, if a test oil with a surface tension of 23.8 mN/m does not wet the surface of the non-woven fiber web after 30 seconds, but a test oil with a surface tension of 21.6 mN/m wets the surface of the non-woven fiber web within thirty seconds, the non-woven fiber web has an oil rank of 6. In some embodiments, if three of more of the five drops partially wet the surface (e.g., forms a droplet, but not a well-rounded drop on the surface) in a given test, then the oil rank is expressed to the nearest 0.5 value determined by subtracting 0.5 from the number of the test liquid. By way of example, if a test oil with a surface tension of 25.4 mN/m does not wet the surface of the non-woven fiber web after 30 seconds, but a test oil with a surface tension of 23.8 mN/m only partially wets the surface of non-woven fiber web after 30 seconds (e.g., three or more of the test droplets form droplets on the surface of the non-woven fiber web that are not well-rounded droplets) within thirty seconds, the nanofiber layer has an oil rank of 5.5.

TABLE 1

| Oil Rank | Test Oil | Surface Tension (mN/m) |
|---|---|---|
| 1 | Kaydol (mineral oil) | 31 |
| 2 | 65/35 Kaydol/n-hexadecane | 28 |
| 3 | n-hexadecane | 27.5 |
| 4 | n-tetradecane | 26.6 |
| 5 | n-dodecane | 25.4 |
| 6 | n-decane | 23.8 |
| 7 | n-octane | 21.6 |
| 8 | n-heptane | 20.1 |

When a filter media comprises two or more non-woven fiber webs, each non-woven fiber web may independently have an oil rank in one or more of the above-described ranges.

The non-woven fiber webs described herein may have relatively low poly(urethane) wicking heights. During filter media fabrication, it is not uncommon for a poly(urethane) adhesive to be employed to adhere non-woven fiber webs together, to other components of the filter media (e.g., other layers therein), and/or to one or more components of a filter element in which the filter media is positioned (e.g., a frame). Accordingly, low poly(urethane) wicking heights may be advantageous because they may reduce the penetration into the non-woven fiber web of any poly(urethane) adhesive employed. This may advantageously allow the pores in and/or surface of the non-woven fiber web to remain relatively open and/or unblocked. It may also allow for the adhesive to remain in its intended location, which can assist with maintaining the intended adhesion and/or sealing the filter media to its frame. In some embodiments, a non-woven fiber web has a poly(urethane) wicking height of less than or equal to 50 mm, less than or equal to 45 mm, less than or equal to 40 mm, less than or equal to 35 mm, less than or equal to 30 mm, less than or equal to 25 mm, less than or equal to 22.5 mm, less than or equal to 20 mm, less than or equal to 17.5 mm, less than or equal to 15 mm, less than or equal to 12.5 mm, less than or equal to 10 mm, less than or equal to 7.5 mm, less than or equal to 5 mm, less than or equal to 2 mm, or less than or equal to 1 mm. In some embodiments, a non-woven fiber web has a poly(urethane) wicking height of greater than or equal to 0 mm, greater than or equal to 1 mm, greater than or equal to 2 mm, greater than or equal to 5 mm, greater than or equal to 7.5 mm, greater than or equal to 10 mm, greater than or equal to 12.5 mm, greater than or equal to 15 mm, greater than or equal to 17.5 mm, greater than or equal to 20 mm, greater than or equal to 22.5 mm, greater than or equal to 25 mm, greater than or equal to 30 mm, greater than or equal to 35 mm, greater than or equal to 40 mm, or greater than or equal to 45 mm. Combinations of the above-referenced ranges are also possible (e.g., less than or equal to 50 mm and greater than or equal to 0 mm, less than or equal to 20 mm and greater than or equal to 0 mm, or less than or equal to 10 mm and greater than or equal to 0 mm). Other ranges are also possible.

The poly(urethane) wicking height of a non-woven fiber web may be determined by the process described in Example 5.

When a filter media comprises two or more non-woven fiber webs, each non-woven fiber web may independently have a poly(urethane) wicking height in one or more of the above-described ranges.

The non-woven fiber webs described herein may have a variety of suitable average oil carryovers. In some embodiments, a non-woven fiber web has an average oil carryover of less than or equal to 30 mg/m³, less than or equal to 27.5 mg/m³, less than or equal to 25 mg/m³, less than or equal to 22.5 mg/m³, less than or equal to 20 mg/m³, less than or equal to 17.5 mg/m³, less than or equal to 15 mg/m³, less than or equal to 12.5 mg/m³, less than or equal to 10 mg/m³, less than or equal to 7.5 mg/m³, less than or equal to 5 mg/m³, less than or equal to 2 mg/m³, less than or equal to 1 mg/m³, less than or equal to 0.75 mg/m³, less than or equal to 0.5 mg/m³, less than or equal to 0.2 mg/m³, less than or equal to 0.1 mg/m³, less than or equal to 0.075 mg/m³, less than or equal to 0.05 mg/m³, less than or equal to 0.02 mg/m³, less than or equal to 0.01 mg/m³, less than or equal to 0.0075 mg/m³, less than or equal to 0.005 mg/m³, less than or equal to 0.002 mg/m³, less than or equal to 0.001 mg/m³, less than or equal to 0.00075 mg/m³, less than or equal to 0.0005 mg/m³, less than or equal to 0.0002 mg/m³, or less than or equal to 0.0001 mg/m³. In some embodiments, a non-woven fiber web has an average oil carryover of greater than or equal to 0.00005 mg/m³, greater than or equal to 0.0001 mg/m³, greater than or equal to 0.0002 mg/m³, greater than or equal to 0.0005 mg/m³, greater than or equal to 0.00075 mg/m³, greater than or equal to 0.001 mg/m³, greater than or equal to 0.002 mg/m³, greater than or equal to 0.005 mg/m³, greater than or equal to 0.0075 mg/m³, greater than or equal to 0.01 mg/m³, greater than or equal to 0.02 mg/m³, greater than or equal to 0.05 mg/m³, greater than or equal to 0.075 mg/m³, greater than or equal to 0.1 mg/m³, greater than or equal to 0.2 mg/m³, greater than or equal to 0.5 mg/m³, greater than or equal to 0.75 mg/m³, greater than or equal to 1 mg/m³, greater than or equal to 2 mg/m³, greater than or equal to 5 mg/m³, greater than or equal to 7.5 mg/m³, greater than or equal to 12.5 mg/m³, greater than or equal to 15 mg/m³, greater than or equal to 17.5 mg/m³, greater than or equal to 20 mg/m³, greater than or equal to 22.5 mg/m³, greater than or equal to 25 mg/m³, or greater than or equal to 27.5 mg/m³. Combinations of the above-referenced ranges are also possible (e.g., less than or equal to 30 mg/m³ and greater than or equal to 0.00005 mg/m³, less than or equal to 20 mg/m³ and greater than or equal to 0.001 mg/m³, or less than or equal to 15 mg/m³ and greater than or equal to 0.001 mg/m³). Other ranges are also possible.

The average oil carryover of a non-woven fiber web may be determined by creating a sample for testing, generating an aerosol of oil in air, exposing 100 cm² of the sample to the oil aerosol for 70 minutes, and then determining an average concentration of oil in the air that passes through the sample. The sample to be tested is created by stacking four layers of the filter media, each having a 175 cm² area, together. The oil employed may be Shell Corena S3 R46, and may have an average particle size of 0.7 microns and a maximum particle size of below 1 micron.

The oil aerosol may be generated with an aerosol generator (e.g., from Topas). The aerosol generator may flow air through an oil reservoir at a flow rate of 50 L/min to generate the oil aerosol. Prior to impinging on the sample, the oil aerosol may be combined with an amount of oil-free air flowing at a rate of 62 L/min to form a final oil aerosol flowing at a flow rate of 112 L/min and a face velocity of 20 cm/s. This final oil aerosol typically has an average oil concentration of 2 g/(m³ of air). However, it should be understood that the actual concentration of oil can vary slightly and that such slight variations are not expected to affect the measured average oil carryover. The oil concentration may be determined by measuring the rate of oil loss from the oil reservoir and dividing that value by the known rate of air flow through the oil reservoir.

The number and size of the oil particles passing through the sample may be assessed with a particle counter (e.g., from Palas) positioned on the opposite side of the sample from the side on which the oil aerosol impinged. The particle counter may be employed to take such measurements every minute, and each measurement may measure the total number of each size of particle detected by the particle counter over the preceding minute. The concentration of oil passing through the sample for each particle counter measurement may be calculated from the measured number and size of particles by multiplying the total volume of the particles counted by the known oil density and then dividing that number by the volume of air impinging on the particle counter over the minute during which the measurement was made. The average concentration of oil that passes through the sample may be determined by averaging the oil concentrations measured by the particle counter over the 70 minutes of measurement.

When a filter media comprises two or more non-woven fiber webs, each non-woven fiber web may independently have an average oil carryover in one or more of the above-described ranges.

The non-woven fiber webs described herein may have a variety of suitable saturation pressure drops. In some embodiments, a non-woven fiber web has a saturation pressure drop of greater than or equal to 10 mbar, greater than or equal to 15 mbar, greater than or equal to 20 mbar, greater than or equal to 25 mbar, greater than or equal to 30 mbar, greater than or equal to 40 mbar, greater than or equal to 50 mbar, greater than or equal to 60 mbar, greater than or equal to 75 mbar, greater than or equal to 100 mbar, greater than or equal to 125 mbar, greater than or equal to 150 mbar, greater than or equal to 175 mbar, greater than or equal to 200 mbar, greater than or equal to 250 mbar, greater than or equal to 300 mbar, greater than or equal to 350 mbar, greater than or equal to 400 mbar, greater than or equal to 450 mbar, greater than or equal to 500 mbar, greater than or equal to 550 mbar, greater than or equal to 600 mbar, greater than or equal to 650 mbar, or greater than or equal to 700 mbar. In some embodiments, a non-woven fiber web has a saturation pressure drop of less than or equal to 750 mbar, less than or equal to 700 mbar, less than or equal to 650 mbar, less than or equal to 600 mbar, less than or equal to 550 mbar, less than or equal to 500 mbar, less than or equal to 450 mbar, less than or equal to 400 mbar, less than or equal to 350 mbar, less than or equal to 300 mbar, less than or equal to 250 mbar, less than or equal to 200 mbar, less than or equal to 175 mbar, less than or equal to 150 mbar, less than or equal to 125 mbar, less than or equal to 100 mbar, less than or equal to 75 mbar, less than or equal to 60 mbar, less than or equal to 50 mbar, less than or equal to 40 mbar, less than or equal to 35 mbar, less than or equal to 30 mbar, less than or equal to 25 mbar, less than or equal to 20 mbar, or less than or equal to 15 mbar. Combinations of the above-referenced ranges are also possible (e.g., greater than or equal to 10 mbar and less than or equal to 750 mbar, greater than or equal to 20 mbar and less than or equal to 500 mbar, or greater than or equal to 30 mbar and less than or equal to 350 mbar). Other ranges are also possible.

The saturation pressure drop of a non-woven fiber web may be determined by performing the measurement technique for determining the average oil carryover described elsewhere herein and then measuring the pressure drop across the sample at the conclusion of the measurement (i.e., after 70 minutes of exposure of the sample to the oil aerosol).

When a filter media comprises two or more non-woven fiber webs, each non-woven fiber web may independently have a saturation pressure drop in one or more of the above-described ranges.

As described above, in some embodiments, a filter media comprises one or more further layers in addition to a main filter layer. For instance, a filter media may further comprise a prefilter layer, a support layer, a scrim, and/or further main filter layers. The main filter layer, when present, may be particularly useful for removing particles from a fluid flowing through the filter media. Other layers used in conjunction with main filter layers may be suitable for other purposes. For instance, some layers may be suitable for draining oil from the filter media and/or reducing the release of oil into process air. Non-limiting examples of suitable layer types for such layers include meltblown non-woven fiber webs, electrospun non-woven fiber webs, wet laid non-woven fiber webs, carded non-woven fiber webs, and other non-wet laid non-woven fiber webs. Such layers may be laminated to each other and/or to a main filter layer. In some embodiments, a filter media further comprises a drainage layer, such as a synthetic drainage layer.

In some embodiments, a filter media comprises two or more of a single layer type. For instance, as described above, a filter media may comprise two or more main filter layers. It is also possible for a filter media to comprise two or more of another type of layer (e.g., a relatively open layer, such as a support layer or a scrim). In some embodiments, a filter media comprises both a main filter layer and a relatively open layer. The filter media may comprise multiple pairs of such layers (e.g., two or more pairs of a main filter layer and a relatively open layer, three or more pairs of a main filter layer and a relatively open layer, four or more pairs of a main filter layer and a relatively open layer, or five or more pairs of a main filter layer and a relatively open layer).

The filter media as a whole may have a variety of suitable properties. Further details regarding properties some filter media may have are provided below.

The filter media described herein may have a variety of suitable basis weights. In some embodiments, a filter media has a basis weight of greater than or equal to 20 gsm, greater than or equal to 30 gsm, greater than or equal to 40 gsm, greater than or equal to 50 gsm, greater than or equal to 60 gsm, greater than or equal to 70 gsm, greater than or equal to 80 gsm, greater than or equal to 90 gsm, greater than or equal to 100 gsm, greater than or equal to 110 gsm, greater than or equal to 120 gsm, greater than or equal to 130 gsm, greater than or equal to 140 gsm, greater than or equal to 150 gsm, greater than or equal to 160 gsm, greater than or equal to 170 gsm, greater than or equal to 180 gsm, greater than or equal to 190 gsm, greater than or equal to 200 gsm, greater than or equal to 225 gsm, greater than or equal to 250 gsm, greater than or equal to 275 gsm, greater than or equal to 300 gsm, greater than or equal to 350 gsm, greater than or equal to 400 gsm, or greater than or equal to 450 gsm. In some embodiments, a filter media has a basis weight of less than or equal to 500 gsm, less than or equal to 450 gsm, less than or equal to 400 gsm, less than or equal to 350 gsm, less than or equal to 300 gsm, less than or equal to 275 gsm, less than or equal to 250 gsm, less than or equal to 225 gsm, less than or equal to 200 gsm, less than or equal to 190 gsm, less than or equal to 180 gsm, less than or equal to 170 gsm, less than or equal to 160 gsm, less than or equal to 150 gsm, less than or equal to 140 gsm, less than or equal to 130 gsm, less than or equal to 120 gsm, less than or equal to 110 gsm, less than or equal to 100 gsm, less than or equal to 90 gsm, less than or equal to 80 gsm, less than or equal to 70 gsm, less than or equal to 60 gsm, less than or equal to 50 gsm, less than or equal to 40 gsm, or less than or equal to 30 gsm. Combinations of the above-referenced ranges are also possible (e.g., greater than or equal to 20 gsm and less than or equal to 500 gsm, greater than or equal to 20 gsm and less than or equal to 400 gsm, greater than or equal to 20 gsm and less than or equal to 200 gsm, greater than or equal to 20 gsm and less than or equal to 150 gsm, greater than or equal to 20 gsm and less than or equal to 130 gsm, greater than or equal to 30 gsm and less than or equal to 400 gsm, or greater than or equal to 40 gsm and less than or equal to 250 gsm). Other ranges are also possible.

The basis weight of a filter media may be determined in accordance with ISO 536:2012.

The filter media described herein may have a variety of suitable thicknesses. In some embodiments, a filter media has a thickness of greater than or equal to 100 microns, greater than or equal to 200 microns, greater than or equal to 250 microns, greater than or equal to 300 microns, greater than or equal to 400 microns, greater than or equal to 500 microns, greater than or equal to 750 microns, greater than or equal to 1000 microns, greater than or equal to 2000 microns, greater than or equal to 3000 microns, or greater than or equal to 4000 microns. In some embodiments, a filter media has a thickness of less than or equal to 5000 microns, less than or equal to 4000 microns, less than or equal to 3000 microns, less than or equal to 2000 microns, less than or equal to 1000 microns, less than or equal to 750 microns, less than or equal to 500 microns, less than or equal to 400 microns, less than or equal to 300 microns, less than or equal to 200 microns, or less than or equal to 200 microns. Combinations of the above-referenced ranges are also possible (e.g., greater than or equal to 100 microns and less than or equal to 5000 microns, greater than or equal to 200 microns and less than or equal to 5000 microns, greater than or equal to 200 microns and less than or equal to 3000 microns, or greater than or equal to 250 microns and less than or equal to 2000 microns). Other ranges are also possible.

The thickness of filter media may be determined in accordance with ASTM D1777-96 (2019) under an applied pressure of 2 kPa.

The filter media described herein may have a variety of suitable mean flow pore sizes. In some embodiments, a filter media has a mean flow pore size of greater than or equal to 0.5 microns, greater than or equal to 0.75 microns, greater than or equal to 1 micron, greater than or equal to 1.25 microns, greater than or equal to 1.5 microns, greater than or equal to 1.75 microns, greater than or equal to 2 microns, greater than or equal to 2.25 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 17.5 microns, greater than or equal to 20 microns, greater than or equal to 25 microns, greater than or equal to 30 microns, greater than or equal to 35 microns, greater than or equal to 40 microns, or greater than or equal to 45 microns. In some embodiments, a filter media has a mean flow pore size of less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2.5 microns, less than or equal to 2.25 microns, less than or equal to 2 microns, less than or equal to 1.75 microns, less than or equal to 1.5 microns, less than or equal to 1.25 microns, less than or equal to 1 micron, or less than or equal to 0.75 microns. Combinations of the above-referenced ranges are also possible (e.g., greater than or equal to 0.5 microns and less than or equal to 50 microns, greater than or equal to 0.5 microns and less than or equal to 35 microns, or greater than or equal to 1 micron and less than or equal to 15 microns). Other ranges are also possible.

The mean flow pore size of a filter media may be determined in accordance with ASTM F316-90 Method B (2019).

The filter media described herein may have a variety of suitable maximum pore sizes. In some embodiments, a filter media has a maximum pore size of greater than or equal to 1.5 microns, greater than or equal to 1.75 microns, greater than or equal to 2 microns, greater than or equal to 2.5 microns, greater than or equal to 3 microns, greater than or equal to 4 microns, greater than or equal to 5 microns, greater than or equal to 6 microns, greater than or equal to 8 microns, greater than or equal to 10 microns, greater than or equal to 12.5 microns, greater than or equal to 15 microns, greater than or equal to 17.5 microns, greater than or equal to 20 microns, greater than or equal to 25 microns, greater than or equal to 30 microns, greater than or equal to 35 microns, greater than or equal to 40 microns, greater than or equal to 45 microns, greater than or equal to 50 microns, greater than or equal to 60 microns, greater than or equal to 70 microns, greater than or equal to 80 microns, or greater than or equal to 90 microns. In some embodiments, a filter media has a maximum pore size of less than or equal to 100 microns, less than or equal to 90 microns, less than or equal to 80 microns, less than or equal to 70 microns, less than or equal to 60 microns, less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 17.5 microns, less than or equal to 15 microns, less than or equal to 12.5 microns, less than or equal to 10 microns, less than or equal to 8 microns, less than or equal to 6 microns, less than or equal to 5 microns, less than or equal to 4 microns, less than or equal to 3 microns, less than or equal to 2.5 microns, less than or equal to 2 microns, or less than or equal to 1.75 microns. Combinations of the above-referenced ranges are also possible (e.g., greater than or equal to 1.5 microns and less than or equal to 100 microns, greater than or equal to 1.5 microns and less than or equal to 50 microns, or greater than or equal to 2.5 microns and less than or equal to 40 microns). Other ranges are also possible.

The maximum pore size of a filter media may be determined in accordance with ASTM F316-90 Method B (2019).

Some filter media described herein may have relatively high water repellencies. In some embodiments, a filter media has a water repellency of greater than or equal to 0.5 inches H₂O, greater than or equal to 1 inch H₂O, greater than or equal to 2 inches H₂O, greater than or equal to 3 inches H₂O, greater than or equal to 4 inches H₂O, greater than or equal to 4.5 inches H₂O, greater than or equal to 5 inches H₂O, greater than or equal to 5.5 inches H₂O, greater than or equal to 6 inches H₂O, greater than or equal to 7 inches H₂O, greater than or equal to 8 inches H₂O, greater than or equal to 9 inches H₂O, greater than or equal to 10 inches H₂O, greater than or equal to 12.5 inches H₂O, greater than or equal to 15 inches H₂O, greater than or equal to 20 inches H₂O, greater than or equal to 30 inches H₂O, greater than or equal to 40 inches H₂O, greater than or equal to 50 inches H₂O, greater than or equal to 75 inches H₂O, greater than or equal to 100 inches H₂O, greater than or equal to 125 inches H₂O, greater than or equal to 150 inches H₂O, greater than or equal to 175 inches H₂O, greater than or equal to 200 inches H₂O, greater than or equal to 225 inches H₂O, greater than or equal to 250 inches H₂O, or greater than or equal to 275 inches H₂O. In some embodiments, a filter media has a water repellency of less than or equal to 300 inches H₂O, less than or equal to 275 inches H₂O, less than or equal to 250 inches H₂O, less than or equal to 225 inches H₂O, less than or equal to 200 inches H₂O, less than or equal to 175 inches H₂O, less than or equal to 150 inches H₂O, less than or equal to 125 inches H₂O, less than or equal to 100 inches H₂O, less than or equal to 75 inches H₂O, less than or equal to 50 inches H₂O, less than or equal to 40 inches H₂O, less than or equal to 30 inches H₂O, less than or equal to 20 inches H₂O, less than or equal to 15 inches H₂O, less than or equal to 12.5 inches H₂O, less than or equal to 10 inches H₂O, less than or equal to 9 inches H₂O, less than or equal to 8 inches H₂O, less than or equal to 7 inches H₂O, less than or equal to 6 inches H₂O, less than or equal to 5.5 inches H₂O, less than or equal to 5 inches H₂O, less than or equal to 4.5 inches H₂O, less than or equal to 4 inches H₂O, less than or equal to 3 inches H₂O, or less than or equal to 2 inches H₂O. Combinations of the above-referenced ranges are also possible (e.g., greater than or equal to 0.5 inches H₂O and less than or equal to 300 inches H₂O, greater than or equal to 0.5 inches H₂O and less than or equal to 100 inches H₂O, greater than or equal to 4 inches H₂O and less than or equal to 40 inches H₂O, greater than or equal to 7 inches H₂O and less than or equal to 20 inches H₂O, greater than or equal to 20 inches H₂O and less than or equal to 35 inches H₂O, greater than or equal to 4 inches H₂O and less than or equal to 300 inches H₂O, greater than or equal to 5 inches H₂O and less than or equal to 200 inches H₂O, or greater than or equal to 10 inches H₂O and less than or equal to 150 inches H₂O). Other ranges are also possible.

The water repellency of a filter media may be determined by performing a Hydrostatic Head Test (HHT), which determines the height of water that the media will support before a predetermined amount of liquid passes through. Filter media with higher values measured by the HHT exhibit greater barriers to liquid penetration than filter media with lower values measured by the HHT. The HHT may be performed according to the standards BS EN 20811:1992 (British), EN 20811:1992, and ISO 811:1981 (international) for determining resistance to water penetration on a FX3000 Hydrotester III instrument.

In some embodiments, a filter media can be characterized by a title that indicates an efficiency level within a certain range. As one example, a filter media may be a high efficiency particulate air (HEPA) or ultra low particulate air (ULPA) filter. These filters are required to remove particulates at an efficiency level specified by EN1822:2009. In some embodiments, the filter media removes particulates at the most penetrating particle size (the particle size with the highest penetration) at an efficiency of greater than 99.95% (H 13), greater than 99.995% (H 14), greater than 99.9995% (U 15), greater than 99.99995% (U 16), or greater than 99.999995% (U 17). It is also possible for a filter media described herein to be an M5, M6, F7, F8, F9, E10, E11, or E12 filter media as per EN 779 (2012) and/or EN 1822:2009. These filter media must exhibit efficiencies of 40%-60% for 0.4 micron diameter particles, 60%-80% for 0.4 micron diameter particles, 80%-90% for 0.4 micron diameter particles, 90%-95% for 0.4 micron diameter particles, greater than or equal to 95% for 0.4 micron diameter particles, greater than or equal to 85% for particles at the most penetrating particle size, greater than or equal to 95% for particles at the most penetrating particle size, and greater than or equal to 99.5% for particles at the most penetrating particle size, respectively. As a third example, a filter media may be an ePM1, ePM2.5, ePM10 or ISO Coarse filter media as per ISO 16890. As a fourth example, a filter media may be a MERV 8, MERV 9, MERV 10, MERV 11, MERV 12, MERV 13, MERV 14, MERV 15, or MERV 16 filter media as per ANSI and ASHRAE 52.2.

In some embodiments, a filter media described herein has a relatively high value of initial dioctyl phthalate (DOP) gamma. The initial DOP gamma may be measured at 0.3 microns for filter media having an efficiency of less than or equal to 99.95%, may be measured at 0.19 microns for filter media having an efficiency of greater than 99.95% and less than 99.995%, and may be measured at the most penetrating particle size for filter media having an efficiency of greater than or equal to 99.995%. The initial DOP gamma at a particular particle size (e.g., 0.3 microns, 0.19 microns, most penetrating particle size) is defined by the following formula: DOP gamma=(−log₁₀(initial DOP penetration at particle size, %/100%)/(initial air resistance, mm H₂O))×100.

Penetration, often expressed as a percentage, is defined as follows: Pen (%)=(C/C₀)*100% where C is the particle concentration after passage through the filter media and Co is the particle concentration before passage through the filter media. The initial penetration for DOP particles of a particular size may be measured by blowing DOP particles of that size through a filter media and measuring the percentage of particles that penetrate therethrough.

The testing for 0.3 micron diameter particles may be performed in accordance with ASTM D2986 (1999). One exemplary method for carrying out this testing follows, but other such methods are also possible. A TDA-100P automated penetrometer and filter tester available from Air Techniques International may be employed to blow DOP particles at a 100 cm² face area of the upstream face of the filter media with a face velocity of 5.33 cm/s. The DOP particles may have a mass mean diameter of 0.3 microns (and also have a 0.18 micron count median diameter and a geometric standard deviation of less than 1.6 microns). The upstream and downstream particle concentrations may be measured by use of condensation particle counters. The DOP particles may be blown at the upstream face of the filter media until the penetration reading is determined to be stable by the TDA-100P automated penetrometer and filter tester.

The testing for 0.19 micron diameter particles may be performed by methods known to those in the art. One exemplary such method follows. Briefly, a TSI 3160 may be employed to blow DOP particles through a filter media at a 100 cm² face area of the upstream face of the filter media with a face velocity of 2.5 cm/s and an air flow of 12 IL/min. The DOP particles may have an average particle diameter of 0.19 microns. The DOP particles may be blown at the upstream face of the filter media for a period of time between 20 seconds and 400 seconds and such that at least 70 downstream counts are obtained. The upstream and downstream particle concentrations may be measured throughout the measurement period by condensation particle counters, and the total upstream and downstream particle counts across the measurement period may be employed to calculate the gamma value.

The testing for penetration at the most penetrating particle size may be performed by methods known to those in the art. One exemplary such method follows. In this method, the procedure described above for 0.19 micron diameter particles is followed, except that DOP particles having a range of sizes may be blown at the upstream face of the filter media. The particle size for which the highest penetration is measured is then considered the most penetrating particle size, and the penetration at that particle size is employed in the gamma calculation. For such analysis, the TSI 3160 may instead be employed to sequentially blow populations of DOP particles with varying average particle diameters at a 100 cm² portion of the upstream face of the filter media. The populations of particles may be blown at the upstream face of the filter media in order of increasing average diameter, and may have the following set of average diameters: 0.03 microns, 0.06 microns, 0.08 microns, 0.13 microns, and 0.2 microns. Each population of particles may be blown in the same manner as described in the immediately preceding paragraph.

The air resistance of a filter media may be determined by the same procedure described elsewhere herein with respect to the air resistance of a non-woven fiber web.

In some embodiments, a filter media has an initial DOP gamma of greater than or equal to 6, greater than or equal to 6.5, greater than or equal to 7, greater than or equal to 7.5, greater than or equal to 8, greater than or equal to 8.5, greater than or equal to 9, greater than or equal to 9.5, greater than or equal to 10, greater than or equal to 11, greater than or equal to 12, greater than or equal to 13, greater than or equal to 14, greater than or equal to 15, greater than or equal to 17.5, greater than or equal to 20, greater than or equal to 22.5, greater than or equal to 25, or greater than or equal to 27.5. In some embodiments, a filter media has an initial DOP gamma of less than or equal to 30, less than or equal to 27.5, less than or equal to 25, less than or equal to 22.5, less than or equal to 20, less than or equal to 17.5, less than or equal to 15, less than or equal to 14, less than or equal to 13, less than or equal to 12, less than or equal to 11, less than or equal to 10, less than or equal to 9.5, less than or equal to 9, less than or equal to 8.5, less than or equal to 8, less than or equal to 7.5, less than or equal to 7, or less than or equal to 6.5. Combinations of the above-referenced ranges are also possible (e.g., greater than or equal to 6 and less than or equal to 30, greater than or equal to 8 and less than or equal to 30, greater than or equal to 9 and less than or equal to 30, greater than or equal to 9 and less than or equal to 25, greater than or equal to 9 and less than or equal to 20, or greater than or equal to 10 and less than or equal to 25). Other ranges are also possible.

The filter media described herein may have a variety of suitable air resistances. In some embodiments, a filter media has an air resistance of greater than or equal to 0.5 Pa, greater than or equal to 0.6 Pa, greater than or equal to 0.8 Pa, greater than or equal to 1 Pa, greater than or equal to 2 Pa, greater than or equal to 5 Pa, greater than or equal to 7.5 Pa, greater than or equal to 10 Pa, greater than or equal to 20 Pa, greater than or equal to 25 Pa, greater than or equal to 28 Pa, greater than or equal to 30 Pa, greater than or equal to 35 Pa, greater than or equal to 40 Pa, greater than or equal to 45 Pa, greater than or equal to 50 Pa, greater than or equal to 55 Pa, greater than or equal to 60 Pa, greater than or equal to 75 Pa, greater than or equal to 100 Pa, greater than or equal to 200 Pa, greater than or equal to 300 Pa, greater than or equal to 400 Pa, greater than or equal to 500 Pa, greater than or equal to 600 Pa, or greater than or equal to 700 Pa. In some embodiments, a filter media has an air resistance of less than or equal to 800 Pa, less than or equal to 700 Pa, less than or equal to 600 Pa, less than or equal to 500 Pa, less than or equal to 400 Pa, less than or equal to 300 Pa, less than or equal to 200 Pa, less than or equal to 100 Pa, less than or equal to 75 Pa, less than or equal to 60 Pa, less than or equal to 55 Pa, less than or equal to 50 Pa, less than or equal to 45 Pa, less than or equal to 40 Pa, less than or equal to 35 Pa, less than or equal to 30 Pa, less than or equal to 28 Pa, less than or equal to 25 Pa, less than or equal to 20 Pa, less than or equal to 10 Pa, less than or equal to 7.5 Pa, less than or equal to 5 Pa, less than or equal to 2 Pa, less than or equal to 1 Pa, less than or equal to 0.8 Pa, or less than or equal to 0.6 Pa. Combinations of the above-referenced ranges are also possible (e.g., greater than or equal to 0.5 Pa and less than or equal to 800 Pa, greater than or equal to 0.5 Pa and less than or equal to 60 Pa, greater than or equal to 0.8 Pa and less than or equal to 30 Pa, or greater than or equal to 2 Pa and less than or equal to 800 Pa). Other ranges are also possible.

In some embodiments, a filter media has a relatively high dry tensile strength in the machine direction. The dry tensile strength in the machine direction may be greater than or equal to 0.25 kN/m, greater than or equal to 0.5 kN/m, greater than or equal to 0.75 kN/m, greater than or equal to 1 kN/m, greater than or equal to 1.5 kN/m, greater than or equal to 2 kN/m, greater than or equal to 2.5 kN/m, greater than or equal to 3 kN/m, greater than or equal to 4 kN/m, greater than or equal to 5 kN/m, greater than or equal to 6 kN/m, greater than or equal to 7.5 kN/m, greater than or equal to 10 kN/m, or greater than or equal to 12.5 kN/m. The dry tensile strength in the machine direction may be less than or equal to 15 kN/m, less than or equal to 12.5 kN/m, less than or equal to 10 kN/m, less than or equal to 7.5 kN/m, less than or equal to 6 kN/m, less than or equal to 5 kN/m, less than or equal to 4 kN/m, less than or equal to 3 kN/m, less than or equal to 2.5 kN/m, less than or equal to 2 kN/m, less than or equal to 1.5 kN/m, less than or equal to 1 kN/m, less than or equal to 0.75 kN/m, or less than or equal to 0.5 kN/m. Combinations of the above-referenced ranges are also possible (e.g., greater than or equal to 0.25 kN/m and less than or equal to 15 kN/m). Other ranges are also possible.

The dry tensile strength in the machine direction of a filter media may be determined by the same procedure described elsewhere herein with respect to the dry tensile strength in the machine direction of a non-woven fiber web.

In some embodiments, a filter media has a relatively high machine direction Gurley stiffness. The Gurley stiffness in the machine direction may be greater than or equal to 300 mg, greater than or equal to 400 mg, greater than or equal to 500 mg, greater than or equal to 600 mg, greater than or equal to 750 mg, greater than or equal to 1000 mg, greater than or equal to 1250 mg, greater than or equal to 1500 mg, greater than or equal to 2000 mg, greater than or equal to 2500 mg, greater than or equal to 3000 mg, greater than or equal to 3500 mg, greater than or equal to 4000 mg, or greater than or equal to 4500 mg. The Gurley stiffness in the machine direction may be less than or equal to 5000 mg, less than or equal to 4500 mg, less than or equal to 4000 mg, less than or equal to 3500 mg, less than or equal to 3000 mg, less than or equal to 2500 mg, less than or equal to 2000 mg, less than or equal to 1500 mg, less than or equal to 1250 mg, less than or equal to 1000 mg, less than or equal to 750 mg, less than or equal to 600 mg, less than or equal to 500 mg, or less than or equal to 400 mg. Combinations of the above-referenced ranges are also possible (e.g., greater than or equal to 300 mg and less than or equal to 5000 mg). Other ranges are also possible.

The Gurley stiffness in the machine direction of a filter media determined by the same procedure described elsewhere herein with respect to the Gurley stiffness in the machine direction of a non-woven fiber web.

The filter media described herein may have a variety of oil ranks. In some embodiments, a filter media has an oil rank of greater than or equal to 0, greater than or equal to 1, greater than or equal to 2, greater than or equal to 3, greater than or equal to 4, or greater than or equal to 5. In some embodiments, a filter media has an oil rank of less than or equal to 6, less than or equal to 5, less than or equal to 4, less than or equal to 3, less than or equal to 2, or less than or equal to 1. Combinations of the above-referenced ranges are also possible (e.g., greater than or equal to 0 and less than or equal to 6, greater than or equal to 1 and less than or equal to 6, greater than or equal to 2 and less than or equal to 5, greater than or equal to 3 and less than or equal to 4, or greater than or equal to 5 and less than or equal to 6). Other ranges are also possible.

The oil rank of a filter media may be determined by the same procedure described elsewhere herein with respect to the oil rank of a non-woven fiber web.

The filter media described herein may have a variety of suitable poly(urethane) wicking heights. In some embodiments, a filter media has a poly(urethane) wicking height of less than or equal to 50 mm, less than or equal to 45 mm, less than or equal to 40 mm, less than or equal to 35 mm, less than or equal to 30 mm, less than or equal to 25 mm, less than or equal to 22.5 mm, less than or equal to 20 mm, less than or equal to 17.5 mm, less than or equal to 15 mm, less than or equal to 12.5 mm, less than or equal to 10 mm, less than or equal to 7.5 mm, less than or equal to 5 mm, less than or equal to 2 mm, or less than or equal to 1 mm. In some embodiments, a filter media has a poly(urethane) wicking height of greater than or equal to 0 mm, greater than or equal to 1 mm, greater than or equal to 2 mm, greater than or equal to 5 mm, greater than or equal to 7.5 mm, greater than or equal to 10 mm, greater than or equal to 12.5 mm, greater than or equal to 15 mm, greater than or equal to 17.5 mm, greater than or equal to 20 mm, greater than or equal to 22.5 mm, greater than or equal to 25 mm, greater than or equal to 30 mm, greater than or equal to 35 mm, greater than or equal to 40 mm, or greater than or equal to 45 mm. Combinations of the above-referenced ranges are also possible (e.g., less than or equal to 50 mm and greater than or equal to 0 mm, less than or equal to 20 mm and greater than or equal to 0 mm, or less than or equal to 10 mm and greater than or equal to 0 mm). Other ranges are also possible.

The poly(urethane) wicking height of a filter media may be determined by the process described in Example 5.

The filter media described herein may have a variety of suitable average oil carryovers. In some embodiments, a filter media has an average oil carryover of less than or equal to 30 mg/m³, less than or equal to 27.5 mg/m³, less than or equal to 25 mg/m³, less than or equal to 22.5 mg/m³, less than or equal to 20 mg/m³, less than or equal to 17.5 mg/m³, less than or equal to 15 mg/m³, less than or equal to 12.5 mg/m³, less than or equal to 10 mg/m³, less than or equal to 7.5 mg/m³, less than or equal to 5 mg/m³, less than or equal to 2 mg/m³, less than or equal to 1 mg/m³, less than or equal to 0.75 mg/m³, less than or equal to 0.5 mg/m³, less than or equal to 0.2 mg/m³, less than or equal to 0.1 mg/m³, less than or equal to 0.075 mg/m³, less than or equal to 0.05 mg/m³, less than or equal to 0.02 mg/m³, less than or equal to 0.01 mg/m³, less than or equal to 0.0075 mg/m³, less than or equal to 0.005 mg/m³, less than or equal to 0.002 mg/m³, less than or equal to 0.001 mg/m³, less than or equal to 0.00075 mg/m³, less than or equal to 0.0005 mg/m³, less than or equal to 0.0002 mg/m³, or less than or equal to 0.0001 mg/m³. In some embodiments, a filter media has an average oil carryover of greater than or equal to 0.00005 mg/m³, greater than or equal to 0.0001 mg/m³, greater than or equal to 0.0002 mg/m³, greater than or equal to 0.0005 mg/m³, greater than or equal to 0.00075 mg/m³, greater than or equal to 0.001 mg/m³, greater than or equal to 0.002 mg/m³, greater than or equal to 0.005 mg/m³, greater than or equal to 0.0075 mg/m³, greater than or equal to 0.01 mg/m3, greater than or equal to 0.02 mg/m³, greater than or equal to 0.05 mg/m³, greater than or equal to 0.075 mg/m³, greater than or equal to 0.1 mg/m³, greater than or equal to 0.2 mg/m³, greater than or equal to 0.5 mg/m³, greater than or equal to 0.75 mg/m³, greater than or equal to 1 mg/m³, greater than or equal to 2 mg/m³, greater than or equal to 1 mg/m³, greater than or equal to 7.5 mg/m³, greater than or equal to 12.5 mg/m³, greater than or equal to 15 mg/m³, greater than or equal to 17.5 mg/m³, greater than or equal to 20 mg/m³, greater than or equal to 22.5 mg/m³, greater than or equal to 25 mg/m³, or greater than or equal to 27.5 mg/m³. Combinations of the above-referenced ranges are also possible (e.g., less than or equal to 30 mg/m³ and greater than or equal to 0.00005 mg/m³, less than or equal to 20 mg/m³ and greater than or equal to 0.001 mg/m³, or less than or equal to 15 mg/m³ and greater than or equal to 0.001 mg/m³). Other ranges are also possible.

The average oil carryover of a filter media may be determined by the same procedure described elsewhere herein with respect to the average oil carryover of a non-woven fiber web.

The filter media described herein may have a variety of suitable saturation pressure drops. In some embodiments, a filter media has a saturation pressure drop of greater than or equal to 10 mbar, greater than or equal to 15 mbar, greater than or equal to 20 mbar, greater than or equal to 25 mbar, greater than or equal to 30 mbar, greater than or equal to 40 mbar, greater than or equal to 50 mbar, greater than or equal to 60 mbar, greater than or equal to 75 mbar, greater than or equal to 100 mbar, greater than or equal to 125 mbar, greater than or equal to 150 mbar, greater than or equal to 175 mbar, greater than or equal to 200 mbar, greater than or equal to 250 mbar, greater than or equal to 300 mbar, greater than or equal to 350 mbar, greater than or equal to 400 mbar, greater than or equal to 450 mbar, greater than or equal to 500 mbar, greater than or equal to 550 mbar, greater than or equal to 600 mbar, greater than or equal to 650 mbar, or greater than or equal to 700 mbar. In some embodiments, a filter media has a saturation pressure drop of less than or equal to 750 mbar, less than or equal to 700 mbar, less than or equal to 650 mbar, less than or equal to 600 mbar, less than or equal to 550 mbar, less than or equal to 500 mbar, less than or equal to 450 mbar, less than or equal to 400 mbar, less than or equal to 350 mbar, less than or equal to 300 mbar, less than or equal to 250 mbar, less than or equal to 200 mbar, less than or equal to 175 mbar, less than or equal to 150 mbar, less than or equal to 125 mbar, less than or equal to 100 mbar, less than or equal to 75 mbar, less than or equal to 60 mbar, less than or equal to 50 mbar, less than or equal to 40 mbar, less than or equal to 35 mbar, less than or equal to 30 mbar, less than or equal to 25 mbar, less than or equal to 20 mbar, or less than or equal to 15 mbar. Combinations of the above-referenced ranges are also possible (e.g., greater than or equal to 10 mbar and less than or equal to 750 mbar, greater than or equal to 20 mbar and less than or equal to 500 mbar, or greater than or equal to 30 mbar and less than or equal to 350 mbar). Other ranges are also possible.

The saturation pressure drop of a filter media may be determined by the same procedure described elsewhere herein with respect to the saturation pressure drop of a non-woven fiber web.

The filter media described herein may be suitable for a variety of applications. Some filter media described herein are suitable for air filtration and/or are positioned in air filters. As described elsewhere herein, some filter media are suitable for HEPA and/or ULPA filters. Further examples of suitable types of filters that the filter media described herein may be positioned in include HVAC filters, heavy duty air filters, gas turbine filters, liquid filters, and coalescer filters. Suitable coalescer filters include coalescer filters for air/oil separation and coalescer filters for liquid/liquid separation (e.g., fuel/water separation, such as jet fuel/water separation).

In some embodiments, a filter media described herein may be a component of a filter element. That is, the filter media may be incorporated into an article suitable for use by an end user.

Non-limiting examples of suitable filter elements include flat panel filters, V-bank filters (comprising, e.g., between 1 and 24 Vs), cartridge filters, cylindrical filters, and conical filters. Filter elements may have any suitable height (e.g., between 2 in and 124 in for flat panel filters, between 4 in and 124 in for V-bank filters, between 1 in and 124 in for cartridge and cylindrical filter media). Filter elements may also have any suitable width (between 2 in and 124 in for flat panel filters, between 4 in and 124 in for V-bank filters). Some filter media (e.g., cartridge filter media, cylindrical filter media) may be characterized by a diameter instead of a width; these filter media may have a diameter of any suitable value (e.g., between 1 in and 124 in). Filter elements typically comprise a frame, which may be made of one or more materials such as cardboard, aluminum, steel, alloys, wood, and polymers.

In some embodiments, a filter media described herein may be a component of a filter element and may be pleated. The pleat height and pleat density (number of pleats per unit length of the media) may be selected as desired. In some embodiments, the pleat height may be greater than or equal to 10 mm, greater than or equal to 15 mm, greater than or equal to 20 mm, greater than or equal to 25 mm, greater than or equal to 30 mm, greater than or equal to 35 mm, greater than or equal to 40 mm, greater than or equal to 45 mm, greater than or equal to 50 mm, greater than or equal to 53 mm, greater than or equal to 55 mm, greater than or equal to 60 mm, greater than or equal to 65 mm, greater than or equal to 70 mm, greater than or equal to 75 mm, greater than or equal to 80 mm, greater than or equal to 85 mm, greater than or equal to 90 mm, greater than or equal to 95 mm, greater than or equal to 100 mm, greater than or equal to 125 mm, greater than or equal to 150 mm, greater than or equal to 175 mm, greater than or equal to 200 mm, greater than or equal to 225 mm, greater than or equal to 250 mm, greater than or equal to 275 mm, greater than or equal to 300 mm, greater than or equal to 325 mm, greater than or equal to 350 mm, greater than or equal to 375 mm, greater than or equal to 400 mm, greater than or equal to 425 mm, greater than or equal to 450 mm, greater than or equal to 475 mm, or greater than or equal to 500 mm. In some embodiments, the pleat height is less than or equal to 510 mm, less than or equal to 500 mm, less than or equal to 475 mm, less than or equal to 450 mm, less than or equal to 425 mm, less than or equal to 400 mm, less than or equal to 375 mm, less than or equal to 350 mm, less than or equal to 325 mm, less than or equal to 300 mm, less than or equal to 275 mm, less than or equal to 250 mm, less than or equal to 225 mm, less than or equal to 200 mm, less than or equal to 175 mm, less than or equal to 150 mm, less than or equal to 125 mm, less than or equal to 100 mm, less than or equal to 95 mm, less than or equal to 90 mm, less than or equal to 85 mm, less than or equal to 80 mm, less than or equal to 75 mm, less than or equal to 70 mm, less than or equal to 65 mm, less than or equal to 60 mm, less than or equal to 55 mm, less than or equal to 53 mm, less than or equal to 50 mm, less than or equal to 45 mm, less than or equal to 40 mm, less than or equal to 35 mm, less than or equal to 30 mm, less than or equal to 25 mm, less than or equal to 20 mm, or less than or equal to 15 mm. Combinations of the above-referenced ranges are also possible (e.g., greater than or equal to 10 mm and less than or equal to 510 mm, or greater than or equal to 10 mm and less than or equal to 100 mm). Other ranges are also possible.

In some embodiments, a filter media has a pleat density of greater than or equal to 5 pleats per 100 mm, greater than or equal to 6 pleats per 100 mm, greater than or equal to 10 pleats per 100 mm, greater than or equal to 15 pleats per 100 mm, greater than or equal to 20 pleats per 100 mm, greater than or equal to 25 pleats per 100 mm, greater than or equal to 28 pleats per 100 mm, greater than or equal to 30 pleats per 100 mm, or greater than or equal to 35 pleats per 100 mm. In some embodiments, a filter media has a pleat density of less than or equal to 40 pleats per 100 mm, less than or equal to 35 pleats per 100 mm, less than or equal to 30 pleats per 100 mm, less than or equal to 28 pleats per 100 mm, less than or equal to 25 pleats per 100 mm, less than or equal to 20 pleats per 100 mm, less than or equal to 15 pleats per 100 mm, less than or equal to 10 pleats per 100 mm, or less than or equal to 6 pleats per 100 mm. Combinations of the above-referenced ranges are also possible (e.g., greater than or equal to 5 pleats per 100 mm and less than or equal to 40 pleats per 100 mm, greater than or equal to 6 pleats per 100 mm and less than or equal to 40 pleats per 100 mm, or greater than or equal to 25 pleats per 100 mm and less than or equal to 28 pleats per 100 mm). Other ranges are also possible.

Other pleat heights and densities may also be possible. For instance, filter media within flat panel or V-bank filters may have pleat heights between % in and 24 in, and/or pleat densities between 1 pleat/in and 50 pleats/in. As another example, filter media within cartridge filters or conical filters may have pleat heights between % in and 24 in and/or pleat densities between h pleats/in and 100 pleats/in. In some embodiments, pleats are separated by a pleat separator made of, e.g., polymer, glass, aluminum, and/or cotton. In other embodiments, the filter element lacks a pleat separator. The filter media may be wire-backed, or it may be self-supporting.

In some embodiments, a filter media comprises one or more layers that are wrapped.

### Example 1

This Example describes the fabrication and testing of filter media comprising additives having different functional groups.

Each filter media was fabricated by introducing a fluid comprising a precursor to an H 14 filter media comprising microglass fibers and chopped strand glass fibers. The precursors employed included methyltrimethoxysilane, n-propyltrimethoxysilane, n-octyltrimethoxysilane, hexadecyltrimethoxysilane, and octadecyltrimethoxysilane. The fluid comprising the precursor was formed by mixing the precursor with water for five minutes in a laboratory mixer to form a 0.3 wt % solution or dispersion of the precursor in water. The H 14 filter media was disposed on a wire, and the H 14 filter media and the wire were then dipped together into the fluid comprising the precursor for ten seconds. After removal from the fluid comprising the precursor, the H 14 filter media and the wire were exposed to a vacuum and then dried on a photodryer. Finally, the precursor-coated H 14 filter media was cured and then post-cured in an oven to form the final filter media including the cured water-repellent additive.

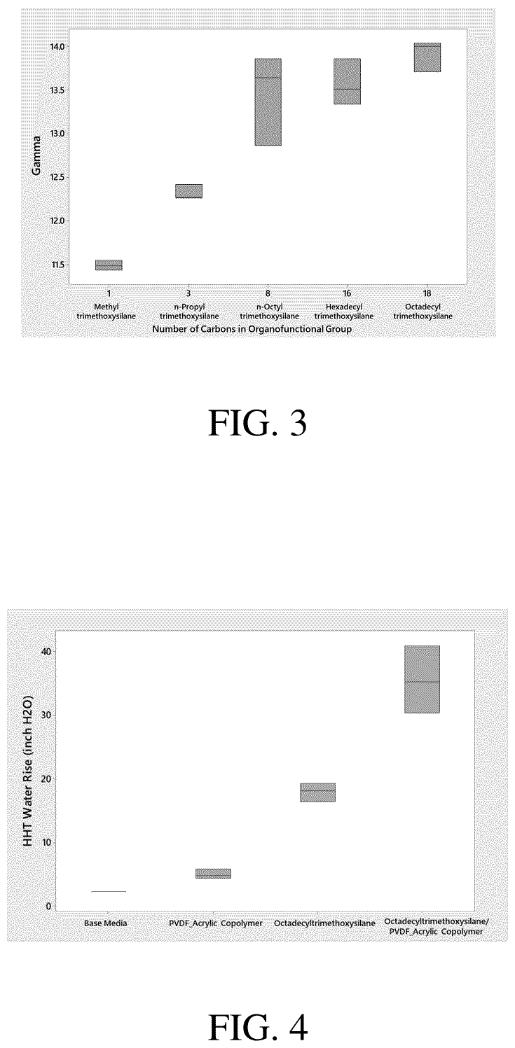

FIG. 3 shows the gamma values for each of the filter media comprising an additive formed from one of the precursors described in the preceding paragraph. In this FIG., the labels provided identify the precursor. As can be seen from the data shown therein, filter media comprising additives formed from precursors having longer water-repellent functional groups had higher values of gamma than filter media comprising water-repellent additives having shorter water-repellent functional groups.

The water repellency of each filter media was also measured. The values observed were all sufficiently high to allow the filter media to be suitable for applications where water repellency is needed (e.g., in excess of 10 inches H₂O).

### Example 2

This Example describes the fabrication and testing of a filter media comprising a water-repellent additive and a fluorinated resin. This filter media was compared to filter media lacking either or both of these species.

The filter media comprising both the water-repellent additive and the fluorinated resin was fabricated as described in Example 1, except that a dispersion of the resin and the water-repellent additive was prepared and mixed instead of a mixture of just the water-repellent additive in water. The mixture was 1.5 wt % solids and the water-repellent additive made up 20 wt % of the mixture. The resin employed was a PVDF-acrylic copolymer. The precursor employed was octadecyltrimethoxysilane. After exposure to the mixture, the non-woven fiber web weighed 4-5% more than it did prior to the exposure. The filter media comprising just the fluorinated resin was prepared in this same manner except that the water-repellent additive was not included in the dispersion. The filter media comprising just the water-repellent additive was fabricated as described in Example 1.

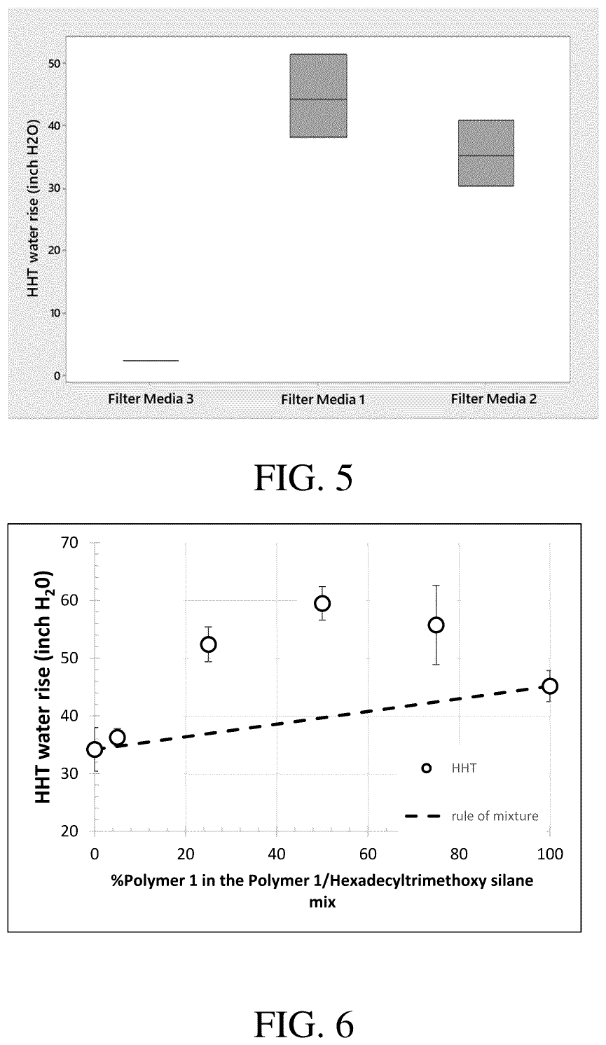

FIG. 4 shows the water repellency for various filter media. From FIG. 4, it is seen that filter media comprising both an additive formed from octadecyltrimethoxysilane and a PVDF-acrylic copolymer resin had an increased water repellency in comparison to filter media lacking either or both species (the latter denoted by “Base Media”). Accordingly, the PVDF-acrylic copolymer and octadecyltrimethoxysilane are believed to act synergistically.

### Example 3

This Example describes the fabrication and testing of filter media comprising a water-repellent additive and an additive comprising a polar functional group. The filter media further comprised a PVDF-acrylic copolymer. This filter media was compared to filter media lacking the additive comprising the polar functional group.

The filter media were fabricated as described in Example 2, except that each additive made up 10 wt % of the mixture. The water-repellent additive was octadecyltrimethoxysilane and the additive comprising the polar functional group was aminopropyltrimethoxysilane. FIG. 5 shows the water-repellency of the three filter media tested. From FIG. 5, it is clear that the filter media comprising all three species (Filter Media 1) had a higher water repellency than both the filter media lacking the aminopropyltrimethoxysilane (Filter Media 2) and the filter media lacking both additives and the PVDF-acrylic copolymer (Filter Media 3).

### Example 4

This Example describes the fabrication and testing of filter media comprising either or both of a first water-repellent additive comprising a water-repellent functional group that is an alkyl group comprising greater than or equal to 3 carbon atoms and a second water-repellent additive that is a fluorinated water-repellent additive.

The filter media were fabricated as described in Example 2, except that: an acrylic resin was employed instead of a PVDF-acrylic copolymer; the precursor for the first water-repellent additive was hexadecyltrimethoxysilane; the dispersion further comprised a second water-repellent additive that was either a perfluoropoly(ether) (Polymer 1) or a polymer comprising a fluorinated side chain having the structure —C₄FₘR_{y} with m≥1 (Polymer 2); the ratio of the weight of the resin to the sum of the weights of the first and second water-repellent additives was 4:1; the dispersion was formed by employing a laboratory mixer to mix the precursors and resin with water for five minutes to form a 99 wt % water dispersion.

FIGS. 6 and 7 show the water repellency of each filter media. FIG. 6 shows the water repellency for filter media comprising Polymer 1 and FIG. 7 shows the water repellency for filter media comprising Polymer 2. As can be seen in both FIGS., the water repellency of the filter media were higher than the water repellency predicted by the rule of mixtures (a rule that predicts that the physical properties of a mixture are the composition-weighted averages of the physical properties of the mixture components). Thus, the inclusion of both the first water-repellent additive and the second water-repellent additive had unexpectedly high water repellency.

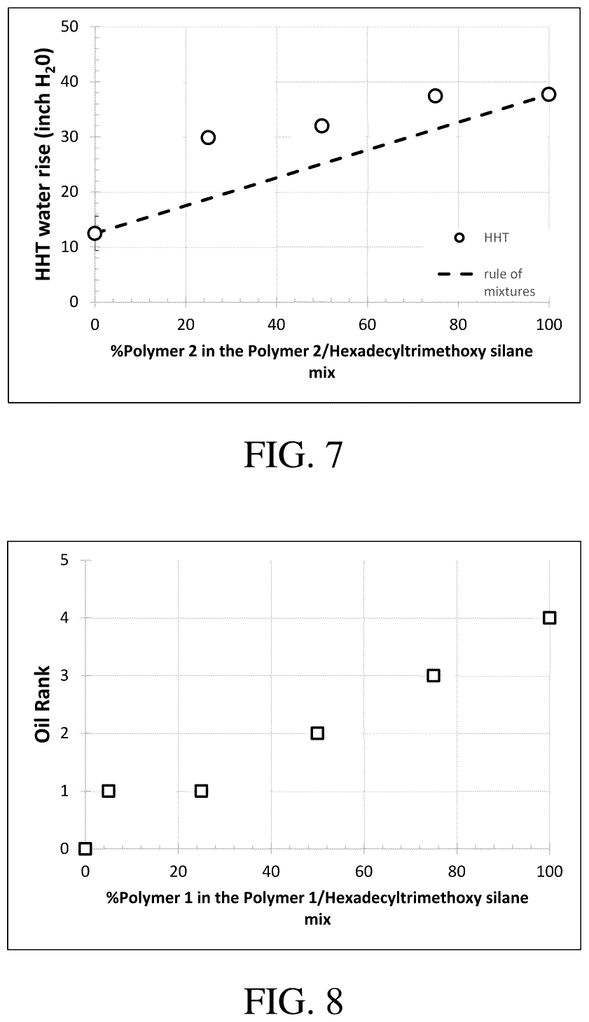

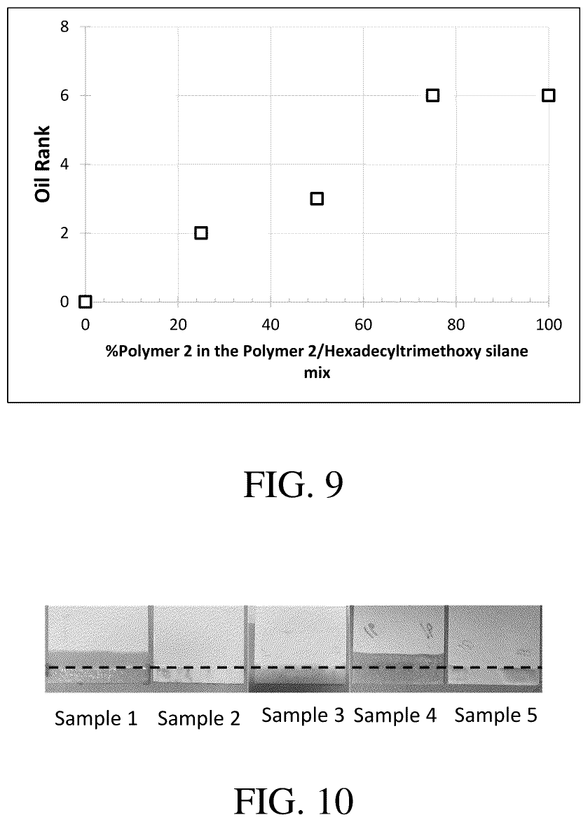

FIGS. 8 and 9 shows the oil rank of each filter media. FIG. 8 shows the oil rank for filter media comprising Polymer 1 and FIG. 9 shows the oil rank for filter media comprising Polymer 2. As can be seen from these FIGS., the inclusion of a water-repellent additive that was a fluorinated polymer enhanced the oil rank of the filter media.

### Example 5

This Example describes the fabrication and testing of filter media comprising a variety of water-repellent additives.

Five filter media were fabricated that differed in the water-repellent additives included therein. The compositions of the water-repellent additives and resins present in the filter media are summarized below in Table 2.

TABLE 2

| Sample No. | Water-Repellent Additive(s) |
|---|---|
| 1 | None |
| 2 | Polymer 1 |
| 3 | Non-Fluorinated Water-Repellent Additive 1 |
| | (a water-repellent additive comprising an |
| | alkyl group comprising greater than or equal |
| | to 3 carbon atoms) and Polymer 1 in equal |
| | amounts |
| 4 | Non-Fluorinated Water-Repellent Additive 1 |
| 5 | Fluorinated Water-Repellent Additive 1 |
| | (water-repellent additive comprising the side |
| | chain —C₆FₘR_{y} with m ≥ 1) |

Then, the poly(urethane) wicking height of each filter media was measured on three different 3.5″×2″ samples. Each 3.5″×2″ sample was placed vertically in a 250 mL beaker including an amount of a poly(urethane) adhesive. The samples were placed in the beaker at a depth such that their lowermost points were submerged to a depth of 10 mm±1 mm and then allowed to remain there for two minutes. At the conclusion of the two minutes, each sample was removed from its beaker and excess resin was wiped from away from the filter media surface. Then, the distance that the resin traveled up the filter media (i.e., the difference between the resin height just after placement of the sample in the beaker and the resin height at the conclusion of the two minutes) was measured in at both edges. Finally, the six values for each filter media (i.e., the two measurements for each of the three samples) were averaged to yield a final poly(urethane) wicking height.

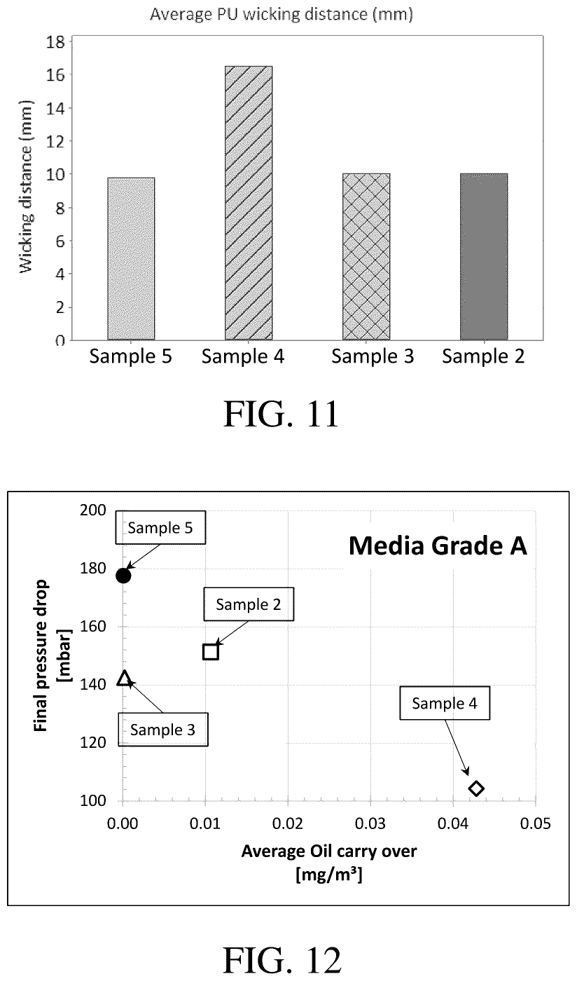

FIG. 10 shows photographs of five of the samples at the conclusion of the measurement and FIG. 11 shows the measured poly(urethane) wicking heights. As can be seen from these FIGS., the inclusion of a fluorinated water-repellent additive decreases the poly(urethane) wicking height.

### Example 6

This Example describes the fabrication and testing of filter media comprising a variety of different water-repellent additives.

Eight filter media were fabricated: four of a first type of coalescer grade and four of a second type of coalescer grade. Tables 3 and 4, below, show further properties of the coalescer grades.

TABLE 3
(Coalescer Grade A properties).

| | |
|---|---|
| | Wt % of All |
| Fiber Type | Fibers Present |

Fiber Properties

| | |
|---|---|
| Microglass fibers having a fiber diameter of | 8 |
| between 0.2 microns and 0.45 microns | |
| Microglass fibers having a fiber diameter of | 53 |
| between 0.5 microns and 1 micron | |
| Microglass fibers having an average fiber | 39 |
| diameter of between 2.5 microns and 10 | |
| microns | |

Physical Properties

| | |
|---|---|
| Basis weight (gsm) | 80 |
| Air resistance (Pa) | 533 |
| Thickness (microns) | 530 |
| Average oil carryover (mg/m³) | 0.05 |
| Saturation pressure drop (mbar) | 200 |

TABLE 4
(Coalescer Grade B properties).

| | |
|---|---|
| | Wt % of All |
| Fiber Type | Fibers Present |

Fiber Properties

| | |
|---|---|
| Microglass fibers having a fiber diameter of | 26 |
| between 2 microns and 3 microns | |
| Microglass fibers having an average fiber | 52 |
| diameter of between 3 microns and 5 microns | |
| Chopped strand glass fibers | 15 |
| Poly(vinyl alcohol) fibers | 7 |

Physical Properties

| | |
|---|---|
| Basis weight (gsm) | 70 |
| Air resistance (Pa) | 17 |
| Thickness (microns) | 470 |
| Average oil carryover (mg/m³) | 6 |
| Saturation pressure drop (mbar) | 50 |

A different water-repellent additive or combination of water-repellent additives was added to each of the four filter media of each type of coalescer grade by the same procedure described in Example 1. The water-repellent additives, and combinations thereof, added were those of Sample Nos. 2-4 shown in Table 2.

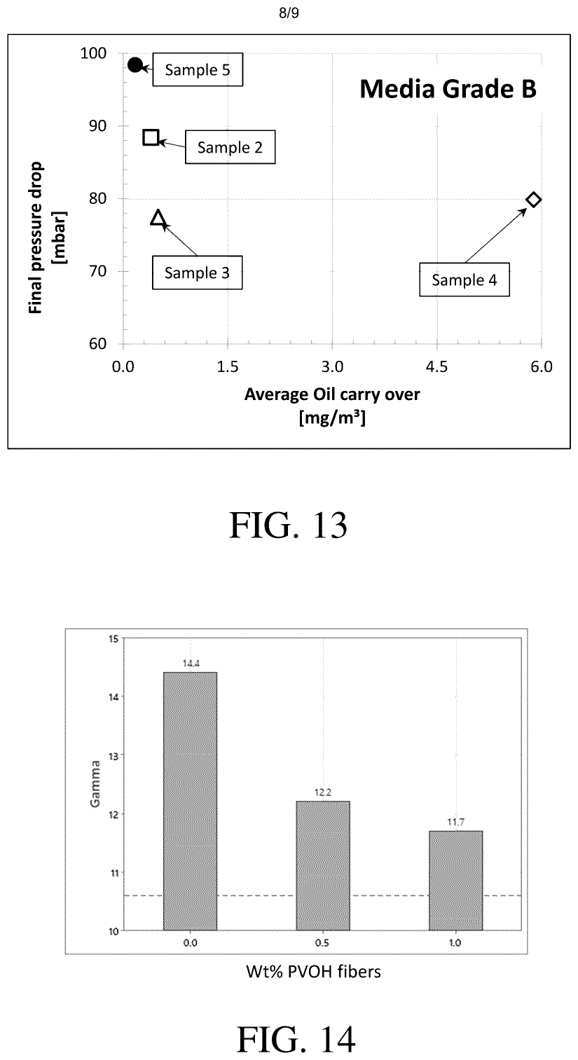

FIGS. 12 and 13 show the saturation pressure drop and average oil carryover for each filter media. As can be seen from these FIGS., filter media including a fluorinated water-repellent additive, such as a fluorinated polymer, exhibited a lower average oil carryover than filter media lacking such an additive. As can also be seen from these FIGS., filter media including both a water-repellent additive comprising an alkyl group comprising greater than or equal to 3 carbon atoms and a fluorinated polymer had a lower saturation pressure drop than the other filter media.

### Example 7

This Example describes the effects of PVOH on filter media with different resins.

As shown in Table 5, filter media comprising a PFAS resin or a PFAS-free resin, with or without PVOH fibers were studied. The gamma, DOP penetration, and air resistance were measured, according to methods described elsewhere herein. Samples A and B differed only in the type of resin used. Samples B and C differed only in the amounts of PVOH used.

TABLE 5
Components and gamma of Filter Media

| | | | | DOP | Air |
|---|---|---|---|---|---|
| | | PVOH | Saturated | Penetration | Resistance |
| Sample | Resin | (wt %) | Gamma | (%) | (mm H₂O) |
| A | PFAS | 2 | 12.1 | 40.9 | 3.2 |
| B | PFAS-free | 2 | 10.1 | 42 | 3.7 |
| | alternative | | | | |
| C | PFAS-free | 0 | 11.7 | 40.5 | 3.3 |
| | alternative | | | | |

As shown in Table 5, the use of the PFAS-free alternative resin in Sample B resulted in a lower saturated gamma than Sample A. While removal of PVOH fibers improved the saturated gamma in Sample C, it also resulted in a reduction in wet strength (measured as described elsewhere herein), such that the sample could not be processed.

### Example 8

This Example describes the fabrication and testing of non-woven fiber web samples comprising a variety of different fibers.

The non-woven fiber web samples contained fine microglass fibers (having an average diameter of less than or equal to 1 micron), glass fibers have a moderate diameter (having an average diameter of greater than 1 micron less than or equal to 6 microns), coarse glass fibers (having an average diameter of greater than 6 microns), bicomponent fibers, PVOH fibers, and/or fibrillated fibers (lyocell fibers). The amounts of each type of fiber in each sample are detailed in Table 6. The samples in Table 6 are non-woven fiber web samples before the optional addition of any resins and/or additives.

TABLE 6
Composition of Non-Woven Fiber Web Samples.

| | Fine | Glass fibers | | Bi- | | |
|---|---|---|---|---|---|---|
| | micro- | having a | Coarse | com- | | |
| | glass | moderate | glass | ponent | PVOH | Fibrillated |
| Sam- | fibers | diameter | fibers | fibers | fibers | fibers |
| ple | (wt %) | (wt %) | (wt %) | (wt %) | (wt %) | (wt %) |
| 1 | 5-25 | 60-80 | 5-25 | 1 | 0 | 0 |
| 2 | 5-25 | 60-80 | 5-25 | 1 | 0.5 | 0 |
| 3 | 5-25 | 60-80 | 5-25 | 1 | 1 | 0 |
| 4 | 5-25 | 60-80 | 5-25 | 1 | 0 | 2 |
| 5 | 5-25 | 60-80 | 5-25 | 0 | 0 | 1 |
| 6 | 5-25 | 55-75 | 5-25 | 0 | 0 | 5 |
| 7 | 5-25 | 50-70 | 5-25 | 0 | 0 | 10 |
| 8 | 5-25 | 45-65 | 5-25 | 0 | 0 | 15 |

FIG. 14 is a plot showing the gamma of samples 1-3 (left to right) of Table 6. The plot shows that gamma decreased with increasing PVOH content. Gamma was measured as described elsewhere herein.

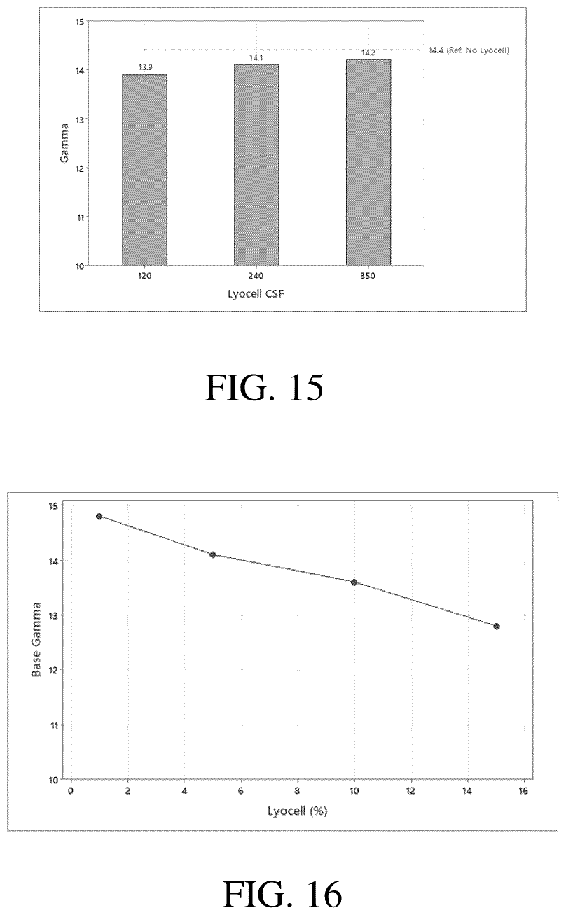

In sample 4, fibrillated lyocell fibers were added to sample 1, and the level of microglass fibers having moderate diameters was lowered accordingly. FIG. 15 is a plot of non-woven fiber web samples having compositions corresponding to sample 4, with varying levels of fibrillation in the fibrillated lyocell fibers. As shown in FIG. 15, the use of fibrillated lyocell fibers with higher CSF values increased the gamma. Gamma was measured as described elsewhere herein. Sample 4 also had higher wet strength and better processability than sample 1.

Samples 3 and 4 from Table 6 were then tested for flame resistance using DIN 53438 (June 1984). Each sample passed, indicating the presence of the PVOH fibers or the fibrillated fibers at the tested amounts did not adversely affect the flame resistance.

In samples 5-8, there were no PVOH or bicomponent fibers, and the amount of fibrillated lyocell fibers was varied (e.g., with the fibrillated fibers replacing corresponding amounts of the glass fibers having a moderate diameter). As shown in FIG. 16, the base gamma decreased as the amount of fibrillated lyocell fibers increased. Gamma was measured as described elsewhere herein.

Flammability of samples 5-8 were then tested for flame resistance using DIN 53438 (June 1984). Samples 5-7 passed the test, but sample 8 failed the test. This indicates that the presence of fibrillated fibers at the tested amount in sample 8 adversely affected the flame resistance of the non-woven fiber web samples.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A filter media, comprising:
a non-woven fiber web and a water-repellent additive;
wherein the non-woven fiber web comprises fine microglass fibers, microglass fibers having moderate diameters, coarse glass fibers, and fibrillated fibers;
wherein the fine microglass fibers have an average fiber diameter of less than or equal to 1 micron;
wherein the microglass fibers having moderate diameters have an average fiber diameter of greater than 1 micron and less than or equal to 6 microns;
wherein the coarse glass fibers have an average fiber diameter of greater than 6 microns; and
wherein the non-woven fiber web comprises greater than 0 wt % and less than or equal to 20 wt % of the fibrillated fibers.

2. The filter media of claim 1, wherein the filter media lacks perfluoroalkyl substances, polyfluoroalkyl substances, and/or fluorotelomers.

3. The filter media of claim 1, wherein the water-repellent additive comprises one or more water-repellent functional groups; each water-repellent functional group of the water-repellent additive is independently an alkyl group comprising greater than or equal to 3 carbon atoms, an alkenyl group comprising greater than or equal to 3 carbon atoms, and/or an alkynyl group comprising greater than or equal to 3 carbon atoms; and each water-repellent functional group of the water-repellent additive is independently a side chain of a repeat unit of a polymer and/or bonded to a silicon atom and/or a metal atom.

4. The filter media of claim 1, wherein the non-woven fiber web comprises greater than 0 wt % and less than or equal to 15 wt % of the fibrillated fibers.

5-6. (canceled)

7. The filter media of claim 1, wherein the non-woven fiber web comprises greater than 0 wt % and less than or equal to 2 wt % of the fibrillated fibers.

8. The filter media of claim 1, wherein the fibrillated fibers comprise lyocell fibers.

9. (canceled)

10. The filter media of claim 1, wherein the fibrillated fibers have a level of fibrillation of greater than or equal to 1 and less than or equal to 1000 CSF.

11. (canceled)

12. The filter media of claim 1, wherein the fibrillated fibers have a level of fibrillation of greater than or equal to 200 and less than or equal to 500 CSF.

13. The filter media of claim 1, wherein the filter media has an initial DOP gamma of greater than or equal to 6 and less than or equal to 30.

14. The filter media of claim 1, wherein the filter media has an initial DOP gamma of greater than or equal to 9 and less than or equal to 20.

15. The filter media of claim 1, wherein the non-woven fiber web comprises greater than 0 wt % and less than or equal to 60 wt % of the coarse glass fibers.

16-22. (canceled)

23. The filter media of claim 1, wherein the non-woven fiber web comprises greater than 0 wt % and less than or equal to 95 wt % of the microglass fibers having moderate diameters.

24-27. (canceled)

28. The filter media of claim 1, wherein the non-woven fiber web comprises greater than 0 wt % and less than or equal to 95 wt % of the fine microglass fibers.

29-31. (canceled)

32. The filter media of claim 1, wherein the non-woven fiber web further comprises a resin.

33-40. (canceled)

41. The filter media of claim 1, wherein the non-woven fiber web comprises less than 2 wt % synthetic fibers comprising poly(vinyl alcohol).

42-44. (canceled)

45. The filter media of claim 1, wherein the non-woven fiber web lacks synthetic fibers comprising poly(vinyl alcohol).

46. The filter media of claim 1, wherein the non-woven fiber web comprises less than or equal to 3 wt % bicomponent fibers.

47-48. (canceled)

49. The filter media of claim 1, wherein the non-woven fiber web lacks bicomponent fibers.

50-51. (canceled)

52. The filter media of claim 1, wherein the non-woven fiber web lacks synthetic fibers other than the fibrillated fibers.

53-59. (canceled)

60. The filter media of claim 1, wherein the filter media comprises greater than 0 wt % and less than or equal to 50 wt % of the water-repellent additive.

61. (canceled)
